(19) United States
(12) Patent Application Publication
(10) Pub. No.: US 2020/0368094 A1
(43) Pub. Date: Nov. 26, 2020

(54) POWER ASSIST SUIT

(71) Applicant: JTEKT CORPORATION, Osaka-shi (JP)

(72) Inventors: Yoshitaka YOSHIMI, Kashiba-shi (JP); Toshiki Kumeno, Kyoto-shi (JP)

(73) Assignee: JTEKT CORPORATION, Osaka-shi (JP)

(21) Appl. No.: 16/877,634

(22) Filed: May 19, 2020

(30) Foreign Application Priority Data
May 20, 2019 (JP) 2019-094439
May 20, 2019 (JP) 2019-094440

(51) Int. Cl. A61H 1/02; A61H 3/00

(52) U.S. Cl. CPC A61H 1/0262; A61H 2201/5084; A61H 3/008; A61H 2205/088; A61H 2203/0406; A61H 2201/5007; A61H 2201/018; A61H 2201/1207; A61H 2201/1463; A61H 2201/1676; A61H 2201/1616; A61H 2201/1621; A61H 2201/1626; A61H 2201/1652; A61H 2201/5069; A61H 2201/5071; A61H 1/0244

(57) ABSTRACT

A power assist suit includes: a body wearing tool; a left actuator unit and a right actuator unit attached to the body wearing tool and worn on a left and right thighs of the wearer, such that the left actuator unit and the right actuator unit respectively generate assist torques of assisting motions of the left and right thighs; left and right-torque-related amount detectors which detect a left-torque-related amount and a right-torque amount related to left and right wearer torques and left and right assist torques, the left and right wearer torque being respectively input from the left and right thighs to the left actuator unit and the right actuator unit, the left and right assist torque being generated by the left actuator unit and the right actuator unit; and a controller which automatically switches a motion mode based on the left-torque-related amount and the right-torque-related amount.

### CROSS-REFERENCE TO RELATED APPLICATIONS

This application is based on and claims priority under 35 USC 119 from Japanese Patent Application No. 2019-094440 filed on May 20, 2019 and Japanese Patent Application No. 2019-094439 filed on May 20, 2019, the contents of which are incorporated herein by reference.

### TECHNICAL FIELD

The present disclosure relates to a power assist suit that supports motion of a left thigh and a right thigh with respect to a waist of a wearer.

### BACKGROUND ART

In recent years, various power assist suits that assist (support) lifting motion and lowering motion of object have been disclosed. These power assist suits are configured to appropriately assist the motion of the wearer of the power assist suit assuming a case where the wearer is holding an object. For example, at a time of a lifting motion of the object, the power assist suit assists an operation of standing up while holding the object from a state in which the wearer lowers the waist and grips the object.

For example, JP2018-061663A discloses a power assist robot apparatus configured to allow the wearer to select one motion mode among walking, loading, half-sitting posture, and damper motion of the wearer. The wearer wearing the power assist robot apparatus can select one motion mode among walking, loading, half-sitting posture, and damper motion from an operation type input unit to obtain a desired assist operation.

Furthermore, in recent years, there have been various power assist suits that reduce a burden of the wearer's waist and the like in various fields such as manufacturing, distribution, construction, agriculture, care, and rehabilitation.

For example, the assist device described in the following JP2018-199186A includes a body wearing tool to be worn on the body of a subject including the periphery of an assist target body part of the wearer, and an actuator unit that is to be worn on the body wearing tool and the assist target body part and that assists a motion of the assist target body part. The actuator unit includes an output link that is rotated around a joint of the assist target body portion to be attached to the assist target body portion, and an actuator including an output shaft that generates an assist torque that assists the rotation of the assist target body portion via the output link.

The output shaft of the actuator is connected to an inner end of a spiral spring. An outer end of the spiral spring is connected to a speed-increasing shaft of a speed reducer that reduces a rotation angle from the output shaft of the actuator via a pulley. A speed-reducing shaft of the speed reducer is connected to the output link. An output link rotation angle detection unit that detects a rotation angle of the output link is provided on the speed-increasing shaft of the speed reducer. Further, a motor rotation angle detection unit that detects a rotation angle of the output shaft of the actuator is provided.

A synthetic torque stored in the spiral spring is obtained from the rotation angle of the output shaft detected by the motor rotation angle detection unit, the rotation angle of the output link detected by the output link rotation angle detection unit, and a spring constant of the spiral spring. Further, a wearer torque is extracted from the obtained synthetic torque, and an assist torque corresponding to the wearer torque is output from the actuator.

In the power assist robot apparatus described in JP2018-061663A, since the wearer needs to select the motion mode from the motion type input unit before starting his/her own motion and operation, this selection operation is troublesome. For example, when the wearer moves by walking from a wearing room of the power assist robot apparatus to a work site, performs loading operation from the half-sitting posture at the work site, and moves by walking from the work site to the wearing room, the motion mode needs to be changed sequentially to walking, half-sitting posture, loading, and walking, which is troublesome. In addition, when the wearer is in a hurry, change of the motion mode may be forgotten, or work efficiency may be reduced.

Furthermore, in the assist device described in JP2018-199186A, when a malfunction occurs in the output link rotation angle detection unit, it is difficult to accurately detect the rotation angle of the output link, and an inappropriate assist torque is output by the actuator, and the wearer may feel uncomfortable. In addition, in the event of an assist torque exceeding an upper limit of a mechanical strength of the spiral spring being output by the actuator, an appropriate assist torque cannot be output suddenly due to deformation of the spiral spring or the like, and when the load is lifted or the like, the wearer may suddenly feel the load and feel uncomfortable when lifting an object or the like.

### SUMMARY OF INVENTION

The present disclosure provides a power assist suit capable of automatically and appropriately switching a motion mode without requiring switching of the motion mode by a wearer.

Furthermore, the present disclosure provides a highly reliable power assist suit that can output an appropriate assist torque with an actuator without causing a sense of discomfort to a wearer.

According to a first illustrative aspect of the present disclosure, a power assist suit includes: a body wearing tool configured to be worn around at least a waist of a wearer; a left actuator unit configured to be attached to the body wearing tool and worn on a left thigh of the wearer, such that the left actuator unit generates an assist torque of assisting a motion of the left thigh with respect to the waist of the wearer; a right actuator unit configured to be attached to the body wearing tool and worn on a right thigh of the wearer, such that the right actuator unit generates an assist torque of assisting a motion of the right thigh with respect to the waist of the wearer; a left-torque-related amount detector configured to detect a left-torque-related amount, which is a torque related to a left wearer torque and a left assist torque, the left wearer torque being a torque input from the left thigh of the wearer to the left actuator unit, the left assist torque being the assist torque generated by the left actuator unit; a right-torque-related amount detector configured to detect a right-torque-related amount, which is a torque related to a right wearer torque and a right assist torque, the right wearer torque being a torque input from the right thigh of the wearer to the right actuator unit, the right assist torque being the assist torque generated by the right actuator unit; and a controller configured to automatically switch a motion mode based on the left-torque-related amount and the right-torque-related amount.

According to a second illustrative aspect of the present disclosure, the motion mode includes three modes whose assist motions are different from one another, the motion mode including: a lifting mode of assisting a lifting operation in which the wearer lifts up an object; a lowering mode of assisting a lowering operation in which the wearer puts down the object; and a walking mode of assisting a walking motion in which the wearer walks. The controller is configured to switch or maintain the motion mode to one of the lifting mode, the lowering mode, and the walking mode, based on the left-torque-related amount and the right-torque-related amount.

According to a third illustrative aspect of the present disclosure, the controller is configured to: switch the motion mode to the lowering mode when the left-torque-related amount and the right-torque-related amount relates to the torques in a direction in which the wearer leans forward and are larger than a first predetermined threshold, and switch the motion mode to the lifting mode when the left-torque-related amount and the right-torque-related amount relates to the torques in a direction opposite to the direction in which the wearer leans forward and are larger than a second predetermined threshold.

According to a fourth illustrative aspect of the present disclosure, the left-torque-related amount detector includes a left thigh angle detector configured to detect a swing angle of the left thigh with respect to the waist of the wearer. The right-torque-related amount detector includes a right thigh angle detector configured to detect a swing angle of the right thigh with respect to the waist of the wearer.

According to a fifth illustrative aspect of the present disclosure, the power assist suit further includes a storage unit in which a learning model is stored. The controller is configured to perform a machine learning with the learning model, such that the controller adjusts values of the first predetermined threshold and the second predetermined threshold, respectively.

According to a sixth illustrative aspect of the present disclosure, a power assist suit includes: a body wearing tool configured to be worn around at least a waist of a wearer; a left actuator unit configured to be attached to the body wearing tool and worn on a left thigh of the wearer, such that the left actuator unit generates an assist torque of assisting a motion of the left thigh with respect to the waist of the wearer; a right actuator unit configured to be attached to the body wearing tool and worn on a right thigh of the wearer, such that the right actuator unit generates an assist torque of assisting a motion of the right thigh with respect to the waist of the wearer; and a controller configured to control the left actuator unit and the right actuator unit. Each of the left actuator unit and the right actuator unit includes: an output link configured to be worn on one of the left thigh and the right thigh of the wearer and to move rotationally around a joint of the one of the left thigh and the right thigh; an actuator including an output shaft configured to generate the assist torque of assisting a rotational movement around the joint of the one of the left thigh and the right thigh via the output link; an elastic member configured to accumulate a synthetic torque obtained by synthesizing the wearer torque input from the output link moved rotationally by a force of the wearer and the assist torque input from the output shaft in the one of the left thigh and the right thigh, one end of the elastic member being connected to the output link, the other end of the elastic member being connected to the output shaft of the actuator; and a deformation state detector configured to detect a deformation state in which the elastic member is deformed. The controller includes: a synthetic torque acquisition unit configured to acquire the synthetic torque accumulated in the elastic member based on the deformation state of the elastic member, the deformation state being detected with the deformation state detector of each of the left actuator unit and the right actuator unit; and a spring failure determination unit configured to determine whether the elastic member of each of the left actuator unit and the right actuator unit is to fail, based on the synthetic torque accumulated in the elastic member acquired via the synthetic torque acquisition unit.

According to a seventh illustrative aspect of the present disclosure, the spring failure determination unit is configured to determine that the elastic member is to fail when the synthetic torque acquired via the synthetic torque acquisition unit is equal to or greater than a predetermined torque threshold.

According to an eighth illustrative aspect of the present disclosure, the power assist suit further includes a power supply unit configured to supply an electric power to the left actuator unit and the right actuator unit. The controller includes a power supply control unit which controls to stop supplying the electric power to the left actuator unit and the right actuator unit when the spring failure determination unit determines that the elastic member is to fail.

According to a ninth illustrative aspect of the present disclosure, the deformation state detector includes: an output shaft rotation angle detection device configured to detect a rotation angle of the output shaft; and an output link rotational movement angle detection device configured to detect a rotational movement angle of the output link. The synthetic torque acquisition unit is configured to acquire each of the synthetic torques based on the rotation angle of the output shaft detected by the output shaft rotation angle detection device and the rotational movement angle of the output link detected by the output link rotational movement angle detection device.

According to a tenth illustrative aspect of the present disclosure, each of the left actuator unit and the right actuator unit includes a speed reducer including a speed-reducing shaft connected to the output link, and including a speed-increasing shaft connected to the output link rotational movement angle detection device.

According to an eleventh illustrative aspect of the present disclosure, A power assist suit includes: a body wearing tool configured to be worn around at least a waist of a wearer; a left actuator unit configured to be attached to the body wearing tool and worn on a left thigh of the wearer, such that the left actuator unit generates an assist torque of assisting a motion of the left thigh with respect to the waist of the wearer; a right actuator unit configured to be attached to the body wearing tool and worn on a right thigh of the wearer, such that the right actuator unit generates an assist torque of assisting a motion of the right thigh with respect to the waist of the wearer; a power supply unit configured to supply an electric power to the left actuator unit and the right actuator unit, and a controller configured to control the left actuator unit and the right actuator unit. Each of the left actuator unit and the right actuator unit includes: an output link configured to be worn on one of the left thigh and the right thigh of the wearer and to move rotationally around a joint of the one of the left thigh and the right thigh; an actuator including an output shaft configured to generate the assist torque of assisting a rotational movement around the joint of the one of the left thigh and the right thigh via the output link; an elastic member configured to accumulate a synthetic torque obtained by synthesizing the wearer torque input from the output link moved rotationally by a force of the wearer and the assist torque input from the output shaft in the one of the left thigh and the right thigh, one end of the elastic member being connected to the output link, the other end of the elastic member being connected to the output shaft of the actuator; and a deformation state detector configured to detect a deformation state in which the elastic member is deformed. The controller is configured to control the left actuator unit and the right actuator unit, and the controller includes: a synthetic torque acquisition unit configured to acquire the synthetic torque accumulated in the elastic member based on the deformation state of the elastic member, the deformation state being detected with the deformation state detector of each of the left actuator unit and the right actuator unit; a first rotational movement torque acquisition unit configured to acquire a first rotational movement torque of moving rotationally the output link of each of the left actuator unit and the right actuator unit, based on the synthetic torque accumulated in the elastic member acquired via the synthetic torque acquisition unit; a current detector configured to detect a current value supplied to each of the left actuator unit and the right actuator unit; a second rotational movement torque acquisition unit configured to acquire a second rotational movement torque of moving rotationally the output link of each of the left actuator unit and the right actuator unit, based on the current value supplied to each of the left actuator unit and the right actuator unit detected with the current detector; and a device failure determination unit configured to determine whether the deformation state detector of each of the left actuator unit and the right actuator unit fails, based on a difference between the first rotation torque and the second rotation torque.

According to a twelfth illustrative aspect of the present disclosure, the device failure determination unit is configured to determine that the deformation state detector fails when the difference between the first rotational movement torque and the second rotational movement torque is equal to or greater than a predetermined error threshold.

According to a thirteenth illustrative aspect of the present disclosure, the controller includes a power supply control unit which controls to stop supplying the electric power to the left actuator unit and the right actuator unit when the device failure determination unit determines that the deformation state detector of the left actuator unit or the right actuator unit fails.

According to a fourteenth illustrative aspect of the present disclosure, the deformation state detector includes: an output shaft rotation angle detection device configured to detect a rotation angle of the output shaft; and an output link rotational movement angle detection device configured to detect a rotational movement angle of the output link. The synthetic torque acquisition unit is configured to acquire each of the synthetic torques based on the rotation angle of the output shaft detected by the output shaft rotation angle detection device and the rotational movement angle of the output link detected by the output link rotational movement angle detection device.

According to a fifteenth illustrative aspect of the present disclosure, the device failure determination unit is configured to determine whether the output link rotational movement angle detection device of each of the left actuator unit and the right actuator unit fails, based on the difference between the first rotation torque and the second rotation torque of each of the left actuator unit and the right actuator unit.

According to a sixteenth illustrative aspect of the present disclosure, each of the left actuator unit and the right actuator unit includes a speed reducer including a speed-reducing shaft connected to the output link, and including a speed-increasing shaft connected to the output link rotational movement angle detection device.

According to a seventeenth illustrative aspect of the present disclosure, the elastic members includes a spiral spring.

According to the first aspect of the present disclosure, the motion of the wearer can be appropriately determined based on the left-torque-related amount and the right-torque-related amount, and the motion mode can be automatically and appropriately switched by using the control device.

According to the second aspect of the present disclosure, since the motion mode includes the lifting mode for assisting the lifting operation, the lowering mode for assisting the lowering operation, and the walking mode for assisting the walking motion (movement of a work place), it is possible to appropriately assist an operation of the wearer that requires a physical strength.

According to the third aspect of the present disclosure, it is possible to appropriately switch between the lowering mode and the lifting mode based on the motion of the wearer.

According to the fourth aspect of the present disclosure, it is possible to appropriately realize the left-torque-related amount detection unit and the right-torque-related amount detection unit.

According to the fifth aspect of the present disclosure, by performing machine learning, it is possible to automatically adjust an optimal value of the first predetermined threshold and an optimal value of the second predetermined threshold for each wearer, which is convenient.

According to the sixth aspect of the present disclosure, the control device acquires the synthetic torque stored in each of the elastic members based on the deformation state of each of the elastic members detected by the deformation state detection device of each of the left actuator unit and the right actuator unit. Further, the control device determines whether the elastic member of each of the left actuator unit and the right actuator unit is to fail (e.g., deform, break, etc.) based on the synthetic torque stored in each of the elastic members.

Accordingly, when the control device determines that the elastic member of the left actuator unit or the right actuator unit is to fail, it is possible to adjust the assist torque by the actuator so as not to exceed an upper limit of a mechanical strength of the elastic member, and it is possible to avoid failure of the elastic member. In this way, it is possible to provide a highly reliable power assist suit that can output an appropriate assist torque with the actuators without causing a sense of discomfort, such has feeling a sudden load, to the wearer.

According to the seventh aspect of the present disclosure, the control device determines that one of the elastic members is to fail (e.g., deforms, breaks, etc.) when the synthetic torque is equal to or greater than the predetermined torque threshold. As a result, by acquiring the “torque threshold” at a time when the elastic member fails in advance via computer aided engineering (CAE) analysis, experiments, or the like, the control device can accurately determine whether the elastic member is to fail (e.g., deform, break, etc.) before the elastic member fails, and can improve the reliability of the power assist suit.

According to the eighth aspect of the present disclosure, the control device stops supply of power to the left actuator unit and the right actuator unit when it is determined that one of the elastic members is to fail based on the synthetic torque. As a result, the assist torque by the actuator is set to “0”, and thus the synthetic torque can be gradually reduced by a spring force of the elastic member. As a result, it is possible to provide a highly reliable power assist suit that does not cause a sense of discomfort, such as feeling a sudden load, to the wearer when assisting the lifting motion and lowering motion of an object.

According to the ninth aspect of the present disclosure, the synthetic torque acquisition unit acquires each of the synthetic torques based on the rotation angle of the output shaft detected by the output shaft rotation angle detection device and the rotation angle of the output link detected by the output link rotation angle detection device. Therefore, each of the synthetic torques can be acquired with a simple configuration including the output shaft rotation angle detection device and the output link rotation angle detection device when assisting the lifting motion and lowering motion of the object.

According to the tenth aspect of the present disclosure, the output link rotation angle detection device is connected to the output link via the speed reducer. Accordingly, since a change in the rotation angle of the output link can be increased and detected by the output link rotation angle detection device, it is possible to improve detection accuracy of the rotation angle of the output link, and to improve detection accuracy of the synthetic torque.

According to the eleventh aspect of the present disclosure, the control device acquires the synthetic torque stored in each of the elastic members based on the deformation state of each of the elastic members detected by the deformation state detection device of each of the left actuator unit and the right actuator unit. Further, the control device acquires the first rotation torque for rotating the output link of each of the left actuator unit and the right actuator unit based on the synthetic torque stored in each of the elastic members.

Moreover, the control device acquires the second rotation torque for rotating each of the output links based on the current value supplied to each of the left actuator unit and the right actuator unit. Further, the control device determines whether the deformation state detection device of each of the left actuator unit and the right actuator unit fails based on the difference between the first rotation torque and the second rotation torque.

Accordingly, when it is determined that the deformation state detection device of the left actuator unit or the right actuator unit fails, the control device can stop output of an inappropriate assist torque by the actuator. In this way, it is possible to provide a highly reliable power assist suit that can output an appropriate assist torque with the actuators without causing a sense of discomfort to the wearer when assisting the lifting motion and lowering motion of the object.

According to the twelfth aspect of the present disclosure, the control device determines that one of the deformation state detection devices fails when the difference between the first rotation torque and the second rotation torque is equal to or greater than the predetermined error threshold. As a result, by acquiring the “error threshold” at a time when one of the deformation state detection devices fails in advance via computer aided engineering (CAE) analysis, experiments, or the like, the control device can accurately determine whether one of the deformation state detection device fails, and can improve the reliability of the power assist suit.

According to the thirteenth aspect of the present disclosure, the control device stops supply of power to the left actuator unit and the right actuator unit when the device failure determination unit determines that the deformation state detection device of the left actuator unit or the right actuator unit fails based on the difference between the first rotation torque and the second rotation torque. As a result, the assist torque by the actuator is set to “0”, and thus the synthetic torque can be gradually reduced by the spring force of the elastic member. As a result, it is possible to provide a highly reliable power assist suit that does not cause a sense of discomfort, such as feeling a sudden load, to the wearer when assisting the lifting motion and lowering motion of the object.

According to the fourteenth aspect of the present disclosure, the synthetic torque acquisition unit acquires each of the synthetic torques based on the rotation angle of the output shaft detected by the output shaft rotation angle detection device and the rotation angle of the output link detected by the output link rotation angle detection device. Therefore, each of the synthetic torques can be acquired with a simple configuration including the output shaft rotation angle detection device and the output link rotation angle detection device when assisting the lifting motion and lowering motion of the object.

According to the fifteenth aspect of the present disclosure, the control device determines whether the output link rotation angle detection device of each of the left actuator unit and the right actuator unit fails based on the difference between the first rotation torque and the second rotation torque of each of the left actuator unit and the right actuator unit.

Accordingly, when a failure of the output link rotation angle detection device of the left actuator unit or the right actuator unit is detected, since the rotation angle of the output link cannot be detected accurately, the control device can stop output of an inappropriate assist torque by the actuator. In this way, it is possible to provide a highly reliable power assist suit that can output an appropriate assist torque with the actuators without causing a sense of discomfort to the wearer when assisting the lifting motion and lowering motion of the object.

According to the sixteenth aspect of the present disclosure, the output link rotation angle detection device of each of the left actuator unit and the right actuator unit is connected to the output link via the speed reducer. Accordingly, since a change in the rotation angle of the output link can be increased and detected by the output link rotation angle detection device, it is possible to improve detection accuracy of the rotation angle of the output link, and to improve accuracy of the first rotation torque.

According to the seventeenth of the present disclosure, by using the spiral spring, as compared to a case where the output torque of the actuator is adjusted via a current, the output torque can be adjusted by simply adjusting an amount of expansion or contraction of the spiral spring (that is, the rotation angle of the output shaft), so that the assist torque can be adjusted easily.

### BRIEF DESCRIPTION OF DRAWINGS

FIG. 1 is a perspective view illustrating an example of an overall configuration of a power assist suit.

FIG. 2 is an exploded perspective view of the power assist suit illustrated in FIG. 1.

FIG. 3 is a perspective view illustrating an example of an appearance of a body wearing tool in the power assist suit illustrated in FIG. 1.

FIG. 4 is a perspective view illustrating an example of an appearance of actuator units and load detection units in the power assist suit illustrated in FIG. 1.

FIG. 5 is a perspective view illustrating an example of an appearance of a frame portion which is a component of the body wearing tool.

FIG. 6 is a developed view illustrating an example of a structure of a waist support portion which is a component of the body wearing tool.

FIG. 7 is a developed view illustrating an example of a structure of a jacket portion which is a component of the body wearing tool.

FIG. 8 is a perspective view illustrating an example of an appearance of a (right) actuator unit in the power assist suit illustrated in FIG. 1.

FIG. 9 is a perspective view illustrating another example of the (right) actuator unit illustrated in FIG. 8.

FIG. 10 is an exploded perspective view illustrating an example of an internal structure of the actuator unit.

FIG. 11 is a cross-sectional view illustrating an example of the internal structure of the actuator unit.

FIG. 12 is a view illustrating an upright state in which a wearer wearing the power assist suit is stretching his/her back muscle.

FIG. 13 is a view illustrating a state in which the wearer comes into a forward-leaning posture from the state illustrated in FIG. 12 and the frame portion and the like are rotated around a virtual rotation axis.

FIG. 14 is a view illustrating an example of an appearance of an operation unit.

FIG. 15 is a view illustrating input/output of a control device.

FIG. 16 is a view illustrating changing (adjustment) of a motion mode, a gain, and an increase rate from the operation unit.

FIG. 17 is a control block diagram for controlling the actuator unit with the control device.

FIG. 18 is a flowchart illustrating an entire processing procedure based on the control block diagram illustrated in FIG. 17.

FIG. 19 is a flowchart illustrating details of the processing of [S100: ADJUSTMENT DETERMINATION, INPUT PROCESSING, CALCULATION OF TORQUE CHANGE AMOUNT, ETC.] in the flowchart illustrated in FIG. 18.

FIG. 20 is a flowchart illustrating details of the processing of [S150: failure detection processing] in the flowchart illustrated in FIG. 18.

FIG. 21 is a flowchart illustrating details of the processing of [S1600R: FAILURE DETECTION PROCESSING OF RIGHT ACTUATOR] in the flowchart illustrated in FIG. 20.

FIG. 22 is a flowchart illustrating details of the processing of [S200: MOTION MODE DETERMINATION] in the flowchart illustrated in FIG. 18.

FIG. 23 is a flowchart illustrating details of the processing of [S300: LOAD DETERMINATION (DETERMINATION OF GAIN Cₚ)] in the flowchart illustrated in FIG. 18.

FIG. 24 is a view illustrating a load detected by the load detection unit in an upright stationary state in which the wearer does not hold an object.

FIG. 25 is a view illustrating a load detected by the load detection unit in a state in which the wearer lowers his/her waist from the state illustrated in FIG. 24 to lift the object.

FIG. 26 is a view illustrating an example of an object mass obtained based on a detection signal from the load detection unit when the wearer actually lowers his/her waist to grasp the object and then lifts the grasped object.

FIG. 27 is a view illustrating an acceleration detected by an acceleration detection unit, which is added, and the load detected by the load detection unit with respect to the state illustrated in FIG. 24.

FIG. 28 is a view illustrating an acceleration detected by the acceleration detection unit and a load detected by the load detection unit in a state in which the wearer lowers his/her waist from the state illustrated in FIG. 27 to lift the object.

FIG. 29 is a view illustrating an example of an object mass obtained based on a detection signal from the load detection unit and a detection signal from the acceleration detection unit when the wearer actually lowers his/her waist to grasp the object and then lifts the grasped object.

FIG. 30 is a flowchart illustrating details of the processing of [SD000R: (RIGHT) LOWERING] in the flowchart illustrated in FIG. 18.

FIG. 31 is a view illustrating a state of a lowering operation of the wearer.

FIG. 32 is a view illustrating an example of a wearer torque change amount−assist amount characteristic.

FIG. 33 is a view illustrating an example of a forward-leaning angle−lowering torque limit value characteristic.

FIG. 34 is a view illustrating how the forward-leaning angle and a lowering assist torque change with respect to time when the wearer performs the lowering operation.

FIGS. 35A and 35B are a flowchart illustrating details of the processing of [SU000: LIFTING] in the flowchart illustrated in FIG. 18.

FIG. 36 is a state transition diagram illustrating details of the processing of [SS000: MOTION STATE DETERMINATION] in the flowchart illustrated in FIGS. 35A and 35B.

FIG. 37 is a view illustrating how the forward-leaning angle and a lifting assist torque change with respect to transition of the motion state when the wearer performs the lifting operation.

FIG. 38 is a flowchart illustrating details of the processing of [SS100R: SWITCHING DETERMINATION OF (RIGHT) INCREASE RATE] in the flowchart illustrated in FIGS. 35A and 35B.

FIG. 39 is a view illustrating an example of a time−switching lower limit characteristic and a time−switching upper limit characteristic.

FIG. 40 is a view illustrating an example of an increase rate−transition time characteristic.

FIG. 41 is a view illustrating an example of a time−assist amount characteristic.

FIG. 42 is a flowchart illustrating details of the processing of [SS170R: (RIGHT) ASSIST TORQUE CALCULATION] in the flowchart illustrated in FIGS. 35A and 35B.

FIG. 43 is a view illustrating an example of a time−lifting torque characteristic and a forward-leaning angle−maximum lifting torque characteristic.

FIG. 44 is a view illustrating an example of a gain−damping coefficient characteristic.

FIG. 45 is a view illustrating an example of an assist ratio−torque damping rate characteristic.

### DESCRIPTION OF EMBODIMENTS

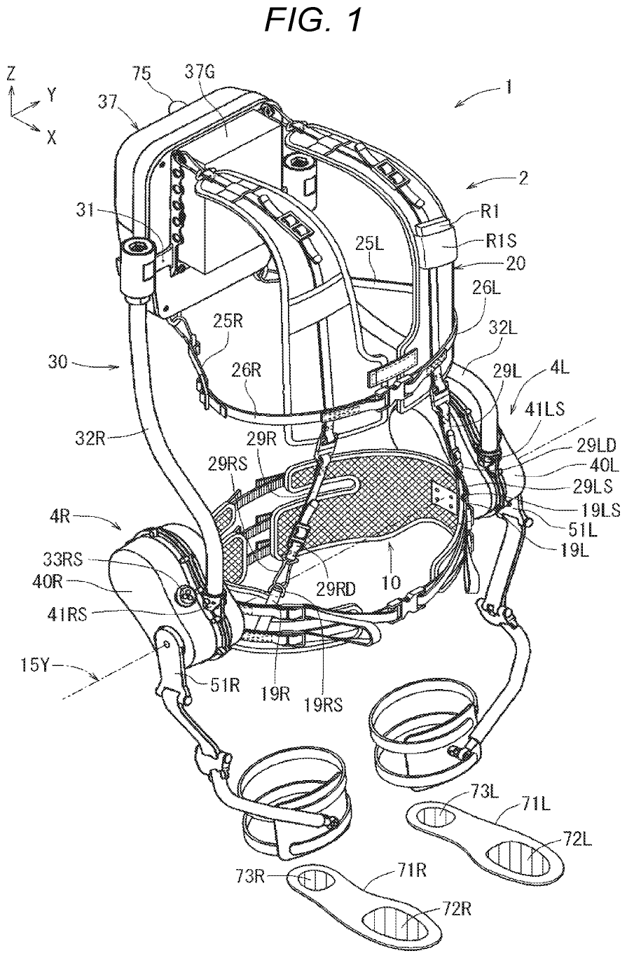

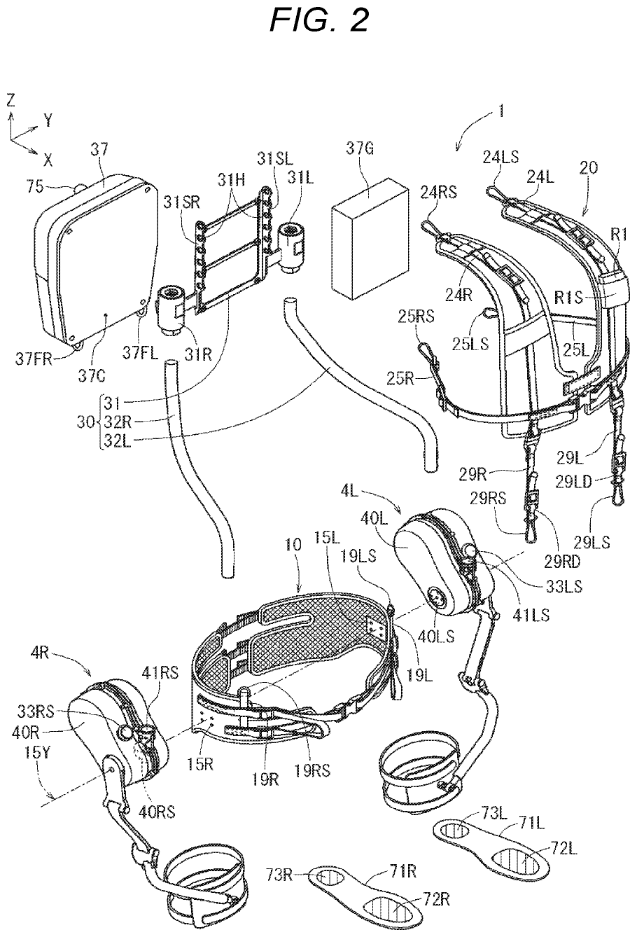

An overall structure of a power assist suit 1 will be described below with reference to FIGS. 1 to 16. The power assist suit 1 is, for example, a device that assists rotation of thighs with respect to a waist (or the waist with respect to the thighs) when a wearer lifts an object (or lowers the load), and assists rotation of the thighs with respect to the waist when the wearer walks. An X axis, a Y axis, and a Z axis in the drawings are orthogonal to each other, and the X axis direction corresponds to a forward direction, the Y axis direction is a left direction, and the Z axis direction corresponds to an upper direction when viewed from the wearer wearing the power assist suit.

[Overall Structure of Power Assist Suit 1 (FIGS. 1 and 2)]

FIG. 1 shows an overall appearance of the power assist suit 1. FIG. 2 is an exploded perspective view of the power assist suit 1 illustrated in FIG. 1.

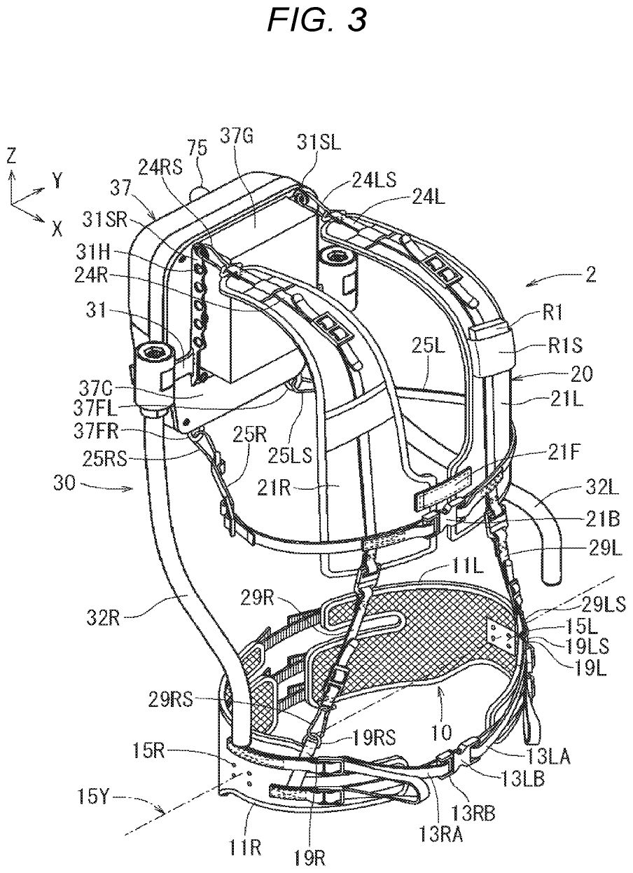

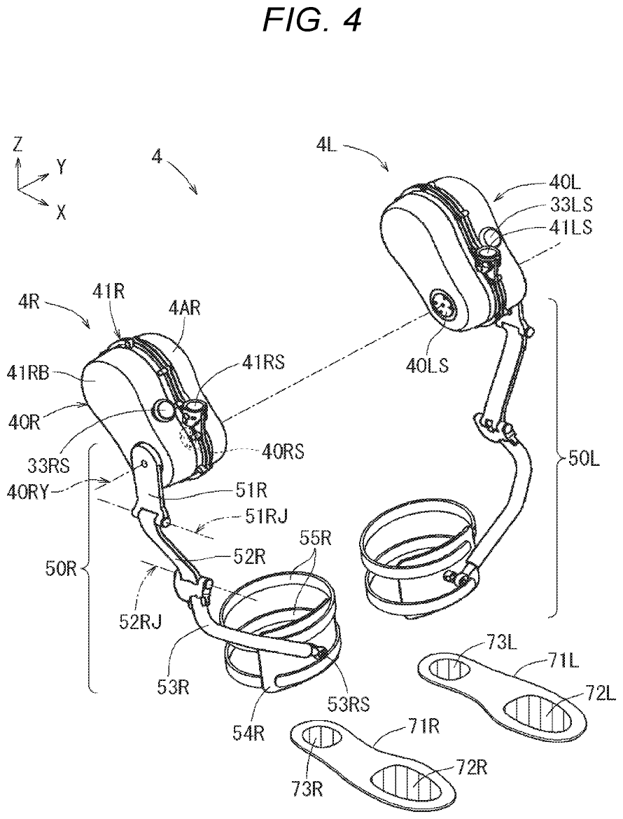

As shown in the exploded perspective view of FIG. 2, the power assist suit 1 includes a waist support portion 10, a jacket portion 20, a frame portion 30, a backpack portion 37, a cushion 37G, a right actuator unit 4R, a left actuator unit 4L, load detection units 71R, 71L, and the like. The waist support portion 10, the jacket portion 20, the frame portion 30, the backpack portion 37, and the cushion 37G constitute a body wearing tool 2 (see FIG. 3), and the right actuator unit 4R and the left actuator unit 4L constitute an actuator unit 4 (see FIG. 4). The backpack portion 37 is provided with an acceleration detection unit 75. The power assist suit 1 includes an operation unit R1 (so-called remote controller) for the wearer to adjust a motion mode (lowering assist, lifting assist, and the like), a gain of an assist torque, and an increase rate of the assist torque, and to confirm an adjusted state and the like, and an accommodation portion R1S that accommodates the operation unit R1.

The load detection units 71R, 71L are, for example, insoles of shoes, where the load detection unit 71R is disposed in a right shoe of the wearer and under a right foot of the wearer, and the load detection unit 71L is disposed in a left shoe of the wearer and under a left foot of the wearer. The load detection unit 71R is provided with a load detection unit 72R (e.g., a pressure sensor) capable of detecting a load around toes of the right foot of the wearer and a load detection unit 73R (e.g., a pressure sensor) capable of detecting a load around a heel of the right foot of the wearer. Although not shown, the load detection unit 71R also includes a wireless communication unit that wirelessly transmits detection signals from the load detection units 72R, 73R to the operation unit R1, a power supply of the communication unit, and the like. Similarly, the load detection unit 71L includes load detection units 72L, 73L, a wireless communication unit, a power supply, and the like, which are the same as those of the load detection unit 71R, and a description thereof will be omitted.

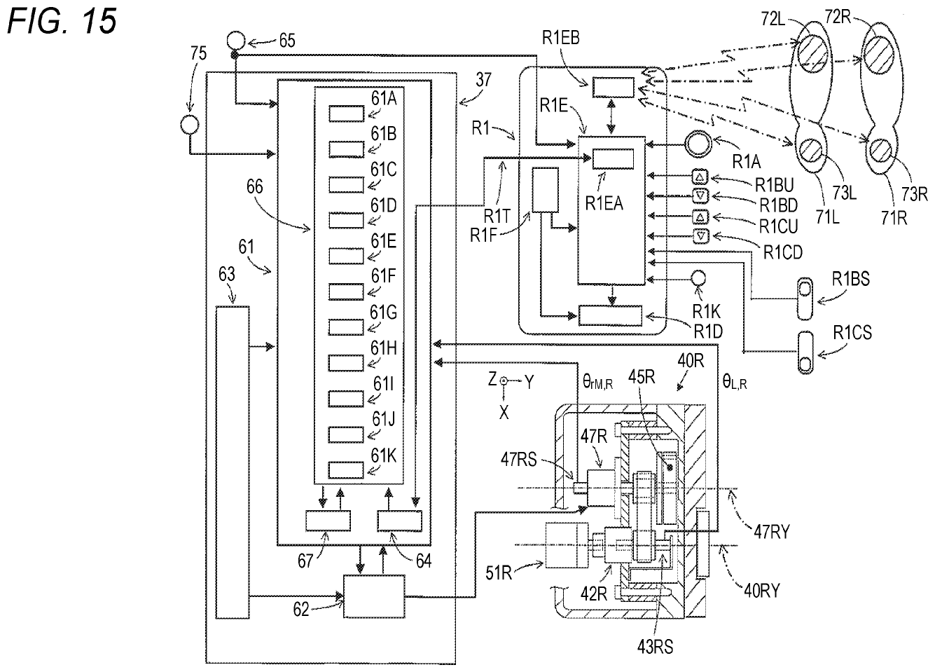

A control device 61 (see FIG. 15) can detect a wearer mass, which is a mass of the wearer, or a wearer weight, which is a weight of the wearer, based on the detection signals from the load detection units 72L, 72R, 73L, 73R, when the wearer is not holding an object. Further, the control device 61 (see FIG. 15) can detect a synthetic mass, which is a mass of the wearer and an object, or a synthetic weight, which is a weight of the wearer and the object, based on the detection signals from the load detection units 72L, 72R, 73L, 73R, when the wearer is holding the object. The control device 61 can detect an object mass, which is a mass of the object, or an object weight, which is a weight of the object, based on the synthetic mass or the synthetic weight and the wearer mass or the wearer weight, and obtains a load-related amount based on the object mass or the object weight (the object mass or the object weight before correction, or the object mass or the object weight after correction).

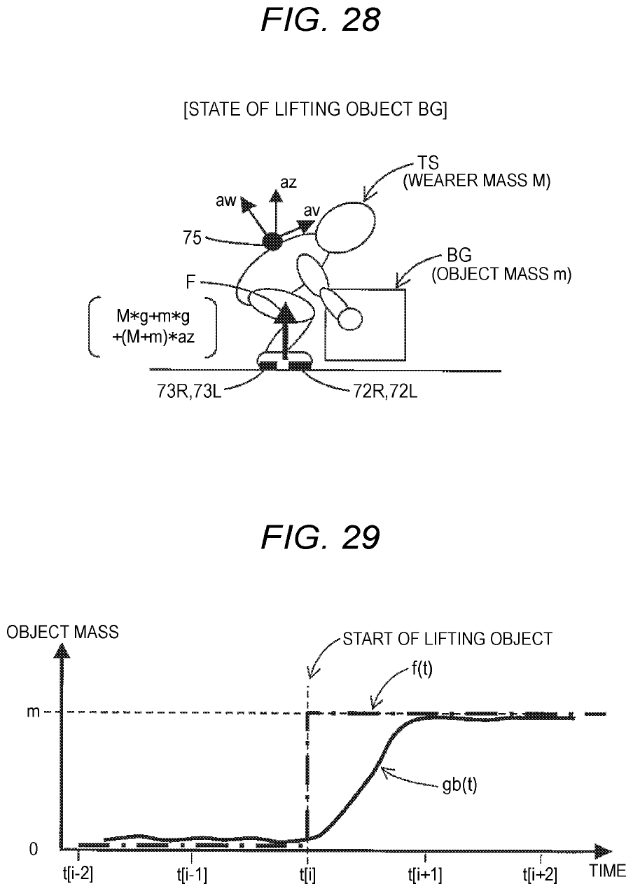

The acceleration detection unit 75 is, for example, an acceleration sensor, and for example, is provided in the backpack portion 37, and detects a body motion acceleration, which is an acceleration of motion of a part of a body of the wearer (in this case, an upper body of the wearer). Since the backpack portion 37 is fixed to the back of the wearer, the acceleration detection unit 75 detects a body motion acceleration av in a spine-parallel direction along a back surface of the wearer (see FIGS. 27 and 28) and a body motion acceleration aw in a back-orthogonal direction orthogonal to the back surface of the wearer (see FIGS. 27 and 28). The control device 61 can obtain a body motion acceleration az (see FIG. 28) of a vertical component based on the body motion accelerations av, aw, and the like.

As will be described later, the control device 61 corrects the object mass (object weight) obtained based on the detection signals from the load detection units 72L, 72R, 73L, 73R using the body motion acceleration az obtained based on the detection signal from the acceleration detection unit 75, so as to obtain the load-related amount (in this case, the object mass or the object weight after correction).

The body wearing tool 2 (see FIG. 3) is to be worn around at least the waist of the wearer. The right actuator unit 4R and the left actuator unit 4L (see FIG. 4) are to be worn on the body wearing tool 2 and the thighs of the wearer to assist the motion of the thighs or with respect to the waist of the wearer or the motion of the waist with respect the thighs of the wearer. Hereinafter, the body wearing tool 2 and the actuator unit 4 will be described in order.

[Appearance of Body Wearing 2 (FIG. 3)]

As illustrated in FIGS. 2 and 3, the body wearing tool device 2 includes the waist support portion 10 to be worn around the waist of the wearer, the jacket portion 20 to be worn around shoulders and a chest of the wearer, the frame portion 30 to which the jacket portion 20 is connected, and the backpack portion 37 and the cushion 37G attached to the frame portion 30. The frame portion 30 is disposed around the back and the waist of the wearer.

[Overall Structure of Frame Portion 30 (FIGS. 2, 3, and 5)]

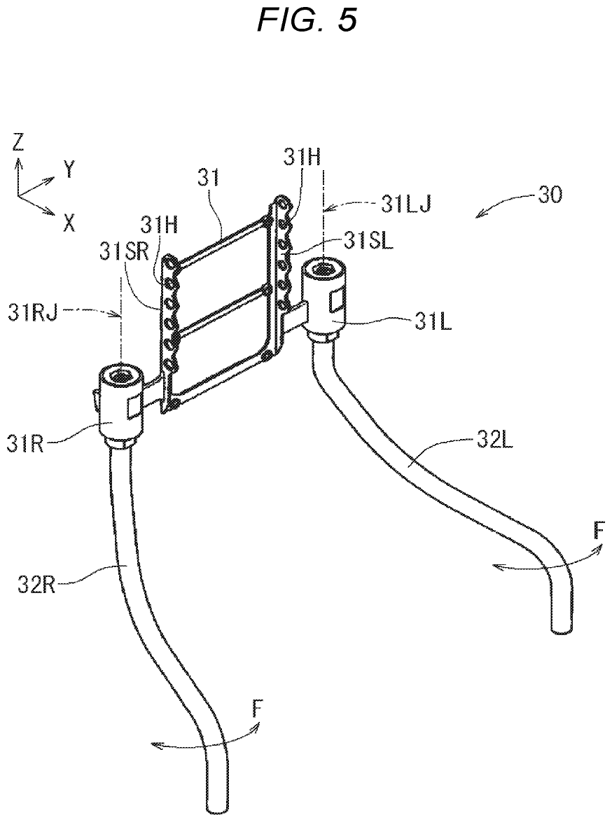

As illustrated in FIGS. 2 and 5, the frame portion 30 includes a main frame 31, a right sub-frame 32R, a left sub-frame 32L, and the like. As illustrated in FIG. 5, the main frame 31 includes support bodies 31SR, 31SL each having a plurality of belt connection holes 31H arranged in the vertical direction, a connecting portion 31R, and a connecting portion 31L. One end (upper end) of the right sub-frame 32R is connected to the connecting portion 31R, and one end (upper end) of the left sub-frame 32L is connected to the connecting portion 31L. The right sub-frame 32R and the left sub-frame 32L have elasticity, and an interval between the left and right lower end portions thereof are adjusted together with the waist support portion 10 according to a waist width of the wearer (see FIG. 1).

As illustrated in FIG. 1, the lower end portion of the right sub-frame 32R is connected (fixed) to a connecting portion 41RS of the right actuator unit 4R, and the lower end portion of the left sub-frame 32L is connected (fixed) to a connecting portion 41LS of the left actuator unit 4L.

[Overall Structure of Waist Support Portion 10 (FIGS. 2, 3, and 6)]

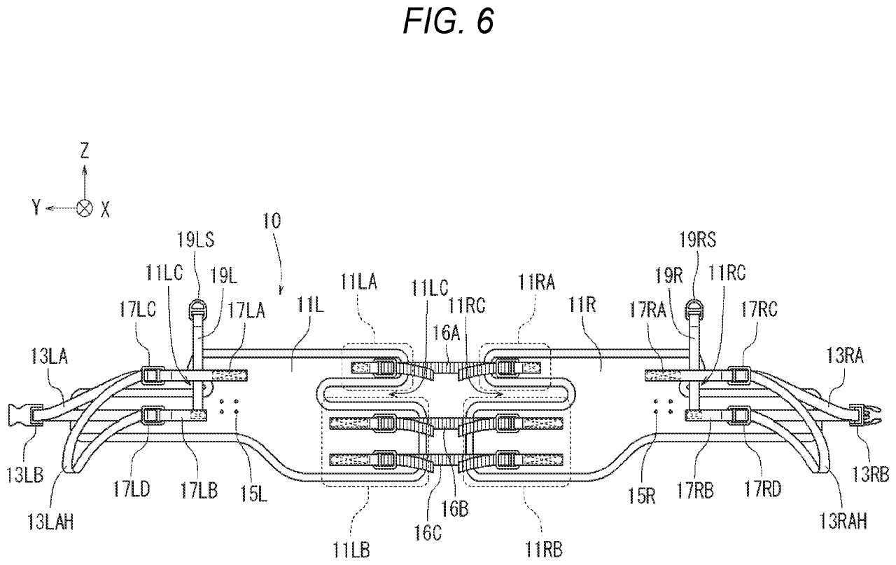

As illustrated in FIGS. 3 and 6, the waist support portion 10 includes a right waist wearing portion 11R to be worn around the waist of a right half body of the wearer and a left waist wearing portion 11L to be worn around the waist of a left half body of the wearer. As illustrated in FIG. 6, the right waist wearing portion 11R and the left waist wearing portion 11L are connected by a back waist belt 16A, a buttock upper belt 16B, and a buttock lower belt 16C.

As illustrated in FIGS. 1 and 2, the waist support portion 10 includes a coupling belt 19R including a coupling ring 19RS coupled to a coupling portion 29RS of the jacket portion 20, and a coupling belt 19L including a coupling ring 19LS coupled to a coupling portion 29LS of the jacket portion 20. As illustrated in FIG. 2, the waist support portion 10 includes attachment holes 15R for connecting to a coupling portion 40RS of the right actuator unit 4R and attachment holes 15L for connecting to the coupling portion 40LS of the left actuator unit 4L at positions intersecting a virtual rotational axis 15Y.

Further, as illustrated in FIG. 6, a position on the back side of the wearer in the right waist wearing portion 11R is formed with a notch portion 11RC, and thus is divided into a right waist 11RA and a right hip portion 11RB. A position on the back side of the wearer in the left waist wearing portion 11L is formed with a notch portion 11LC, and thus is divided into a left waist 11LA and a left hip portion 11LB.

As illustrated in FIG. 6, the waist support portion 10 includes various belts, whose length can be adjusted, for close contact around the waist of the wearer without being displaced, such as a right waist tightening belt 13RA, a waist belt holding member 13RB (waist buckle), a left waist tightening belt 13LA, a waist belt holding member 13LB (waist buckle), a right pelvis upper belt 17RA, a right pelvic lower belt 17RB, a left pelvis upper belt 17LA, a left pelvic lower belt 17LB, an upper right belt holding member 17RC (upper right triglide), a lower right belt holding member 17RD (lower right triglide), a tensile portion 13RAH, an upper left belt holding member 17LC (upper left triglide), a lower left belt holding member 17LD (lower left triglide), and a tension portion 13LAH.

[Configuration of Backpack Portion 37 and Periphery of Backpack Portion 37 (FIGS. 1 to 3)]

As illustrated in FIGS. 1 and 3, the backpack portion 37 is attached to the main frame 31, which serves as an upper end portion of the frame portion 30. As illustrated in FIG. 3, a right shoulder belt 24R, a right underarm belt 25R, a left shoulder belt 24L, and a left underarm belt 25L of the jacket portion 20 are connected to the main frame 31 or the backpack portion 37.

As illustrated in FIGS. 1 to 3, the backpack portion 37 has a simple box-like shape, and accommodates a control device, a power supply unit, a communication unit, and the like. As illustrated in FIG. 3, the support bodies 31SR, 31SL, on which of each the plurality of belt connection holes 31H (corresponding to the belt connection portions) are arranged in the vertical direction, are provided at positions respectively facing both shoulders on the back side of the wearer on the main frame 31. That is, the plurality of belt connecting holes 31H (belt connecting portions) are provided so as to be able to adjust the position of the jacket portion 20 in a height direction with respect to the frame portion 30 according to a physique of the wearer. Therefore, a height of the jacket portion 20 can be adjusted to an appropriate position in accordance with the physique of the wearer.

Even when the upper body of the wearer is leaning forward, the cushion 37G (or a back rest portion 37C) that contacts the back is elongated from the shoulders toward the waist of the wearer, so that the actuator units (4R, 4L) that output the assist torques can be supported appropriately. Further, even when the upper body of the wearer is leaning left or right, the cushion 37G (or a back rest portion 37C) is in contact with a bending center on the back of the wearer, so that the actuator units (4R, 4L) that output the assist torques can be supported appropriately.

As illustrated in FIG. 3, a belt connection portion 24RS of the right shoulder belt 24R is connected to any one of the belt connection holes 31H (belt connection portion) of the support body 31SR. Similarly, as illustrated in FIG. 3, a belt connection portion 24LS of the left shoulder belt 24L is connected to any one of the belt connection holes 31H (belt connection portion) of the support body 31SL. The support bodies 31SR, 31SL may also be provided on the backpack portion 37.

As illustrated in FIG. 3, belt connecting portions 37FR, 37FL are respectively provided on left and right sides of a lower end of the backpack portion 37. As illustrated in FIG. 3, a belt connecting portion 25RS of the right underarm belt 25R is connected to the belt connecting portion 37FR. Similarly, as illustrated in FIG. 3, a belt connecting portion 25RS of the left underarm belt 25L is connected to the belt connecting portion 37FR. The belt connecting portions 37FR, 37FL may also be provided on the main frame 31.

[Overall Structure of Jacket Portion 20 (FIGS. 2, 3, and 7)]

As illustrated in FIG. 3, the jacket portion 20 includes a right chest wearing portion 21R to be worn around the chest of a right half body of the wearer and a left chest wearing portion 21L to be worn around the chest of a left half body of the wearer. The right chest wearing portion 21R is connected to the left chest wearing portion 21L by, for example, a hook-and-loop fastener 21F and a buckle 21B to facilitate wearing on and taking off from the wearer of the jacket portion 20.

As illustrated in FIG. 3, the right chest wearing portion 21R includes the right shoulder belt 24R and the belt connecting portion 24RS that are connected to one of the belt connecting holes 31H of the main frame 31 (or the backpack portion 37), and the right underarm belt 25R and the belt connecting portion 25RS that are connected to the belt connecting portions 37FR, 37FL of the backpack portion 37 (or the main frame 31). As illustrated in FIG. 3, the left chest wearing portion 21L includes the left shoulder belt 24L and the belt connecting portion 24LS that are connected to the main frame 31 (or the backpack portion 37), and the left underarm belt 25L and the belt connecting portion 25LS that are connected to the backpack portion 37 (or the main frame 31). As illustrated in FIG. 3, the right chest wearing portion 21R includes a coupling belt 29R and a connecting portion 29RS for coupling with the right waist wearing portion 11R, and the left chest wearing portion 21L including a coupling belt 29L and a coupling portion 29LS for coupling with the left waist wearing portion 11L.

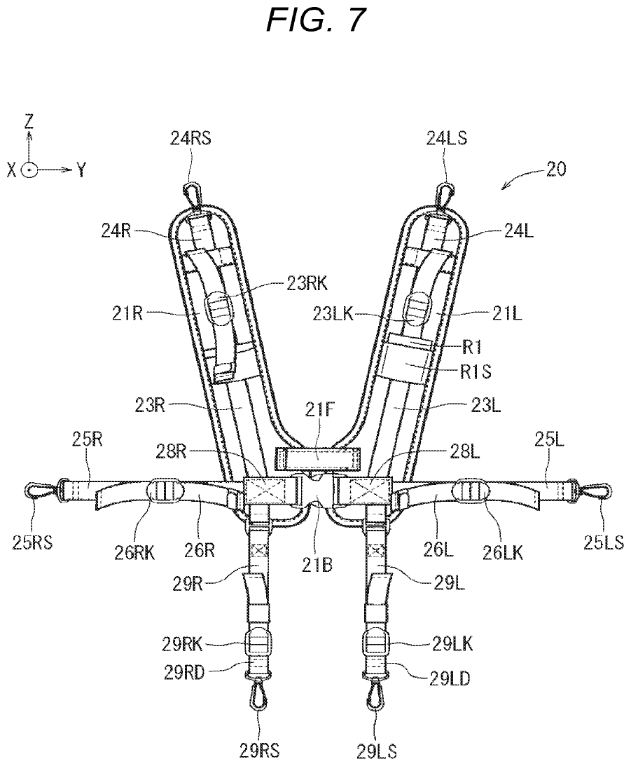

As illustrated in FIG. 7, the jacket portion 20 includes various belts, whose length can be adjusted, for close contact around the chest of the wearer without being displaced, such as a fixing portion 28R, a fixing portion 28L, a right shoulder belt 23R, a right shoulder belt holding member 23RK (right shoulder triglide), a left shoulder belt 23L, a left shoulder belt holding member 23LK (left shoulder triglide), a right underarm belt 26R, a right underarm belt holding member 26RK (right underarm triglide), a left underarm belt 26L, a left underarm belt holding member 26LK (left underarm triglide), and the like.

[Overall Configuration of Right Actuator Unit 4R and Left Actuator Unit 4L (FIGS. 2, 4, 8, and 9)]

FIG. 4 shows an appearance of the right actuator unit 4R and the left actuator unit 4L illustrated in FIG. 2, and the load detection units 71L, 71R. Since the left actuator unit 4L is left-right symmetrical with respect to the right actuator unit 4R, description of the left actuator unit 4L will be omitted in the following description.

As illustrated in FIG. 4, the right actuator unit 4R includes a torque generation unit 40R and an output link 50R that serves as a torque transmission unit. The torque generation unit 40R includes an actuator base portion 41R, a cover 41RB, and a coupling base 4AR. As illustrated in FIG. 4, the output link 50R rotates around a joint (in this case, a hip joint) of the assist target body part (in this case, the thigh) so as to be worn on the assist target body part (in this case, the thigh). The assist torque for assisting the rotation of the assist target body portion via the output link 50R is generated by an electric motor (actuator) in the torque generation unit 40R.

The output link 50R includes an assist arm 51R (corresponding to a first link), a second link 52R, a third link 53R, and a thigh wearing portion 54R (corresponding to a body holding portion). The assist arm 51R is rotated around a rotation axis 40RY by a synthetic torque obtained by synthesizing the assist torque generated by the electric motor in the torque generation unit 40R and a wearer torque due to the motion of the thigh of the wearer. One end of the second link 52R is connected to a tip end of the assist arm 51R in a manner rotatable around a rotation axis 51RJ, and one end of the third link 53R is connected to the other end of the second link 52R in a manner rotatable around the rotation axis 52RJ. The thigh wearing portion 54R is connected to the other end of the third link 53R via a third joint portion 53RS (in this case, a spherical joint).

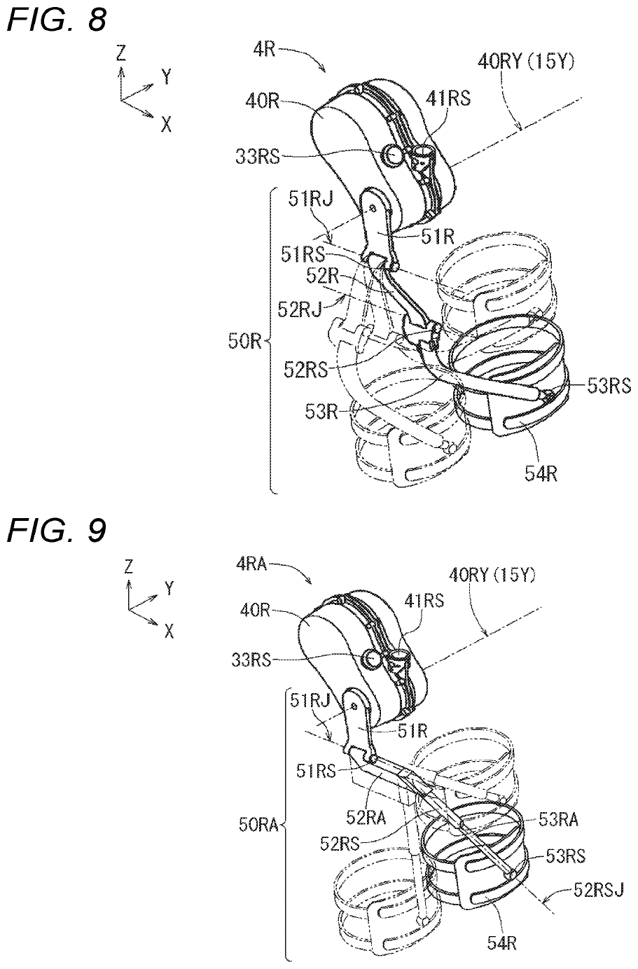

Next, a link mechanism of the right actuator unit 4R will be described in detail with reference to FIGS. 4, 8, and 9. As examples of the link mechanism, an example of the output link 50R illustrated in FIG. 8 and an example of an output link 50RA illustrated in FIG. 9 will be described.

In the output link 50R illustrated in FIG. 8, the assist arm 51R (corresponding to the first link), the second link 52R, the third link 53R, and the thigh wearing portion 54R (corresponding to the body holding portion) are coupled to one another by joint portions, so that the output link 50R is constituted by a plurality of coupling members.

One end of the second link 52R is coupled with the tip end of the assist arm 51R by a first joint portion 51RS in a manner rotatable around the rotation axis 51RJ. The first joint portion 51RS has a coupling structure in which a degree of freedom is one that allows the second link 52R to rotate around the rotation axis 51RJ with respect to the assist arm 51R.

One end of the third link 53R is coupled with the other end of the second link 52R by a second joint portion 52RS in a manner rotatable around the rotation axis 52RJ. The second joint portion 52RS has a coupling structure in which a degree of freedom is one that allows the third link 53R to rotate around the rotation axis 52RJ with respect to the second link 52R.

The thigh wearing portion 54R is coupled with the other end of the third link 53R by the third joint portion 53RS (e.g., a spherical joint). Therefore, the third joint portion 53RS between the third link and the thigh wearing portion 54R (body holding portion) has a coupling structure in which a degree of freedom is three. As described above, a total number of degrees of freedom of the output link 50R illustrated in FIG. 8 is five, since the sum of one plus one plus three equals five (1+1+3=5).

The total number of degrees of freedom of the output link 50R may be any number of three or more. For example, the third joint portion 53RS may be configured such that the thigh wearing portion 54R is rotatable around the rotation axis with respect to the other end of the third link 53R (i.e., degree of freedom is one). Since the degree of freedom of the first joint portion 51RS is “one” and the degree of freedom of the second joint portion 52RS is “one”, the total number of degrees of freedom of the output link in this case is 3 (the sum of one plus one plus one equals three). It is more preferable to provide a stopper that limits rotation ranges of the second link and the third link.

In the output link 50RA illustrated in FIG. 9, the assist arm 51R (corresponding to the first link), a second link 52RA (and the second joint portion 52RS), a third link 53RA, and the thigh wearing portion 54R (corresponding to the body holding portion) are coupled to one another by joint portions, so that the output link 50RA is constituted by a plurality of coupling members.

An end portion of the second link 52RA is coupled with the tip end of the assist arm 51R by the first joint portion 51RS in a manner rotatable around the rotation axis 51RJ. The first joint portion 51RS has a coupling structure in which a degree of freedom is one that allows the second link 52RA to rotate around the rotation axis 51RJ with respect to the assist arm 51R.

The second link 52RA and the second joint portion 52RS are integrated, and a side of one end of the third link 53RA that is reciprocally slidable along a slide axis 52RSJ in a longitudinal direction is connected to the second link 52RA by the second joint portion 52RS. The second joint portion 52RS has a coupling structure in which a degree of freedom is one that allows the third link 53RA to slide along the slide axis 52RSJ with respect to the second link 52RA.

The thigh wearing portion 54R is coupled with the other end of the third link 53RA by the third joint portion 53RS (e.g., a spherical joint). Therefore, the third joint portion 53RS between the third link 53RA and the thigh wearing portion 54R (body holding portion) has a coupling structure in which a degree of freedom is three. As described above, a total number of degrees of freedom of the output link 50RA illustrated in FIG. 9 is five, since the sum of one plus one plus three equals five (1+1+3=5).

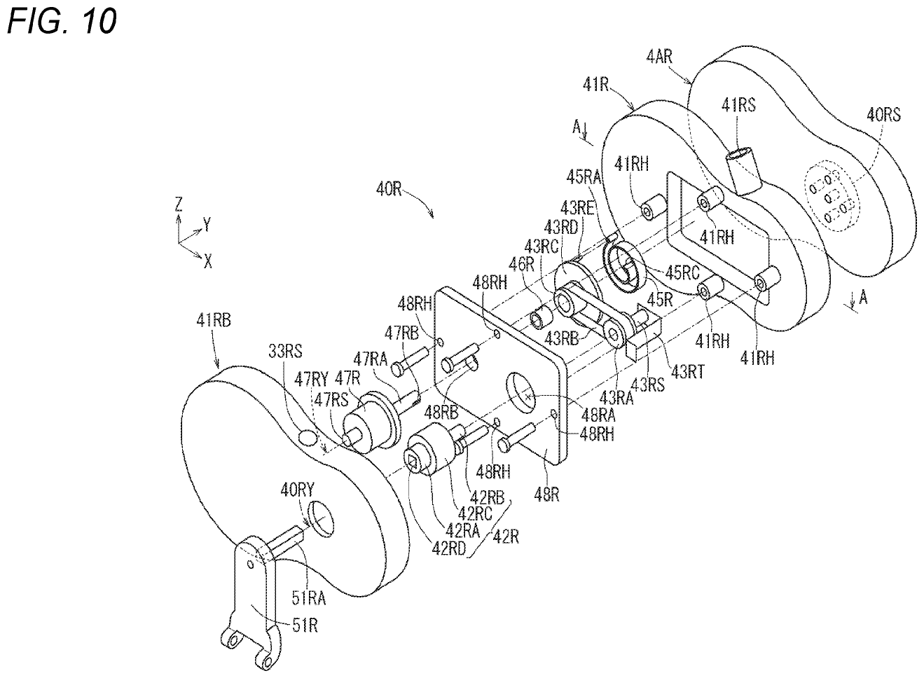

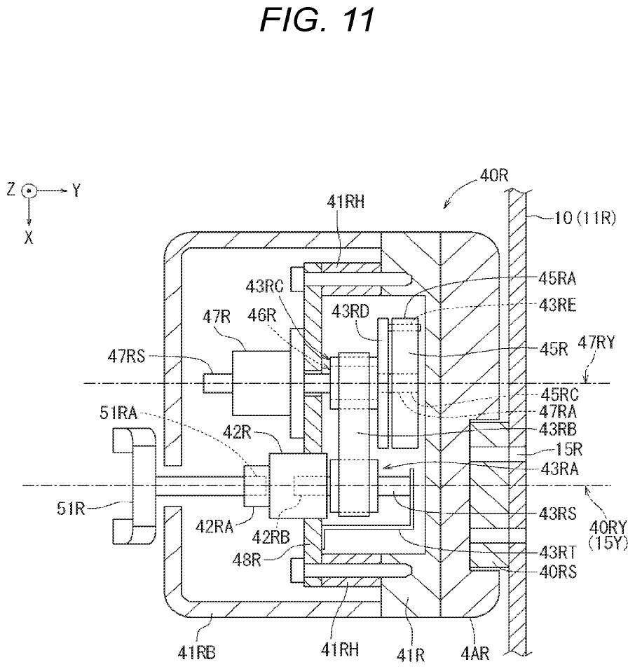

Since the total number of degrees of freedom may be any number of 3 or more, the third joint portion 53RS may have a coupling structure in which a degree of freedom is one such that the thigh wearing portion 54R is rotatable around the rotation axis. It is more preferable to provide a stopper that limits a rotation range of the second link 52RA and a slide range of the third link 53RA.

[Internal Structure of Torque Generation Unit 40R in Right Actuator Unit 4R (FIGS. 10 and 11)]

Next, members accommodated in the cover 41RB of the torque generation unit 40R (see FIG. 4) will be described with reference to FIGS. 10 and 11. FIG. 11 is a cross-sectional view taken along line A-A in FIG. 10. As illustrated in FIGS. 10 and 11, a speed reducer 42R, a pulley 43RA, a transmission belt 43RB, a pulley 43RC having a flange portion 43RD, a spiral spring 45R, a bearing 46R, an electric motor 47R (actuator), a sub-frame 48R, and the like are accommodated in the cover 41RB. The assist arm 51R, which includes a shaft portion 51RA, is disposed outside the cover 41RB.

In addition, outlet ports 33RS, 33LS (connection ports) of cables for actuator drive, control, and communication are provided on portions of the actuator units (4R, 4L) close to the frame portion 30. Cables (not shown) respectively connected to the outlet ports 33RS, 33LS of the cables are disposed along the frame portion 30 and are connected to the backpack portion 37.

As illustrated in FIG. 11, the torque generation unit 40R includes the actuator base portion 41R on which the sub-frame 48R mounted with the electric motor 47R and the like is attached, the cover 41RB attached to one side of the actuator base portion 41R, and the coupling base 4AR attached to the other side of the actuator base portion 41R. The coupling base 4AR is provided with the coupling portion 40RS which is rotatable around the rotation axis 40RY.

As illustrated in FIGS. 10 and 11, an output link rotation angle detection unit 43RS (rotation angle sensor or the like) that detects a rotation angle of the assist arm 51R with respect to the actuator base portion 41R is connected to the pulley 43RA connected to the speed-increasing shaft 42RB of the speed reducer 42R. The output link rotation angle detection unit 43RS is, for example, an encoder or an angle sensor, and outputs a detection signal corresponding to the rotation angle to the control device 61 (see FIG. 15). The electric motor 47R is provided with a motor rotation angle detection unit 47RS capable of detecting a rotation angle of a motor shaft (corresponding to an output shaft). The motor rotation angle detection unit 47RS is, for example, an encoder or an angle sensor, and outputs a detection signal corresponding to the rotation angle to the control device 61 (see FIG. 15).

As illustrated in FIG. 10, a through hole 48RA for fixing a speed reducer housing 42RC of the speed reducer 42R and a through hole 48RB through which an output shaft 47RA of the electric motor 47R is inserted are formed on the sub-frame 48R. The shaft portion 51RA of the assist arm 51R is fitted into a hole portion 42RD of the speed-reducing shaft 42RA of the speed reducer 42R, and the speed reducer housing 42RC of the speed reducer 42R is fixed in the through hole 48RA of the sub-frame 48R. Accordingly, the assist arm 51R is supported so as to be rotatable around the rotation axis 40RY with respect to the actuator base portion 41R, and rotates integrally with the speed-reducing shaft 42RA. The electric motor 47R is fixed to the sub-frame 48R, and the output shaft 47RA is inserted into the through hole 48RB of the sub-frame 48R. The sub-frame 48R is fixed to an attachment portion 41RH of the actuator base portion 41R by a fastening member such as a bolt.

As illustrated in FIG. 10, the pulley 43RA is connected to the speed-increasing shaft 42RB of the speed reducer 42R, and the output link rotation angle detection unit 43RS is connected to the pulley 43RA. A support member 43RT fixed to the sub-frame 48R is connected to the output link rotation angle detection unit 43RS. Thus, the output link rotation angle detection unit 43RS can detect a rotation angle of the speed-increasing shaft 42RB with respect to the sub-frame 48R (that is, with respect to the actuator base portion 41R). Moreover, since the rotation angle of the assist arm 51R is a rotation angle increased by the speed-increasing shaft 42RB of the speed reducer 42R, the output link rotation angle detection unit 43RS and the control device 61 can detect the rotation angle of the assist arm 51R at a higher resolution. By detecting the rotation angle of the output link at a higher resolution, the control device can perform control at higher accuracy. The shaft portion 51RA, the speed reducer 42R, the pulley 43RA, and the output link rotation angle detection portion 43RS of the assist arm 51R are arranged coaxially along the rotation axis 40RY.

The speed reducer 42R has a set gear reduction ratio n_{G} (1<n_{G}), and when the speed-reducing shaft 42RA is rotated by a rotation angle (θ_{L,R}), the speed-increasing shaft 42RB is rotated by a rotation angle n_{G}θ_{L,R}. When the speed-increasing shaft 42RB is rotated by the rotation angles n_{G}θ_{L,R}, the speed reducer 42R rotates the speed-reducing shaft 42RA by the rotation angle θ_{L,R}. The transmission belt 43RB is hung on the pulley 43RA, to which the speed-increasing shaft 42RB of the speed reducer 42R is connected, and the pulley 43RC. Therefore, the wearer torque from the assist arm 51R is transmitted to the pulley 43RC via the speed-increasing shaft 42RB, and the assist torque from the electric motor 47R is transmitted to the speed-increasing shaft 42RB via the spiral spring 45R and the pulley 43RC. A pulley reduction ratio n_{P}, which is a ratio of the speed-reducer-side pulley 43RA to the motor-side pulley 43RC (pulley reduction ratio=speed-reducer-side pulley 43RA:motor-side pulley 43RC=n_{P}:1), is set. For example, the gear reduction ratio n_{G} is set to about 50, and the pulley reduction ratio n_{P} is set to about 88/60.

The spiral spring 45R has a spring constant Ks, and has a spiral shape having an inner end portion 45RC on a center side and an outer end portion 45RA on an outer peripheral side. The inner end portion 45RC of the spiral spring 45R is fitted into a groove portion 47RB formed on the output shaft 47RA of the electric motor 47R. The outer end portion 45RA of the spiral spring 45R is wound into a cylindrical shape, and a transmission shaft 43RE provided on the flange portion 43RD of the pulley 43RC is fitted in the outer end portion 45RA so as to support the outer end portion 45RA (the pulley 43RC is integrated with the flange portion 43RD and the transmission shaft 43RE). The pulley 43RC is supported in a manner rotatable around a rotation axis 47RY, and the transmission shaft 43RE, which protrudes toward the spiral spring 45R, is provided in the vicinity of an outer peripheral edge of the flange portion 43RD which is integrated with the transmission shaft 43RE. The transmission shaft 43RE is fitted in the outer end portion 45RA of the spiral spring 45R, and moves the position of the outer end portion 45RA around the rotation axis 47RY. The bearing 46R is provided between the output shaft 47RA of the electric motor 47R and the pulley 43RC. That is, the output shaft 47RA is not fixed to the pulley 43RC, and the output shaft 47RA can freely rotate with respect to the pulley 43RC. The pulley 43RC is rotationally driven by the electric motor 47R via the spiral spring 45R. In the above configuration, the output shaft 47RA of the electric motor 47R, the bearing 46R, the pulley 43RC having the flange portion 43RD, and the spiral spring 45R are disposed coaxially along the rotation axis 47RY.

The spiral spring 45R stores the assist torque transmitted from the electric motor 47R, stores the wearer torque transmitted via the assist arm 51R, the speed reducer 42R, the pulley 43RA, and the pulley 43RC by the motion of the thigh of the wearer, and as a result, stores a synthetic torque obtained by synthesizing the assist torque and the wearer torque. The synthetic torque stored in the spiral spring 45R rotates the assist arm 51R via the pulley 43RC, the pulley 43RA and the speed reducer 42R. With the above configuration, the output shaft 47RA of the electric motor 47R is connected to the output link (in the case of FIG. 10, the assist arm 51R) via the speed reducer 42R which reduces the rotation angle of the output shaft 47RA.

The synthetic torque stored in the spiral spring 45R is obtained based on an angular change amount from a no-load state and the spring constant, and for example, is obtained based on the rotation angle of the assist arm 51R (obtained by the output link rotation angle detection unit 43RS), and the rotation angle of the output shaft 47RA of the electric motor 47R (obtained by the motor rotation angle detection unit 47RS) and the spring constant Ks of the spiral spring 45R. Then, a wearer torque is extracted from the obtained synthetic torque, and an assist torque corresponding to the wearer torque is output from the electric motor.

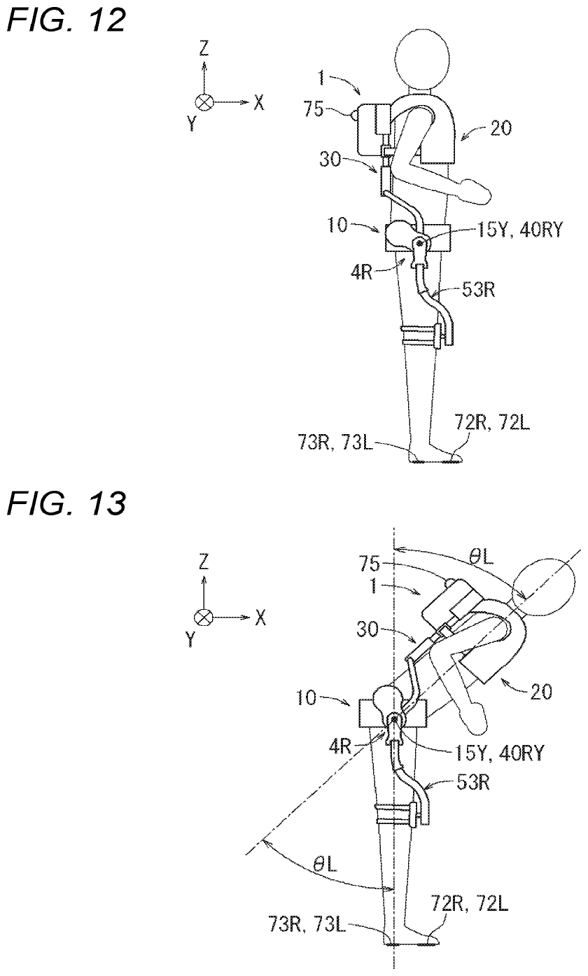

As illustrated in FIG. 11, the torque generation unit 40R of the right actuator unit includes a coupling portion 40RS which is rotatable around the rotation axis 40RY (that is, a virtual rotation axis 15Y). As illustrated in FIGS. 2 and 1, the coupling portion 40RS is connected (fixed) by a coupling member such as a bolt through the attachment hole 15R of the waist support portion 10. As illustrated in FIGS. 2 and 1, the lower end portion of the right sub-frame 32R of the frame portion 30 is connected (fixed) to the connecting portion 41RS of the right actuator unit 4R. Similarly, the coupling portion 40LS of the torque generation unit 40L of the left actuator unit is connected (fixed) by a coupling member such as a bolt through the attachment hole 15L of the waist support portion 10, and the lower end portion of the left sub-frame 32L of the frame portion 30 is connected (fixed) to the connecting portion 41LS of the left actuator unit 4L. That is, in FIG. 2, the waist support portion 10 and the frame portion 30 are fixed to the torque generation unit 40R of the right actuator unit 4R, and the waist support portion 10 and the frame portion 30 are fixed to the torque generation unit 40L of the left actuator unit 4L. The right actuator unit 4R, the left actuator unit 4L, and the frame portion 30 are integrated, and are rotatable with respect to the waist support portion 10 by the coupling portions 40RS, 40LS (see FIG. 2) which are rotatable around the virtual rotation axis 15Y (see FIGS. 12 and 13).

As described above, the control device 61 can detect the rotation angle and the rotation direction of the spiral spring 45R from the no-load state based on the detection signal from the output link rotation angle detection unit 43RS and the detection signal from the motor rotation angle detection unit 47RS, and can detect the torque (synthetic torque) with the rotation angle, the rotation direction and the spring constant of the spiral spring 45R. In this case, the output link rotation angle detection unit 43RS, the motor rotation angle detection unit 47RS, and the spiral spring 45R correspond to a torque detection unit, and the control device 61 can detect a torque-related amount (in this case, the synthetic torque) related to the torque based on the forward-leaning angle detected by using the output link rotation angle detection unit 43RS (corresponding to an angle detection unit).

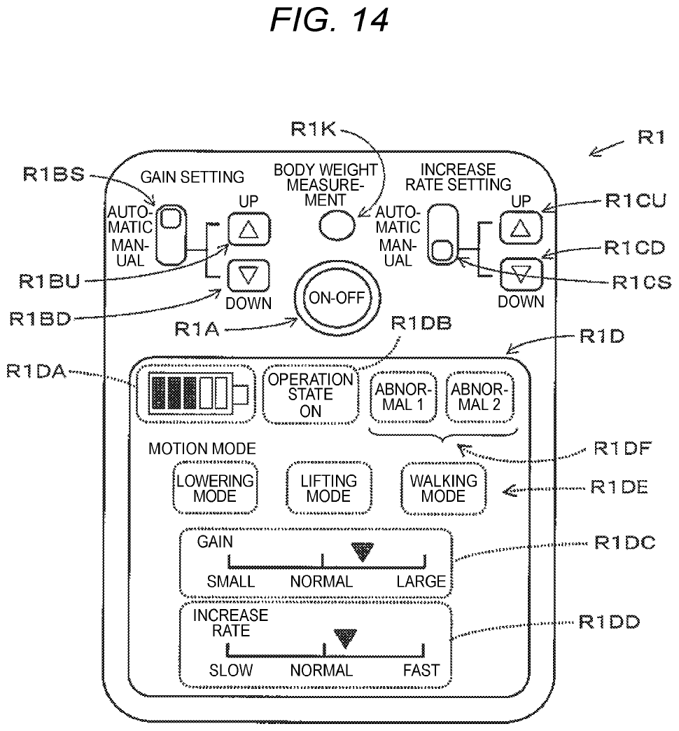

In the above description, the electric motor 47R, the spiral spring 45R, the motor rotation angle detection unit 47RS, and the output link rotation angle detection unit 43RS are all provided in the right actuator unit 4R. Although not shown, an electric motor 47L, a spiral spring 45L, a motor rotation angle detection unit 47LS, and an output link rotation angle detection unit 43LS are similarly provided in the left actuator unit 4L. When described in the following description, the electric motor 47L, the spiral spring 45L, the motor rotation angle detection unit 47LS, or the output link rotation angle detection unit 43LS refers to that provided in the left actuator unit 4L, although not illustrated.

[Appearance, Configuration, etc. of Operation Unit R1 (FIGS. 14 to 16)]

Next, the operation unit R1 which allows the wearer to easily adjust an assist state of the power assist suit 1 will be described with reference to FIGS. 14 to 16. As illustrated in FIG. 15, the operation unit R1 is connected to the control device 61 in the backpack portion 37 (see FIG. 1) via a wired or wireless communication line R1T. A control device R1E of the operation unit R1 can transmit and receive information to and from the control device 61 via a first communication unit R1EA, and the control device 61 can transmit and receive information to and from the control device R1E in the operation unit R1 via a communication unit 64. The control device R1E of the operation unit R1 can receive detection signals from the load detection units 72L, 72R, 73L, 73R via a second communication unit R1EB (e.g., wireless communication such as Bluetooth (registered trademark) or human body communication). As illustrated in FIG. 1, when the operation unit R1 is not operated, for example, the wearer can accommodate the operation unit R1 in the accommodation portion R1S such as a pocket provided in the jacket portion 20 (see FIG. 1).

As illustrated in FIG. 14, the operation unit R1 includes a main operation unit R1A, a gain automatic/manual switching operation unit R1BS, a gain up operation unit R1BU, a gain down operation unit R1BD, an increase rate automatic/manual switching operation unit R1CS, an increase rate up operation unit R1CU, an increase rate down operation unit R1CD, a body weight measurement operation unit R1K, a display unit R1D, and the like. The gain up operation unit R1BU and the gain down operation unit R1BD correspond to a gain changing unit, and the increase rate up operation unit R1CU and the increase rate down operation unit R1CD correspond to an increase rate changing unit. As illustrated in FIG. 15, the operation unit R1 includes the control device R1E, an operation unit power source R1F, and the like. The main operation unit R1A, the gain up operation unit R1BU, the gain down operation unit R1BD, the increase rate up operation unit R1CU, the increase rate down operation unit R1CD, the gain automatic/manual switching operation unit R1BS, the increase rate automatic/manual switching operation unit R1CS, and the body weight measurement operation unit R1K preferable do not protrude from disposed surfaces in order to prevent an erroneous operation when the operation unit R1 is accommodated in the accommodation portion R1S (see FIG. 1).

The main operation unit R1A is a switch for starting and stopping assist control by the power assist suit 1 upon operation from the wearer. As illustrated in FIG. 15, a main power switch 65 for starting and stopping the power assist suit 1 itself (as a whole) is provided, for example, on the backpack portion 37. When the main power switch 65 is operated to an ON side, the control device 61 and the control device R1E are activated, and when the main power switch 65 is operated to an OFF side, operation of the control device 61 and the control device R1E is stopped. As illustrated in FIG. 14, for example, a display area R1DB of the display unit R1D of the operation unit R1 displays whether a current operation state of the power assist suit is ON (operating) or OFF (stopped).

The gain automatic/manual switching operation unit R1BS is a switch that switches a gain (magnitude) of the assist torque between being automatically adjusted and manually adjusted by the wearer. When the gain automatic/manual switching operation unit R1BS is set to an “AUTOMATIC” side, operation of the gain up operation unit R1BU and the gain down operation unit R1BD is disabled, and the control device 61 detects the mass (or weight) of the object held by the wearer and automatically adjusts the magnitude of the assist torque according to the detected mass (or weight) of the object. When the gain automatic/manual switching operation unit R1BS is set to a “MANUAL” side, the operation of the gain up operation unit R1BU and the gain down operation unit R1BD is enabled, and the control device 61 changes the magnitude of the assist torque according to the operation of the gain up operation unit R1BU and the gain down operation unit R1BD. In order to detect the mass (or weight) of the object, it is necessary to measure the mass (or weight) of the wearer, and the body weight measurement operation unit R1K is used when the wearer causes the control device to measure his/her mass as will be described later. At the time of automatic gain, a learning model generated by machine learning (such as a neural network) may be used to adjust the gain (the learning model may be provided in a storage unit for learning in the control device 61 so as to perform learning operation and to adjust the gain, or a learning model of another power assist suit may be stored in the storage unit using the communication unit 64 or the like to perform the learning operation and to adjust the gain).

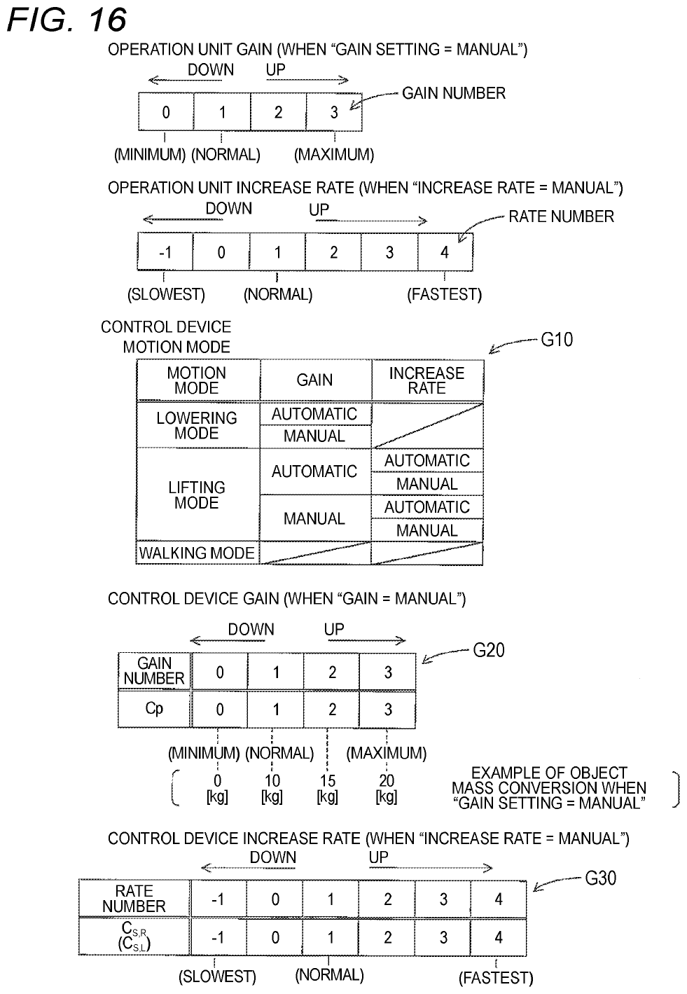

The gain up operation unit R1BU is a switch that increases the gain of the assist torque generated by the power assist suit upon operation from the wearer when the gain automatic/manual switching operation unit R1BS is set to the “MANUAL” side, and the gain down operation unit R1BD is a switch that reduces the gain of the assist torque generated by the power assist suit upon operation from the wearer. For example, as shown in “OPERATION UNIT GAIN (WHEN “GAIN SETTING=MANUAL”)” in FIG. 16, the control device R1E increases a stored gain number by one every time the gain up operation unit R1BU is operated, and reduces the gain number by one every time the gain down operation unit R1BD is operated. The example of FIG. 16 shows four examples whose gain numbers are respectively 0 to 3, without being limited to four. As illustrated in FIG. 14, for example, the control device R1E (see FIG. 15) displays according to the current gain number in a display area R1DC of the display unit R1D of the operation unit R1.

The increase rate automatic/manual switching operation unit R1CS is a switch that switches an increase rate of the assist torque (a timing for applying the assist torque) between being automatically adjusted and manually adjusted by the wearer. When the increase rate automatic/manual switching operation unit R1CS is set to an “AUTOMATIC” side, operation of the increase rate up operation unit R1CU and the increase rate down operation unit R1CD is disabled, and the control device 61 automatically adjusts the increase rate of the assist torque (the timing for applying the assist torque). When the increase rate automatic/manual switching operation unit R1CS is set to a “MANUAL” side, the operation of the increase rate up operation unit R1CU and the increase rate down operation unit R1CD is enabled, and the control device 61 changes the increase rate of the assist torque according to the operation of the increase rate up operation unit R1CU and the increase rate down operation unit R1CD. At the time of automatic increase rate, a learning model generated by machine learning (such as a neural network) may be used to adjust the increase rate (the learning model may be provided in a storage unit for learning in the control device 61 so as to perform learning operation and to adjust the increase rate , or a learning model of another power assist suit may be stored in the storage unit using the communication unit 64 or the like to perform the learning operation and to adjust the increase rate).

The increase rate up operation unit R1CU and the increase rate down operation unit R1CD are switches that adjust fast/slow of the increase rate of the assist torque (the timing for applying the assist torque) generated by the power assist suit by an operation from the wearer when the increase rate automatic/manual operation unit R1CS is set to the “MANUAL” side. For example, as shown in “OPERATION UNIT INCREASE RATE (WHEN “INCREASE RATE=MANUAL”)” in FIG. 16, the control device R1E increases a stored rate number by one every time the increase rate up operation unit R1CU is operated, and reduces the rate number by one every time the increase rate down operation unit R1CD is operated. The example of FIG. 16 shows six examples whose rate numbers are respectively −1 to 4, without being limited to six. As illustrated in FIG. 14, for example, the control device R1E (see FIG. 15) displays according to the current rate number in a display area R1DD of the display unit R1D of the operation unit R1.

The control device R1E of the operation unit R1 transmits operation information via the first communication unit R1EA (see FIG. 15) at a predetermined time interval (e.g., an interval of several [ms] to several hundred [ms]) or each time any one of the main operation unit R1A, the gain up operation unit R1BU, the gain down operation unit R1BD, the increase rate up operation unit R1CU, the increase rate down operation unit R1CD, the gain automatic/manual switching operation unit R1BS, and the increase rate automatic/manual switching operation unit R1CS is operated. The operation information includes the above-described stop instruction or start instruction, the gain number, the gain automatic/manual information from the gain automatic/manual switching operation unit, the rate number, the increase rate automatic/manual information from the increase rate automatic/manual switching operation unit, the body weight measurement instruction information from the body weight measurement operation unit, the detection signal from the load detection unit, and the like.

Upon receiving the operation information, the control device 61 of the backpack portion 37 stores the received operation information, and transmits, via the communication unit 64, response information including battery information indicating a state of a battery of a power supply unit 63 used to drive the power assist suit and assist information indicating an assist state (see FIG. 15). The battery information included in the response information includes a remaining amount of the power supply unit 63, and the assist information included in the response information includes error information indicating details of the abnormality, for example, when abnormality is found in the power assist suit. As illustrated in FIG. 15, for example, the control device R1E displays the battery remaining amount and the like on the display area R1DA (see FIG. 14) of the display unit R1D of the operation unit R1, and displays error information (in this case, “ABNORMALITY 1”, “ABNORMALITY 2”) ON the display area R1DF (see FIG. 14) OF the display unit R1D when error information is included.

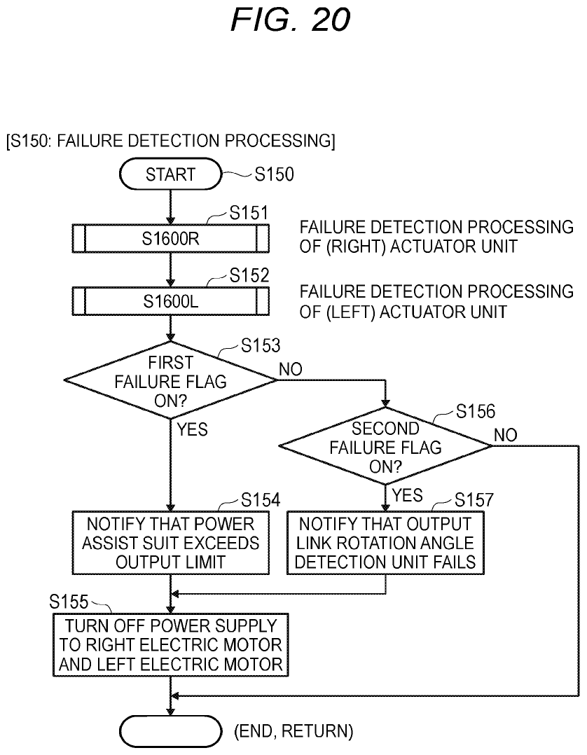

For example, when either one of the spiral springs 45L, 45R of the left actuator unit 4L or the right actuator unit 4R exceeds an output limit of a spring torque, an icon of “ABNORMALITY 1” (see FIG. 14) blinks (see FIG. 20). For example, when either one of the output link rotation angle detection units 43LS, 43LR of the left actuator unit 4L or the right actuator unit 4R fails, an icon of “ABNORMALITY 2” (see FIG. 14) blinks (see FIG. 20).

When the control device 61 receives the operation information from the control device R1E (see FIG. 15), the control device 61 (see FIG. 15) activates the power assist suit if the received operation information includes the start instruction, and stops the power assist suit if the received operation information includes the stop instruction. Further, for example, as indicated by the “CONTROL DEVICE GAIN” in FIG. 16, the control device 61 stores the value (0 to 3) of the gain Cₚ corresponding to the gain number, and stores a (right) increase rate C_{s,R} (right rate number: −1 to 4) and a (left) increase rate C_{s,L} (left rate number: −1 to 4) corresponding to the rate number. The above-described Cₚ, C_{s,R}, C_{s,L} are used in a processing procedure described below.

The power assist suit has three motion modes for generating assist torque for assisting the motion of the wearer, and the motion modes include a lowering mode, a lifting mode, and a walking mode. The lowering mode is a motion mode for assisting an object lowering operation by the wearer. The lifting mode is a motion mode for assisting an object lifting operation by the wearer. The walking mode is a motion mode for assisting a walking motion of the wearer. As will be described in detail later, the control device 61 automatically switches the above-described three motion modes based on the torques applied to the left actuator unit 4L and the right actuator unit 4R (see FIG. 1) (or the torque-related amounts related to the torques). As will be described later, the control device 61 switches to the “lifting mode” when it is determined that the wearer starts the lifting motion, switches to the “lowering mode” when it is determined that the wearer starts the lowering motion, and switches to the “walking mode” when it is determined that the wearer starts the walking motion.

As shown in the example of “CONTROL DEVICE MOTION MODE” in FIG. 16, in “LOWERING MODE”, the gain can be switched to automatic or manual by the gain automatic/manual switching operation unit R1BS (see FIG. 14), and automatic/manual switching is not provided for the increase rate. In “LIFTING MODE”, the gain can be switched to automatic or manual by the gain automatic/manual switching operation unit R1BS (see FIG. 14), and the increase rate can be switched to automatic or manual by the increase rate automatic/manual switching operation unit R1CS (see FIG. 14). In “WALKING MODE”, automatic/manual switching is not provided for the increase rate. The “CONTROL DEVICE MOTION MODE” illustrated in FIG. 16 is an example, and may enable automatic/manual switching for the increase rate in the lowering mode, and may enable automatic/manual switching for the gain in the walking mode.

As described above, via the operation of the operation unit R1, the wearer can easily perform adjustment for setting the desired assist state. Further, since the battery remaining amount, the error information, and the like are displayed on the display unit R1D of the operation unit R1, the wearer can easily grasp the state of the power assist suit. A form of the various types of information displayed on the display unit R1D is not limited to the example illustrated in FIG. 14.

[Input and Output of Control Device 61 (FIG. 15)]

As illustrated in FIG. 15, the control device 61 is accommodated in the backpack portion 37. In the example illustrated in FIG. 15, the control device 61, a motor driver 62, the power supply unit 63, and the like are accommodated in the backpack portion 37. The control device 61 includes, for example, a control portion 66 (CPU, microcomputer or processor), a storage portion 67 (storing control program and the like, and corresponding to a storage device or a memory). The control device 61 includes an adjustment determination unit 61A, an input processing unit 61B, and a torque change amount, etc. calculation unit 61C, a motion mode determination unit 61D, a selection unit 61E, a lowering assist torque calculation unit 61F, a lifting assist torque calculation unit 61G, a walking assist torque calculation unit 61H, a control command value calculation unit 61I, a load determination unit 61J, a failure detection processing unit 61K, the communication unit 64, and the like, which will be described later. The motor driver 62 is an electronic circuit that outputs a drive current for driving the electric motor 47R based on a control signal from the control device 61. The power supply unit 63 is, for example, a lithium battery, and supplies power to the control device 61 and the motor driver 62. Operation of the communication unit 64 will be described later. A detection signal from the acceleration detection unit 75 is input to the control device 61.

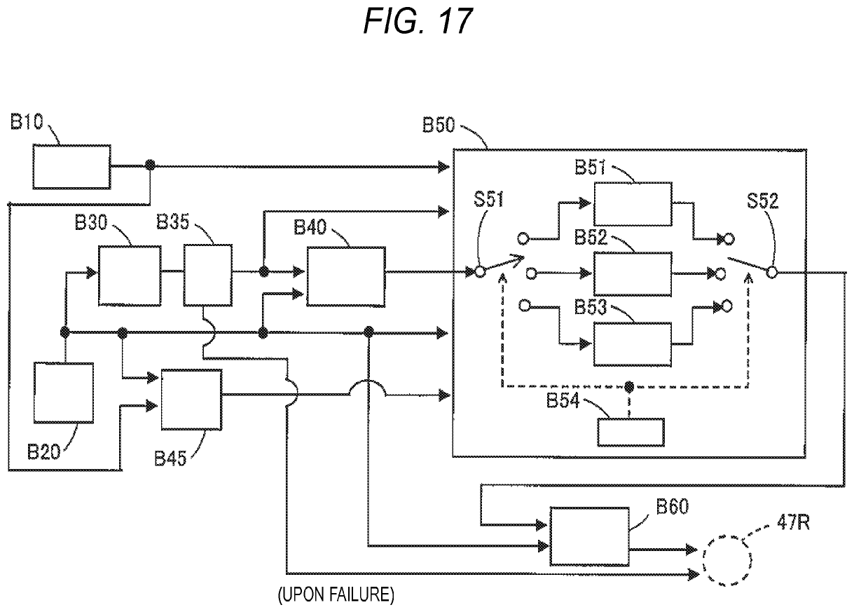

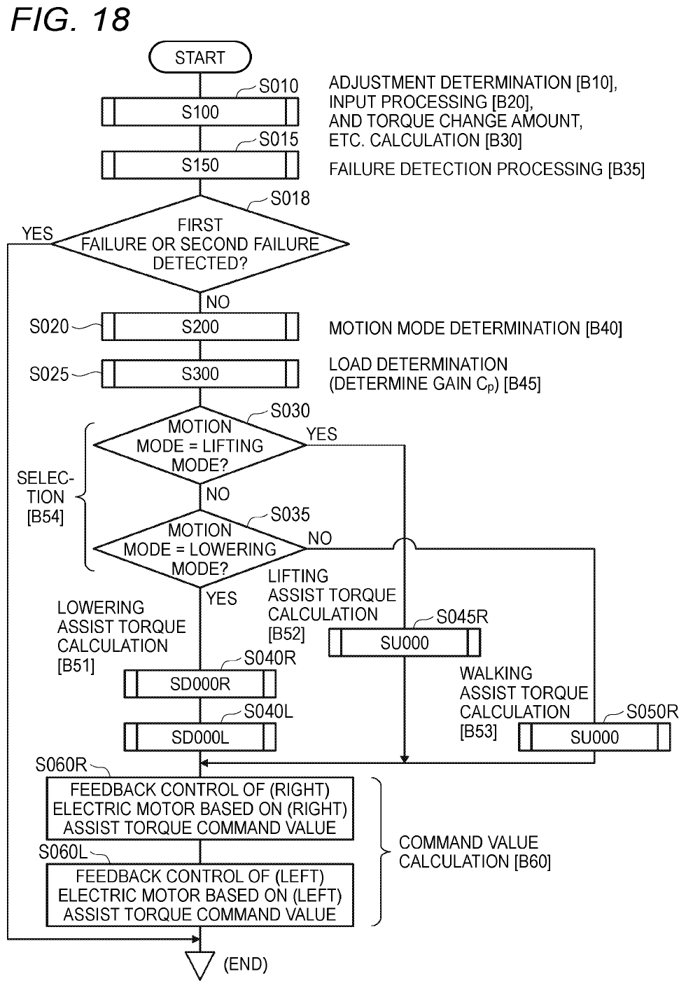

The operation information from the operation unit R1, a detection signal from the motor rotation angle detection unit 47RS (a detection signal corresponding to an actual motor shaft angle θ_{rM,R} of the (right) electric motor 47R), a detection signal from the (right) output link rotation angle detection unit 43RS (a detection signal corresponding to an actual link angle θ_{L,R} of the assist arm 51R), and the like are input to the control device 61. The control device 61 obtains the rotation angle of the (right) electric motor 47R based on the input signals, and outputs a control signal corresponding to the obtained rotation angle to the motor driver 62 (the same applies to the (left) electric motor).

[Control Block (FIG. 17) and Processing Procedure of Control Device 61 (FIG. 18)]

Next, a processing procedure of the control device 61 will be described with reference to the flowchart illustrated in FIG. 18 and the control block illustrated in FIG. 17. The control block illustrated in FIG. 17 includes an adjustment determination block B10, an input processing block B20, a torque change amount calculation block B30, a failure detection processing block B35, a motion mode determination block B40, a load determination block B45, a selection block B54, an assist torque calculation block B50, a lowering assist torque calculation block B51, a lifting assist torque calculation block B52, a walking assist torque calculation block B53, a control command value calculation block B60, switching switches S51, S52 and the like. Processing contents of each block will be described with reference to the flowchart illustrated in FIG. 18.

[Overall Processing Flow (FIG. 18)]

The flowchart illustrated in FIG. 18 shows a processing procedure for controlling the (right) actuator unit 4R and the (left) actuator unit 4L. The processing illustrated in FIG. 18 is started at a predetermined time interval (e.g., an interval of several [ms]), and when the processing is started, the control device 61 (corresponding to the control unit) proceeds to step S010. A processing program of the control device 61, data such as a map, and the like are stored in the storage portion 67 (corresponding to the storage device).

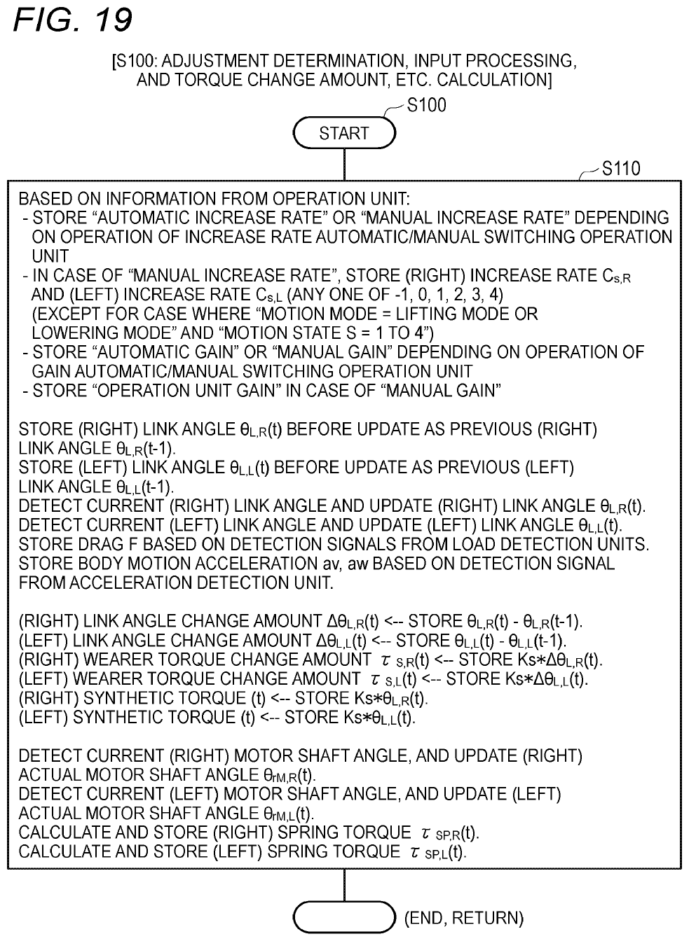

In step S010, the control device 61 executes the processing of S100 (see FIG. 19), and the processing proceeds to step S015. The processing of S100 corresponds to the adjustment determination block B10, the input processing block B20, and the torque change amount, etc. calculation block B30 illustrated in FIG. 17, and corresponds to the adjustment determination unit 61A, the input processing unit 61B, and the torque change amount, etc. calculation unit 61C illustrated in FIG. 15. Details of the processing in S100 will be described later.

In step S015, the control device 61 executes the processing of S150 (see FIG. 20), and the processing proceeds to step S018. The processing of S150 corresponds to the failure detection processing block B35 illustrated in FIG. 17, and corresponds to the failure detection processing unit 61K illustrated in FIG. 15. The processing of S150 is a processing of detecting a failure of the right actuator unit 4R and the left actuator unit 4L, and details of the processing of S150 will be described later.

In step S018, the control device 61 determines whether at least one of a first failure flag and a second failure flag is set to ON in the failure detection processing of step S015. The control device 61 ends the processing if at least one of the first failure flag or the second failure flag is ON (Yes), and proceeds to step S020 if neither of the first failure flag and the second failure flag is ON (No).

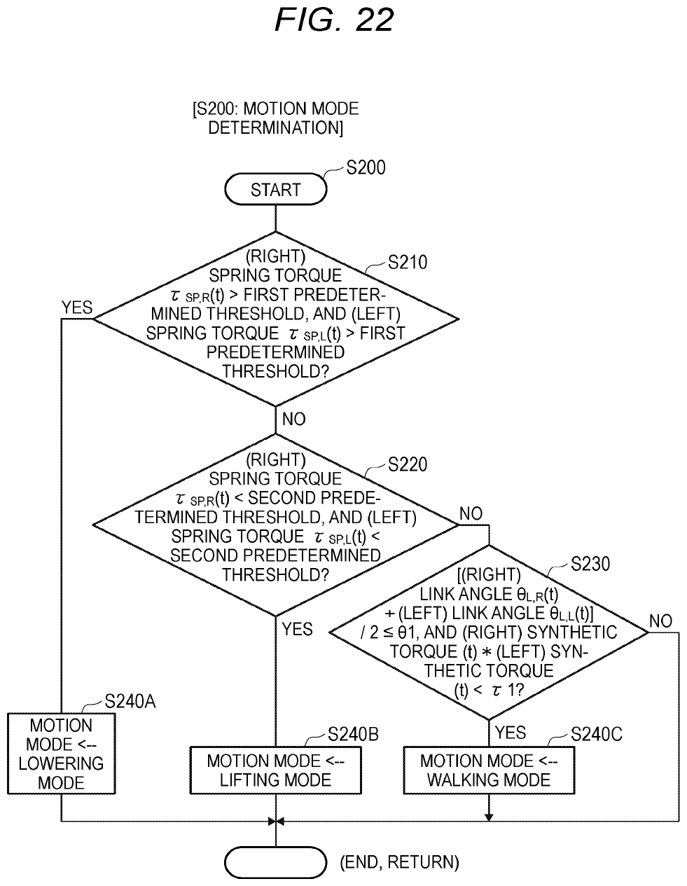

When the processing proceeds to step S020, the control device 61 executes the processing of S200 (see FIG. 22), and proceeds to step S025. The processing of S200 corresponds to the motion mode determination block B40 illustrated in FIG. 17, and corresponds to the motion mode determination unit 61D illustrated in FIG. 15. In the processing of S200, the control device 61 switches or maintains the motion mode to one of the “lifting mode”, the “lowering mode”, and the “walking mode”. Details of the processing in S200 will be described later.

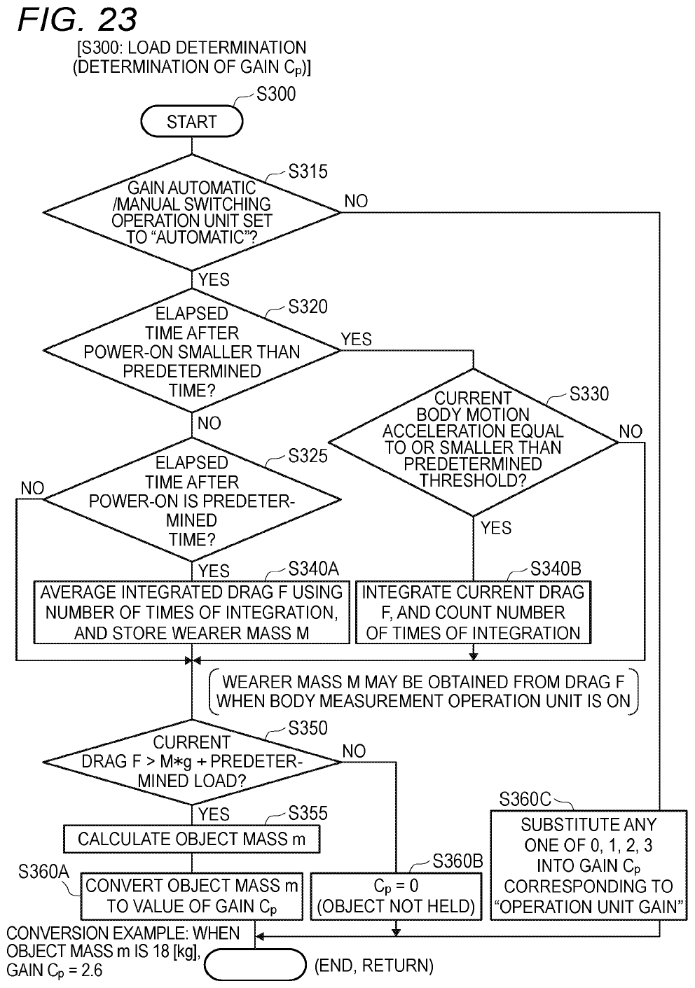

In step S025, the control device 61 executes the processing of S300 (see FIG. 23), and the processing proceeds to step S030. The processing of S300 corresponds to the load determination block B45 illustrated in FIG. 17, and corresponds to the load determination unit 61J illustrated in FIG. 15. The processing of S300 is a processing of determining a value of the gain Cₚ, and details of the processing of S300 will be described later.

In step S030, the control device 61 determines whether the motion mode determined in step S020 is the lifting mode. The control device 61 proceeds to step S045 if the motion mode is the lifting mode (Yes), and proceeds to step S035 if the motion mode is not the lifting mode (No).

When the processing proceeds to step S035, the control device 61 determines whether the motion mode determined in step S020 is the lowering mode. The control device 61 proceeds to step S040R if the motion mode is the lowering mode (Yes), and proceeds to step S050 if the motion mode is not the lowering mode (No). The processing in steps S030, S035 corresponds to the selection block B54 illustrated in FIG. 17, and corresponds to the selection unit 61E illustrated in FIG. 15.

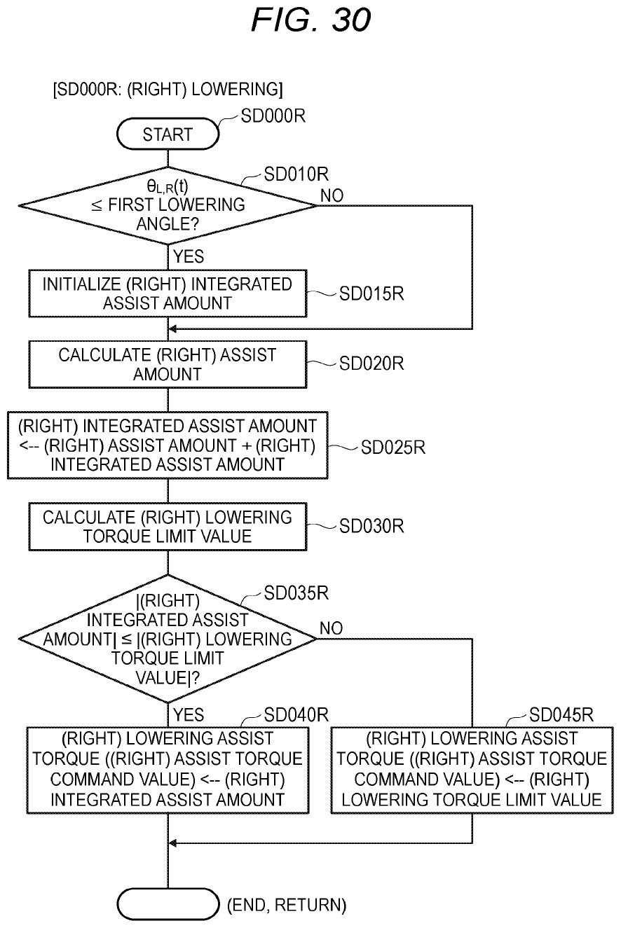

When the processing proceeds to step S040R, the control device 61 executes the processing of SD000R (see FIG. 30), and proceeds to step S040L. The processing of SD000R is a processing of obtaining a control command value of the (right) actuator unit 4R in the lowering motion, corresponds to the lowering assist torque calculation block B51 illustrated in FIG. 17, and corresponds to the lowering assist torque calculation unit 61F illustrated in FIG. 15. Details of the processing in SD000R will be described later.

In step S040L, the control device 61 executes the processing of SD000L (not shown), and proceeds to step S060R. The processing of SD000L is a processing of obtaining a control command value of the (left) actuator unit 4L in the lowering motion, corresponds to the lowering assist torque calculation block B51 illustrated in FIG. 17, and corresponds to the lowering assist torque calculation unit 61F illustrated in FIG. 15. Since the processing of SD000L is the same as that of SD000R, detailed description thereof will be omitted.

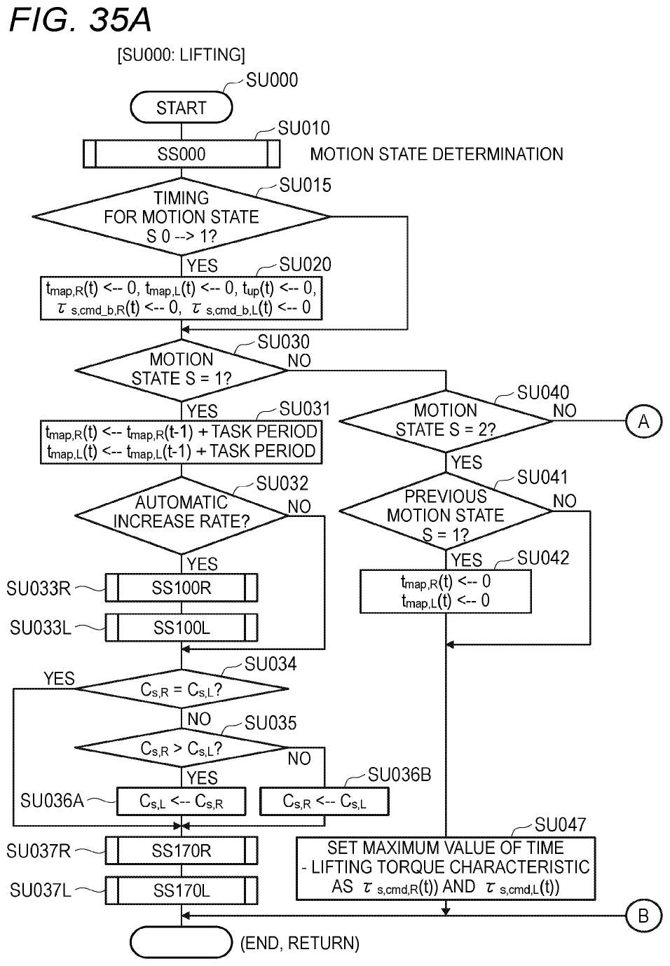

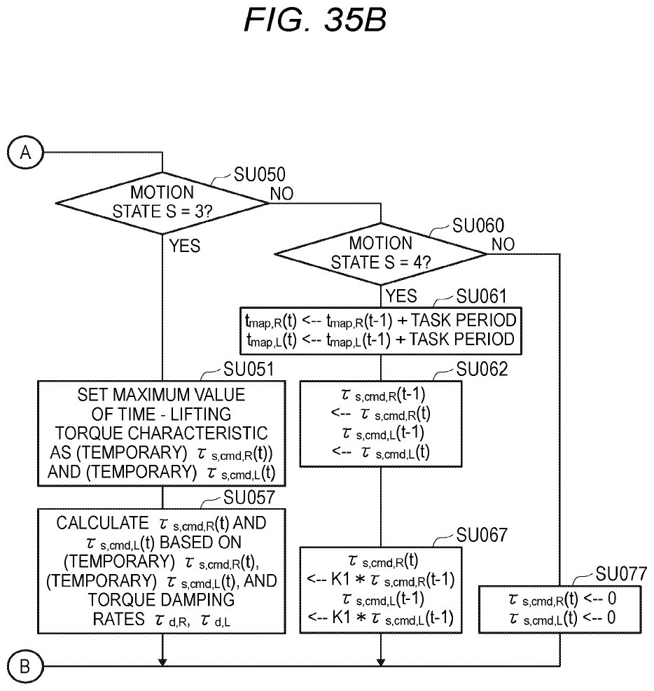

When the processing proceeds to step S045, the control device 61 executes the processing of SU000 (see FIGS. 35A and 35B), and proceeds to step S060R. The processing of SU000 is a processing of obtaining control command values of the (right) actuator unit 4R and the (left) actuator unit 4L in the lifting motion, corresponds to the lifting assist torque calculation block B52 illustrated in FIG. 17, and corresponds to the lifting assist torque calculation unit 61G illustrated in FIG. 15. Details of the processing in SU000 will be described later.

When the processing proceeds to step S050, the control device 61 executes the processing of SW000 (not shown), and proceeds to step S060R. The processing of SW000 is a processing of obtaining the control command values of the (right) actuator unit 4R and the (left) actuator unit 4L in the walking motion, corresponds to the walking assist torque calculation block B53 illustrated in FIG. 17, and corresponds to the walking assist torque calculation unit 61H illustrated in FIG. 15. Details of the processing in SW000 will be described later.

In step S060R, the control device 61 performs feedback control of the (right) electric motor based on the (right) assist torque command value obtained in step S060R or SU000 or SW000, and proceeds to step S060L.

In step S060L, the control device 61 performs feedback control of the (left) electric motor based on the (left) assist torque command value obtained in the SD000L or SU000 or SW000, and ends the processing. The processing of steps S060R, S060L corresponds to the control command value calculation block B60 illustrated in FIG. 17, and corresponds to the control command value calculation unit 611 illustrated in FIG. 15.

[Details of S100: Adjustment Determination, Input Processing, and Torque Change Amount, etc. Calculation (FIG. 19)]

Next, details of the processing in step S100 according to step S010 illustrated in FIG. 18 will be described with reference to FIG. 19. In the processing of S100, the control device 61 recognizes and stores whether the increase rate automatic/manual switching operation unit is set to “AUTOMATIC INCREASE RATE” or “MANUAL INCREASE RATE” based on the information from the operation unit. In a case of “MANUAL INCREASE RATE”, the control device 61 stores any one of −1, 0, 1, 2, 3, 4, as a (right) increase rate C_{s,R} and a (left) increase rate C_{s,L} based on the information from the operation unit, except for “A CASE WHERE MOTION MODE=LIFTING MODE OR LOWERING MODE AND MOTION STATE S=1 TO 4” (see “CONTROL DEVICE INCREASE RATE” in FIG. 16). Further, the control device 61 recognizes and stores whether the gain automatic/manual switching operation unit is set to “AUTOMATIC GAIN” or “MANUAL GAIN” based on the information from the operation unit, and stores “OPERATION UNIT GAIN (any one of 0, 1, 2, 3; see FIG. 16)” based on the information from the operation unit in the case of “MANUAL GAIN”. The above corresponds to the adjustment determination block B10 illustrated in FIG. 17 and the adjustment determination unit 61A illustrated in FIG. 15.

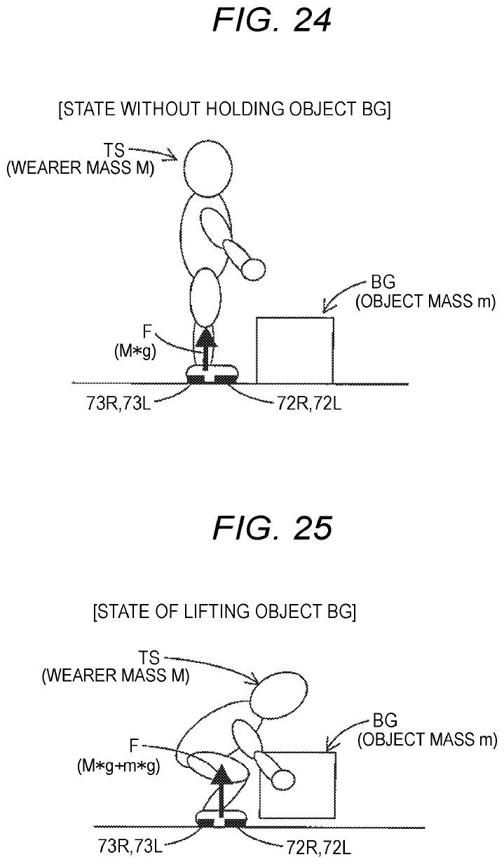

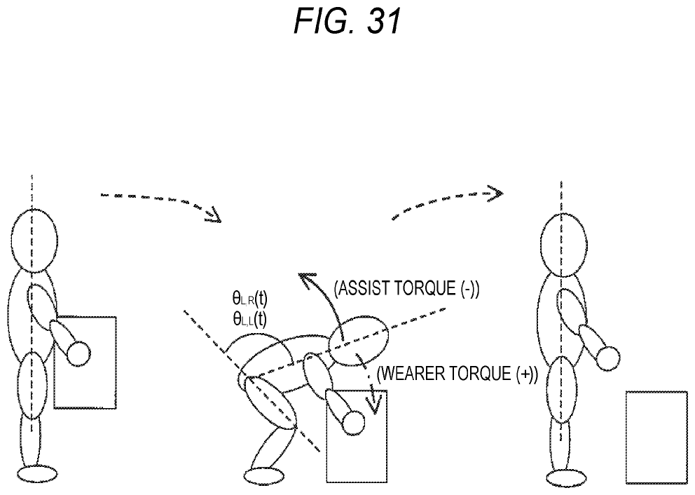

The control device 61 stores a (right) link angle θ_{L,R}(t) before update as a previous (right) link angle θ_{L,R}(t−1), and stores a (left) link angle θ_{L,L}(t) before update as a previous (left) link angle θ_{L,L}(t−1). Further, the control device 61 detects a current (right) link angle by using the output link rotation angle detection unit 43RS (corresponding to the angle detection unit; see FIGS. 10 and 11) of the (right) actuator unit, and stores (updates) the (right) link angle θ_{L,R}(t). Similarly, the control device 61 detects a current (left) link angle by using the output link rotation angle detection unit (corresponding to the angle detection unit) of the (left) actuator unit, and stores (updates) the (left) link angle θ_{L,L}(t). Further, the control device 61 obtains and stores a drag F (see FIGS. 24, 25, 27, and 28) based on detection signals from the load detection units 72L, 72R, 73L, 73R based on the information from the operation unit. Further, the control device 61 obtains and stores the body motion acceleration av in a spine-parallel direction along the back surface of the wearer (see FIGS. 27 and 28) and the body motion acceleration aw in a back-orthogonal direction orthogonal to the back surface of the wearer (see FIGS. 27 and 28) based on the detection signal from the acceleration detection unit 75. The above corresponds to the input processing block B20 illustrated in FIG. 17 and the input processing unit 61B illustrated in FIG. 15. The (right) link angle θ_{L,R}(t) is a (right) forward-leaning angle of the waist with respect to the thigh (see FIG. 31), and the (left) link angle θ_{L,L}(t) is a (left) forward-leaning angle of the waist with respect to the thigh (see FIG. 31).

The control device 61 obtains and stores a (right) link angle change amount Δθ_{L,R}(t) according to the following Equation (1), and obtains and stores a (left) link angle change amount Δθ_{L,L}(t) according to Equation (2). The (right) link angle change amount Δθ_{L,R}(t), and the (left) link angle change amount Δθ_{L,L}(t) correspond to angular-velocity-related amounts. The output link rotation angle detection unit 43RS corresponds to the torque detection unit.

(Right) link angle change amount Δθ_{L,R}(t)=(right) link angle θ_{L,R}(t)−(right) link angle θ_{L,R}(t−1) (Equation 1)

(Left) link angle change amount Δθ_{L,L}(t)=(left) link angle θ_{L,L}(t)−(left) link angle θ_{L,L}(t−1) (Equation 2)

The control device 61 obtains and stores a (right) wearer torque change amount τ_{S,R}(t) according to the following Equation (3), and obtains and stores a (left) wearer torque change amount τ_{S,L}(t) according to Equation 4. Ks is the spring constant of the spiral spring 45R.

(Right) wearer torque change amount τ_{S,R}(t)=Ks*Δθ_{L,R}(t) (Equation 3)

(Left) wearer torque change amount τ_{S,L}(t)=Ks*Δθ_{L,L}(t) (Equation 4)

The control device 61 obtains and stores a (right) synthetic torque (t) according to the following Equation (5), and obtains and stores the (left) synthetic torque (t) according to Equation 6.

(Right) synthetic torque (t)=Ks*θ_{L,R}(t) (Equation 5)

(Left) synthetic torque (t)=Ks*θ_{L,L}(t) (Equation 6)

The control device 61 detects the motor shaft angle of the (right) electric motor 47R based on the detection signal from the motor rotation angle detection unit 47RS of the (right) electric motor 47R, and stores (updates) the (right) actual motor shaft angle θ_{rM,R}(t). Similarly, the control device 61 detects a motor shaft angle of the (left) electric motor based on the detection signal from the motor rotation angle detection unit of the (left) electric motor (not illustrated), and stores (updates) a (left) actual motor shaft angle θ_{rM,L}(t).

As illustrated in FIG. 11, when the assist torque from the electric motor 47R is input to the spiral spring 45R of the right actuator unit, the (right) wearer torque is input from the thigh of the wearer via the speed reducer 42R, the pulley 43RA and the pulley 43RC to the spiral spring 45R, and the spiral spring 45R is rotated in a compression direction or an extension direction so as to store the torque. The rotation angle of the spiral spring 45R in the compression direction or the extension direction can be expressed by (a (right) pulley rotation angle θ_{P,R}(t), which is the rotation angle of the pulley 43RC−the (right) actual motor shaft angle θ_{rM,R}(t) of the electric motor 47R). The (right) spring torque τ_{SP,R}(t), which is the torque stored in the spiral spring 45R, can be expressed as (right) spring torque τ_{SP,R}(t)=Ks*(θ_{P,R}(t)−θ_{rM,R}(t)) using the spring constant Ks of the spiral spring 45R.

Here, when using the gear reduction ratio n_{G}, the pulley reduction ratio n_{P}, and the (right) link angle θ_{L,R}(t), the pulley rotation angle θ_{P,R}(t)=θ_{L,R}(t)*n_{P}*n_{G}. From the above, the (right) spring torque τ_{SP,R}(t) can be expressed by the following Equation (6-1). Further, since θ_{S,R}(t)=θ_{L,R}(t)*n_{G} when based on a sub-encoder rotation angle θ_{S,R}(t) which is a rotation angle of the output link rotation angle detection unit 43RS in FIG. 11, the (right) spring torque τ_{SP,R}(t) in this case can be expressed by the following Equation (6-2).

(Right) spring torque τ_{SP,R}(t)=Ks*(θ_{L,R}(t)*n_{G}*n_{P}−θ_{rM,R}(t)) (Equation 6-1)

(Right) spring torque τ_{SP,R}(t)=Ks*(θ_{S,R}(t)*n_{P}−θ_{rM,R}(t)) (Equation 6-2)

Similarly, a (left) spring torque τ_{SP,L}(t), which is a torque stored in the spiral spring of the left actuator unit, can be obtained according to the following (Equations 6-3) and (Equations 6-4) using the (left) link angle θ_{L,L}(t), the gear reduction ratio n_{G}, the pulley reduction ratio n_{P}, a sub-encoder rotation angle θ_{S,L}(t) of the output link rotation angle detection unit of the left actuator unit, and the (left) actual motor shaft angle θ_{rM,L}(t).

(Left) spring torque τ_{SP,L}(t)=Ks*(θ_{L,L}(t)*n_{G}*n_{P}−θ_{rM,L}(t)) (Equation 6-3)

(Left) spring torque τ_{SP,L}(t)=Ks*(θ_{S,L}(t)*n_{P}−θ_{rM,L}(t)) (Equation 6-4)

The above (right) spring torque τ_{SP,R}(t) corresponds to a right-torque-related amount, which is a torque related to the right wearer torque input from the right thigh of the wearer to the right actuator unit and the right assist torque generated by the right actuator unit. The right-torque-related amount detection unit that detects the right-torque-related amount detects the swing angle of the right thigh with respect to the waist of the wearer. As illustrated in FIGS. 10 and 11, the right-torque-related amount detection unit includes the motor rotation angle detection unit 47RS that detects the (right) actual motor shaft angle θ_{rM,R}(t), and the output link rotation angle detection unit 43RS (corresponding to the right thigh angle detection unit) that detects the (right) pulley rotation angle θ_{P,R}(t). the above (left) spring torque τ_{SP,L}(t) corresponds to a left-torque-related amount, which is a torque related to the left wearer torque input from the left thigh of the wearer to the left actuator unit and the left assist torque generated by the left actuator unit. The left-torque-related amount detection unit that detects the left-torque-related amount detects the swing angle of the left thigh with respect to the waist of the wearer. Although not illustrated, the left-torque-related amount detection unit includes the motor rotation angle detection unit that detects the (left) actual motor shaft angle θ_{rM,L}(t), and the output link rotation angle detection unit (corresponding to the left thigh angle detection unit) that detects the (left) pulley rotation angle θ_{P,L}(t).

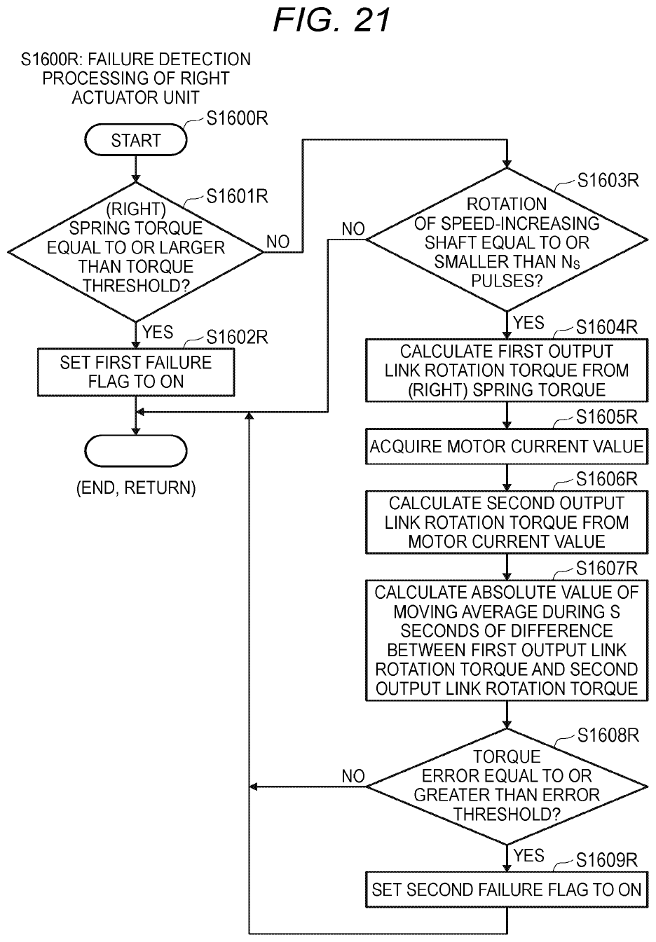

The control device 61 obtains and stores the (right) spring torque τ_{SP,R}(t) and the (left) spring torque τ_{SP,L}(t) according to the above calculation equations. The above corresponds to the torque change amount calculation block B30 illustrated in FIG. 17 and the torque change amount, etc. calculation unit 61C illustrated in FIG. 15.

[S150: Failure Detection Processing (FIGS. 20 to 21)]

Next, details of the processing in step S150 according to step S015 illustrated in FIG. 18 will be described with reference to FIGS. 20 and 21. In S150, the control device 61 detects a failure of the right actuator unit 4R and the left actuator unit 4L. The processing of S150 corresponds to the failure detection processing block B35 illustrated in FIG. 17, and corresponds to the failure detection processing unit 61K illustrated in FIG. 15.

After the processing of S150, the control device 61 proceeds to step S151. As illustrated in FIG. 20, in step S151, the control device 61 executes the processing of S1600R (see FIG. 21), and then proceeds to step S152. The processing of S1600R is a processing of detecting a failure of the (right) actuator unit 4R.

In step S152, the control device 61 executes the processing of S1600L (not shown), and then proceeds to step S153. The processing of S1600L is a processing of detecting a failure of the (left) actuator unit 4L. The processing of S1600L executed in step S152 shows the processing procedure executed for the (left) actuator unit 4L, which, however, is the same as the processing procedure of S1600R executed for the (right) actuator unit 4L, and detailed description thereof will be omitted.

In step S153, the control device 61 reads the first failure flag from a RAM, and determines whether the first failure flag is set to “ON”. As will be described later, the first failure flag is set to “ON” in a case where at least one of the (right) spring torque τ_{SP,R}(t) (see FIG. 19) stored in the spiral spring 45R of the right actuator unit 4R and the (left) spring torque τ_{SP,L}(t) (see FIG. 19) stored in the spiral spring 45L of the left actuator unit 4L reaches a maximum torque that can be generated without breaking the spiral springs 45R, 45L (see FIG. 21). The first failure flag is set to “OFF” and stored in the RAM when the control device 61 is activated or reset.

The control device 61 proceeds to step S154 if it is determined that the first failure flag is set to “ON” (S153: YES). In step S154, the control device 61 notifies that the power assist suit 1 has exceeded the output limit, and then proceeds to step S155. For example, the control device 61 outputs a notification command instructing the control device R1E (see FIG. 15) of the operation unit R1 (see FIG. 14) to blink the icon of “ABNORMAL 1” (see FIG. 14), so as to blink the icon of “ABNORMAL 1” to notify the wearer that the power assist suit 1 reaches the “output limit”. The power assist suit 1 may audibly notify the “output limit” via a speaker (not shown).

In step S155, the control device 61 stops supply of power to the electric motor 47R (see FIG. 15) of the right actuator unit 4R and the electric motor 47L of the left actuator unit 4L via the motor driver 62 (see FIG. 15), and then ends the processing of S150 and returns (proceeds to step S018 in FIG. 18). Therefore, since a state in which the first failure flag is set to “ON” is continued until a reset button (not shown) provided on the backpack portion 37 is pressed, the supply of power to the electric motors 47R, 47L is also stopped until the reset button (not shown) is pressed.

As a result, since the supply of power to the electric motors 47R, 47L is stopped, the torques applied to the spiral springs 45R, 45L disappear, the (right) spring torque τ_{SP,R} and the (left) spring torque τ_{SP,L} become “0”, and the spiral springs 45R, 45L can be prevented from breaking. Further, since the supply of power to the electric motors 47R, 47L is stopped, the assist torques return to “0” due to the spring forces of the spiral springs 45R, 45L (taking a time of about 0.5 seconds to 0.7 seconds), so that it is possible to prevent a sudden load from being applied to the waist of the wearer and to prevent the waist from being damaged. In this way, it is possible to provide a highly reliable power assist suit 1 without causing a sense of discomfort, such has feeling a sudden load, to the wearer.

On the other hand, the control device 61 proceeds to step S156 if it is determined in step S153 that the first failure flag is set to “OFF” (S153: NO). In step S156, the control device 61 reads the second failure flag from the RAM, and determines whether the second failure flag is set to “ON”.

Here, as will be described later, the output link rotation angle detection unit 43RS is determined as failing and the second failure flag is set to “ON” if an absolute value of a difference between a (right) first output link rotation torque τ_{O1R} (first rotation torque) of the output link 50R (see FIG. 4) calculated from the (right) spring torque τ_{SP,R}(t) (see FIG. 19) and a (right) second output link rotation torque τ_{O2R} (second rotation torque) of the output link 50R (see FIG. 4) calculated from a motor current value of the electric motor 47R is equal to or greater than an “ERROR THRESHOLD” (see FIG. 21).

Further, as will be described later, the output link rotation angle detection unit 43LS is determined as failing and the second failure flag is set to “ON” if an absolute value of a difference between a (left) first output link rotation torque Toil, (first rotation torque) of the output link 50L (see FIG. 4) calculated from the (left) spring torque τ_{SP,L}(t) (see FIG. 19) and a (left) second output link rotation torque τ_{O2L} (second rotation torque) of the output link 50L (see FIG. 4) calculated from a motor current value of the electric motor 47L is equal to or greater than the “ERROR THRESHOLD” (see FIG. 21).

The control device 61 proceeds to step S157 if it is determined that the second failure flag is set to “ON” (S156: YES). In step S157, the control device 61 notifies that either one of the output link rotation angle detection unit 43RS or the output link rotation angle detection unit 43LS fails, and then proceeds to step S155. The control device 61 ends the processing of S150 and returns (proceeds to step S018 in FIG. 18) if it is determined that the second failure flag is set to “OFF” (S156: NO).

For example, the control device 61 outputs a notification command instructing the control device R1E (see FIG. 15) of the operation unit R1 (see FIG. 14) to blink the icon of “ABNORMAL 2” (see FIG. 14), so as to blink the icon of “ABNORMAL 2” to notify the wearer that either one of the output link rotation angle detection unit 43RS or the output link rotation angle detection unit 43LS fails. It may be audibly notified via a speaker (not illustrated) that either one of the output link rotation angle detection unit 43RS or the output link rotation angle detection unit 43LS fails.

In step S155, the control device 61 stops supply of power to the electric motor 47R (see FIG. 15) of the right actuator unit 4R and the electric motor 47L of the left actuator unit 4L via the motor driver 62 (see FIG. 15), and then ends the processing of S150 and returns (proceeds to step S018 in FIG. 18). Therefore, since a state in which the second failure flag is set to “ON” is continued until a reset button (not shown) provided on the backpack portion 37 is pressed, the supply of power to the electric motors 47R, 47L is also stopped until the reset button (not shown) is pressed.

As a result, since the supply of power to the electric motors 47R, 47L is stopped, the torques applied to the spiral springs 45R, 45L disappear, and the (right) spring torque τ_{SP,R} and the (left) spring torque τ_{SP,L} become “0”. As a result, it is possible to stop output of inappropriate assist torques by the electric motors 47R, 47L. In this way, it is possible to provide a highly reliable power assist suit 1 that can output an appropriate assist torque with the electric motors 47R, 47L without causing a sense of discomfort to the wearer when assisting lifting motion and lowering motion of the object.

[S1600R: Failure Detection Processing of Right Actuator Unit]

Next, details of the processing of S1600R executed in step S151 illustrated in FIG. 20 will be described in detail with reference to FIG. 21. In S1600R, the control device 61 determines whether the (right) spring torque τ_{SP,R} (see FIG. 19) stored in the spiral spring 45R of the (right) actuator unit 4R reaches the maximum torque (torque threshold) that can be generated without breaking the spiral spring 45R. In step S1600R, the control device 61 determines whether the output link rotation angle detection unit 43RS fails.

The processing of S1600L executed in step S152 shows the processing procedure executed for the (left) actuator unit 4L, which, however, is the same as the processing procedure of S1600R executed for the (right) actuator unit 4L.

As illustrated in FIG. 21, in the processing of S1600R, the control device 61 proceeds to step S1601R. In step S1601R, the control device 61 reads from the RAM the (right) spring torque τ_{SP,R}(t) calculated and stored in step S110 (see FIG. 19). Then, the control device 61 determines whether the (right) spring torque τ_{SP,R}(t) is equal to or greater than a maximum torque (torque threshold) τ_{SP,MAX} that can be generated without breaking the spiral spring 45R. The torque threshold τ_{SP,MAX} is determined via experiments, computer aided engineering (CAE) analysis, and the like, and is stored in the storage portion 67 in advance.

The control device 61 may calculate the first output link rotation torque (first rotation torque) τ_{O1,R}(t) of the output link 50R corresponding to the (right) spring torque τ_{SP,R}(t) according to the following Equation 21, and may also determine whether the first output link rotation torque τ_{01,R}(t) is equal to or greater than a maximum torque τ_{O1,MAX} (e.g., 22 Nm) that can be generated without breaking the spiral spring 45R. Here, n_{G} (1<n_{G}) is a reduction ratio of the speed reducer 42R, and n_{P} is the pulley reduction ratio of the pulley 43RA to the pulley 43RC.

τ_{O1,R}(t)=τ_{SP,R}(t)*n_{P}*n_{G} (Equation 21)

The control device 61 proceeds to step S1602R if it is determined that the (right) spring torque τ_{SP,R}(t) is equal to or greater than the maximum torque (torque threshold) τ_{SP,max} that can be generated without breaking the spiral spring 45R (S1601: YES). In step S1602R, the control device 61 reads the first failure flag from the RAM, sets the first failure flag to “ON”, stores the first failure flag in the RAM again, and then ends the processing of S1600R and returns (proceeds to step S152 in FIG. 20). Thereby, the control device 61 can accurately determine whether the spiral spring 45R is to fail (e.g., deform, break, etc.) before the spiral spring 45R fails, and can improve the reliability of the power assist suit 1.

On the other hand, the control device 61 determines that the spiral spring 45R is not to fail (e.g., deform, break, etc.) and proceeds to step S1603R if it is determined that the (right) spring torque τ_{SP,R}(t) is smaller than the maximum torque (torque threshold) τ_{SP,MAX} that can be generated without breaking the spiral spring 45R (S1601: NO).

In step S1603R, the control device 61 determines whether a rotation amount of the speed-increasing shaft 42RB detected by the output link rotation angle detection unit 43RS is equal to or smaller than N_{S} pulses (e.g., 4 pulses) during T_{S} (msec) (e.g., during about 2 msec). The output link rotation angle detection unit 43RS outputs about 1000*N_{S} pulses (e.g., 4096 pulses) during one rotation of the speed-increasing shaft 42RB.

Then, the control device 61 determines that the output link 50R is rotating, and ends the processing of S1600R and returns (proceeds to step S152 in FIG. 20) if it is determined that the rotation amount of the speed-increasing shaft 42RB detected by the output link rotation angle detection unit 43RS is larger than N_{S} pulses (e.g., 4 pulses) during T_{S} (msec) (e.g., during about 2 msec) (S1603: NO).

On the other hand, the control device 61 determines that the output link 50R is almost not rotating, and proceeds to step S1604R if it is determined that the rotation amount of the speed-increasing shaft 42RB detected by the output link rotation angle detection unit 43RS is equal to or smaller than N_{S} pulses (e.g., 4 pulses) during T_{S} (msec) (e.g., during about 2 msec) (S1603: YES). In step S1604R, the control device 61 calculates the first output link rotation torque (first rotation torque) τ_{O1,R}(t) of the output link 50R corresponding to the (right) spring torque τ_{SP,R}(t) according to Equation 21, and stores the first output link rotation torque τ_{O1,R}(t) in the RAM.

Subsequently, in step S1605R, the control device 61 acquires a current value I_{R} supplied to the electric motor 47R via the motor driver 62, and then proceeds to step S1606R. In step S1606R, the control device 61 calculates a second output link rotation torque (second rotation torque) τ_{O2,R}(t) of the output link 50R from the current value I_{R} supplied to the electric motor 47R according to the following Equation 22, and stores the second output link rotation torque τ_{O2,R}(t) in the RAM. Here, K_{A} is a motor constant (Nm/A) of the electric motor 47R, n_{G} (1<n_{G}) is the reduction ratio of the speed reducer 42R, and n_{P} is the pulley reduction ratio of the pulley 43RA to the pulley 43RC.

τ_{O2,R}(t)=K_{A}*I_{R}*n_{P}*n_{G} (Equation 22)

Thereafter, in step S1607R, the control device 61 calculates, according to the following Equation 23, an absolute value of a moving average during S seconds (e.g., during about 0.5 seconds) of a value obtained by subtracting the second output link rotation torque (second rotation torque) τ_{O2,R}(t) calculated according to Equation 22 from the first output link rotation torque (first rotation torque) τ_{O1,R}(t) calculated according to Equation 21 during T_{S} (msec) (e.g., during about 2 sec), stores the value as a (right) torque error Δτ_{R}(t) in the RAM, and then proceeds to step S1608R. Note that τ_{O1,R}(t−1) is a previously calculated first output link rotation torque (first rotation torque), and τ_{O2,R}(t−1) is a previously calculated second output link rotation torque (second rotation torque).

Δτ_{R}(t)=|((τ_{O1,R}(t−1)−τ_{O2,R}(t−1))*((S/T_{S})−1)+(τ_{O1,R}(t)−τ_{O2,R}(t)))÷(S/T_{S})| (Equation 23)

In step S1607R, for example, the control device 61 may be configured as follows. The control device 61 calculates a value obtained by subtracting the second output link rotation torque (second rotation torque) τ_{O2,R}(t) from the first output link rotation torque (first rotation torque) τ_{O1,R}(t) per T_{S} (msec) (e.g., per 2 msec) during S seconds (e.g., during 0.5 seconds), and sums the values. Then, the control device 61 may calculate an absolute value of an average value of the total value and store the absolute value in the RAM as the (right) torque error Δτ_{R}(t), and then proceed to step S1608R.

In step S1608R, the control device 61 reads from the RAM the (right) torque error Δτ_{R}(t) calculated and stored in step S1607R. Then, the control device 61 determines whether the (right) torque error Δτ_{R}(t) is equal to or greater than an error threshold τ_{LM} (e.g., about 3.8 Nm). The error threshold τ_{LM} is determined via experiments, computer aided engineering (CAE) analysis, and the like, and is stored in the storage portion 67 in advance.

The control device 61 determines that the output link rotation angle detection unit 43RS does not fail and ends the processing of S1600R and returns (proceeds to step S152 in FIG. 20) if it is determined that the (right) torque error Δτ_{R}(t) is smaller than the error threshold τ_{LM} (e.g., about 3.8 Nm) (S1608R: NO).

On the other hand, the control device 61 proceeds to step S1609R if it is determined that the (right) torque error Δτ_{R}(t) is equal to or greater than the error threshold τ_{LM} (e.g., about 3.8 Nm) (S1608R: YES). In step S1609R, the control device 61 reads the second failure flag from the RAM, sets the second failure flag to “ON”, stores the second failure flag in the RANI again, and then ends the processing of S1600R and returns (proceeds to step S152 in FIG. 20). Thereby, the control device 61 can accurately determine whether the output link rotation angle detection unit 43RS fails, and can improve the reliability of the power assist suit 1.

[Details of S200: Motion Mode Determination (FIG. 22)]

Next, details of the processing in step S200 according to step S020 illustrated in FIG. 18 will be described with reference to FIG. 22. In the processing of S200, the control device 61 switches or maintains the motion mode of the power assist suit to one of the “lifting mode”, the “lowering mode”, and the “walking mode” based on the (right) spring torque τ_{SP,R}(t) (right-torque-related amount) and the (left) spring torque τ_{SP,L}(t) (left-torque-related amount) obtained in the processing of S100. The lifting mode is a motion mode for assisting the object lifting operation by the wearer. The lowering mode is a motion mode for assisting the object lowering operation by the wearer. The walking mode is a motion mode for assisting the walking motion of the wearer. As described above, the motion mode includes the three modes including the lifting mode, the lowering mode, and the walking mode, but may also include another mode. The processing of S200 corresponds to the motion mode determination block B40 illustrated in FIG. 17, and corresponds to the motion mode determination unit 61D illustrated in FIG. 15.

After the processing of S200, the control device 61 proceeds to step S210. Then, in step S210, the control device 61 determines whether a condition is satisfied that the (right) spring torque τ_{SP,R}(t) is a torque toward the forward-leaning direction of the wearer and is greater than the first predetermined threshold, and that the (left) spring torque τ_{SP,L}(t) is a torque toward the forward-leaning direction of the wearer and is greater than the first predetermined threshold. For example, a value of the first predetermined threshold is 0 (zero). The control device 61 proceeds to step S240A if the condition is satisfied (Yes), and proceeds to step S220 if the condition is not satisfied (No). The (right) spring torque τ_{SP,R}(t) and the (left) spring torque τ_{SP,L}(t) are positive (>0) if being torques in the forward-leaning direction of the wearer, and are negative (<0) if being torques in a rearward-leaning direction of the wearer.

The control device 61 may use a value set in the storage unit in advance as the first predetermined threshold, or may adjust the value of the first predetermined threshold using a learning model generated by machine learning (neural network or the like). When machine learning is used for adjustment, the learning model may be provided in the storage unit for learning in the control device 61 so as to perform learning operation and to adjust the first predetermined threshold, or a learning model of another power assist suit may be stored in the storage unit using the communication unit 64 or the like to perform the learning operation and to adjust the first predetermined threshold.

When the processing proceeds to step S220, the control device 61 determines whether a condition is satisfied that the (right) spring torque τ_{SP,R}(t) is a torque toward the rearward-leaning direction (opposite to the forward-leaning direction) of the wearer and is smaller than the second predetermined threshold, and that the (left) spring torque τ_{SP,L}(t) is a torque toward the rearward-leaning direction (opposite to the forward-leaning direction) of the wearer and is smaller than the second predetermined threshold. For example, a value of the second predetermined threshold is 0 (zero). The control device 61 proceeds to step S240B if the condition is satisfied (Yes), and proceeds to step S230 if the condition is not satisfied (No).

The control device 61 may use a value set in the storage unit in advance as the second predetermined threshold, or may adjust the value of the second predetermined threshold using a learning model generated by machine learning (neural network or the like). When machine learning is used for adjustment, the learning model may be provided in the storage unit for learning in the control device 61 so as to perform learning operation and to adjust the second predetermined threshold, or a learning model of another power assist suit may be stored in the storage unit using the communication unit 64 or the like to perform the learning operation and to adjust the second predetermined threshold.

When the processing proceeds to step S230, the control device 61 determines whether [the (right) link angle θ_{L,R}(t)+the (left) link angle θ_{L,L}(t)]/2 is equal to or smaller than a first motion determination angle θ1, and the (right) synthetic torque (t)*the (left) synthetic torque (t) is smaller than a first motion determination torque τ1. The control device 61 proceeds to step S240C if [the (right) link angle θL,R(t)+the (left) link angle θL,L(t)]/2 is equal to or smaller than the first motion determination angle θ1, and the (right) synthetic torque (t)*the (left) synthetic torque (t) is smaller than the first motion determination torque τ1 (Yes), and ends the processing of S200 and returns (proceeds to step S025 of FIG. 18) if not (No). In this case, the current motion mode is maintained as the motion mode. Then, the assist operation can be continued while maintaining the motion mode.

When the processing proceeds to step S240A, the control device 61 stores the “lowering mode” as the motion mode, ends the processing of S200, and returns (proceeds to step S025 in FIG. 18).

When the processing proceeds to step S240B, the control device 61 stores the “lifting mode” as the motion mode, ends the processing of S200, and returns (proceeds to step S025 in FIG. 18).

When the processing proceeds to step S240C, the control device 61 stores the “walking mode” as the motion mode, ends the processing of S200, and returns (proceeds to step S025 in FIG. 18).

[Details of S300: Load Determination (Determination of Gain Cₚ) (FIGS. 23 to 29)]

Next, details of the processing in step S300 according to step S025 illustrated in FIG. 18 will be described with reference to FIG. 23. In 5300, the control device 61 determines the value of the gain Cₚ, which is the magnitude of the assist torque. For example, when the gain automatic/manual switching operation unit R1BS illustrated in FIG. 14 is set to the “MANUAL” side, the gain Cₚ is set to any one of 0, 1, 2, 3 via operation of the gain up operation unit R1BU and the gain down operation unit R1BD by the wearer. When the gain automatic/manual switching operation unit R1BS illustrated in FIG. 14 is set to the “AUTOMATIC” side, the control device 61 automatically detects the mass (or weight) of the object held by the wearer, and determines the value of the gain Cₚ, which is the magnitude of the assist torque, according to the detected mass (or weight) of the object. For example, the control device 61 associates 0, 1, 2, 3 of the manual gain Cₚ with the object mass=0 [kg], 10 [kg], 15 [g], 20 [kg], respectively. For example, when the mass of the load is 18 kg, the manual gain Cₚ is determined to be 2, which is one value of the gain Cₚ in the manual case, but in order to further eliminate a sense of discomfort, the assist torque (the gain Cₚ) may be set to 2.6 (proportional or the like) in accordance with the object mass. The processing of S300 corresponds to the load determination block B45 illustrated in FIG. 17, and corresponds to the load determination unit 61J illustrated in FIG. 15.

After the processing of S300 (see FIG. 23), the control device 61 proceeds to step S315. The drag F and the body motion accelerations av and aw are already obtained in the processing of S100 described above, and the drag F and the body motion accelerations av and aw will be described first.

As illustrated in FIG. 24, in a state in which the wearer TS does not hold the object BG (object mass: m), the drag F=M*g, where the wearer mass is M and a gravitational acceleration is g. The drag F is a force that the wearer TS receives from a floor surface. As illustrated in FIG. 25, in a state in which the wearer TS lifts the object BG (object mass: m), the drag F=M*g+m*g, where the wearer mass is M and a gravitational acceleration is g. At the time of step S100, the control device 61 temporarily stores the current drag F regardless of whether the wearer TS holds the object BG.

As illustrated in FIGS. 27 and 28, the acceleration detection unit 75 outputs a detection signal of the body motion acceleration av in the spine-parallel direction along the back surface of the wearer TS and a detection signal of the body motion acceleration aw in the back-orthogonal direction orthogonal to the back surface of the wearer TS. At the time of step S100, the control device 61 detects and stores the current body motion acceleration av in the spine-parallel direction based on the detection signal of the body motion acceleration av, and detects and stores the current body motion acceleration aw in the back-orthogonal direction based on the detection signal of the body motion acceleration aw.

In step S315, the control device 61 determines whether the gain automatic/manual switching operation unit R1BS (see FIG. 14) is set to the “AUTOMATIC” side, proceeds to step S320 if set to the “AUTOMATIC” side (Yes), and proceeds to step S360C if set to the “MANUAL” side (No).

When the processing proceeds to step S320, the control device 61 determines whether an elapsed time after power-on is smaller than a predetermined time (e.g., smaller than 0.2 to 2 [sec]), proceeds to step S330 if smaller than the predetermined time (Yes), and proceeds to step S325 if equal to or larger than the predetermined time (No).

When the processing proceeds to step S330, the control device 61 determines whether |the current body motion acceleration av| is equal to or smaller than a predetermined threshold and |the current body motion acceleration aw| is equal to or smaller than a predetermined threshold (that is, the wearer TS is in a substantially stationary state), proceeds to step S340B if equal to or smaller than the predetermined threshold (Yes), and proceeds to step S350 if larger than the predetermined threshold (No).

When the processing proceeds to step S340B, the control device 61 integrates the current drag F, counts a number of times of integration, and proceeds to step S350.

When the processing proceeds to step S325, the control device 61 determines whether the elapsed time after power-on is the predetermined time (the same value as the “predetermined time” in step S320), proceeds to step S340A if being the predetermined time (Yes), and proceeds to step S350 if not the predetermined time (No).

When the processing proceeds to step S340A, the control device 61 averages the integrated value obtained in step S340B (the integrated value of the drag F) using the number of times of integration, so as to obtain an average wearer drag Fav of only the wearer TS. Then, the control device 61 divides the average wearer drag Fav by the gravitational acceleration g to obtain and store the wearer mass M (M=Fav/g), and proceeds to step S350. The wearer mass M is preferably stored in a nonvolatile memory.

The control device 61 may calculate the wearer mass M by using the drag F detected when the body weight measurement operation unit R1K (see FIG. 14) is ON from the drag F/g at that time (M=F/g). In this case, the wearer TS turns on the body weight measurement operation unit R1K without holding the object BG.

When the processing proceeds to step S350, the control device 61 determines whether the current drag F is greater than the wearer mass M*g+a predetermined load (e.g., 2 to 3 [kg]*g, where g is the gravity acceleration), proceeds to step S355 if larger (Yes), and proceeds to step S360B if not larger (No).

When the processing proceeds to step S355, the object mass m is calculated by, for example, the following [Calculation Method 1 of Cargo Mass m] or [Calculation Method 2 of Cargo Mass m], and the processing proceeds to step S360A.

[Calculation Method 1 of Cargo Mass m]

As illustrated in FIG. 25, the control device 61 assumes that the current drag F is a drag caused by the wearer mass M and the object mass m, and calculates the object mass m by the current drag F (M*g+m*g)/g−(the wearer mass M). In the case of using this [Calculation Method 1 of Cargo Mass m], it is possible to omit the acceleration detection unit 75.

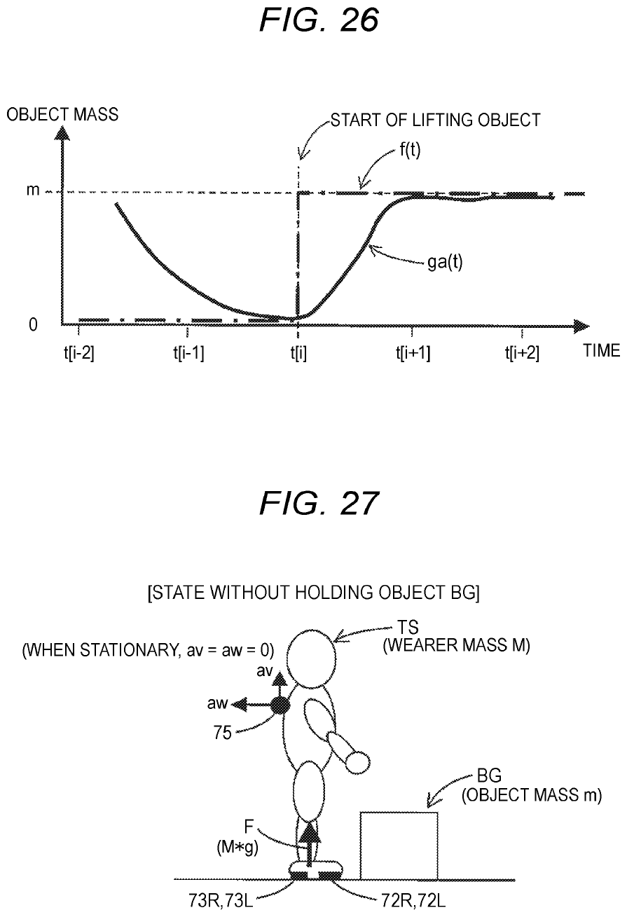

FIG. 26 shows an example of the object mass m actually calculated by Calculation Method 1, where a horizontal axis is set to the time, a vertical axis is set to the mass of the object held by the wearer, and the wearer TS starts to hold the object BG at time t[i]. In FIG. 26, f(t) indicated by a dash-dot line is an ideal object mass. Before the time t[i], since the wearer TS does not hold the object BG, the object mass is 0 (zero), and after the time t[i], since the object BG is lifted by the wearer TS, the object mass is m. However, the object mass calculated in Calculation Method 1 is represented by ga(t) shown by a solid line in FIG. 26. Before the time t[i], due to an acceleration when the wearer TS lowers the waist toward the object BG or the like, a gradually reducing object mass is detected erroneously, and after the time t[i], due to response delay of the load detection unit or the like, a gradually increasing object mass is detected. After the time t[i], since the mass converges to the correct object mass m after the time t[i+1], there is no big problem. In addition, a response delay time is short and a sense of discomfort is hardly felt. However, to determine that the object is held even if the object is not held before the time t[i] is not a big problem (the motion with respect to the object is understood by estimating a bending angle of the waist by the output link rotation angle detection unit 43RS and/or the motor rotation angle detection unit 47RS), but is not preferable either. In Calculation Method 2, the object is prevented from being determined to be held before the time t[i].

[Calculation Method 2 of Cargo Mass m]

As illustrated in FIG. 28, the control device 61 obtains the object mass m by assuming that the current drag F is a drag caused by the wearer mass M, the object mass m, and the body motion acceleration az of the vertical component of the wearer TS. The control device 61 obtains the body motion acceleration az of the vertical component based on the body motion accelerations av, aw, and the like. For example, the control device 61 obtains the body motion acceleration az from az=√(av²+aw²). In this case, the drag F=(M+m)*(g+az). That is, since F=M*g+M*az+m*g+m*az, since m is smaller than M and az is smaller than g (the gravity acceleration), assuming that m*az=0, then F=M*g+M*az+m*g. From this equation, m=[F−M*(g+az)]/g, and the control device 61 obtains the object mass m from this equation.

FIG. 29 shows an example of the object mass m actually calculated by Calculation Method 2, where a horizontal axis is set to the time, a vertical axis is set to the mass of the object held by the wearer, and the wearer TS starts to hold the object BG at time t[i]. In FIG. 29, f(t) indicated by a dash-dot line is the ideal object mass. Before the time t[i], since the wearer TS does not hold the object BG, the object mass is 0 (zero), and after the time t[i], since the object BG is lifted by the wearer TS, the object mass is m. However, the object mass calculated in Calculation Method 2 is represented by gb(t) shown by a solid line in FIG. 29. Before the time t[i], as compared to FIG. 26, erroneous detection due to an acceleration when the wearer TS lowers the waist toward the object BG or the like is prevented. After the time t[i], similarly to FIG. 26, due to response delay of the load detection unit or the like, a gradually increasing object mass is detected After the time t[i], since the mass converges to the correct object mass m after the time t[i+1], there is no big problem. Further, since the object is prevented from being determined to be held before the time t[i], there is no problem.

When the processing proceeds to step S360A, the control device 61 converts the obtained object mass m to the value of the gain Cₚ, ends the processing of S300, and returns (proceeds to step S030 in FIG. 18). As an example of conversion, for example, in a case where the gain numbers 0, 1, 2, 3 illustrated in FIG. 16 respectively correspond to the object mass=0 [kg], 10 [kg], 15 [kg], 20 [kg], for example, when the object mass m is 18 [kg], the control device 61 converts the object mass 18 [kg] into the gain Cₚ=2.6.

When the processing proceeds to step S360B, the control device 61 determines that the wearer TS does not hold the object BG (object mass m=0), and thus regards that the gain Cₚ=0, ends the processing of S300, and returns (proceeds to step S030 in FIG. 18).

When the processing proceeds to step S360C, the control device 61 uses the gain number of the “OPERATION UNIT GAIN” illustrated in FIG. 16 (acquired via the processing in S100) to substitute the corresponding gain number (any one of 0, 1, 2, 3) into the gain Cₚ, ends the processing of S300, and returns (proceeds to step S030 of FIG. 18).

[Details of SD000R: (Right) Lowering (FIGS. 30 to 34)]

Next, details of the processing in step SD000R according to step S040R illustrated in FIG. 18 will be described with reference to FIG. 30. In SD000R, the control device 61 calculates the (right) lowering assist torque generated by the power assist suit in order to assist the lowering operation of the wearer. The processing procedure of SD000R shows the processing procedure for calculating the (right) lowering assist torque generated by the (right) actuator unit 4R (see FIG. 1), while the processing procedure of SD000L (see FIG. 18) for calculating the (left) lowering assist torque generated by the (left) actuator unit 4L (see FIG. 1) is similar, and thus the description thereof will be omitted. As illustrated in FIG. 31, in the lowering operation of lowering the object held by the wearer, the (right) link angle θ_{L,R}(t) and the (left) link angle θ_{L,L}(t) are forward-leaning angles of the waist with respect to the thighs. The lowering assist torques for assisting the operation in a lowering direction of the wearer (a direction of the “WEARER TORQUE” in FIG. 31) are generated in a lifting direction (the direction of “ASSIST TORQUE” in FIG. 31) with respect to the wearer. In the following description, a sign of the torque in the lifting direction will be described as − (negative), and the sign of the torque in the lowering direction will be described as + (positive).

After the processing of SD000R, the control device 61 proceeds to step SD010R. Then, in step SD010R, the control device 61 determines whether the (right) link angle θ_{L,R}(t) is equal to or smaller than a first lowering angle θd1, proceeds to step SD015R if equal to or smaller than the first lowering angle θd1 (Yes), and proceeds to step SD020R if not (No). For example, when the first lowering angle θd1 is a forward-leaning angle of about 10 [°], and when θ_{L,R}(t)≤θd1, the control device 61 determines that lowering stars lifting ends.

When the processing proceeds to step SD015R, the control device 61 initializes (resets to zero) a (right) integrated assist amount, and proceeds to step SD020R.

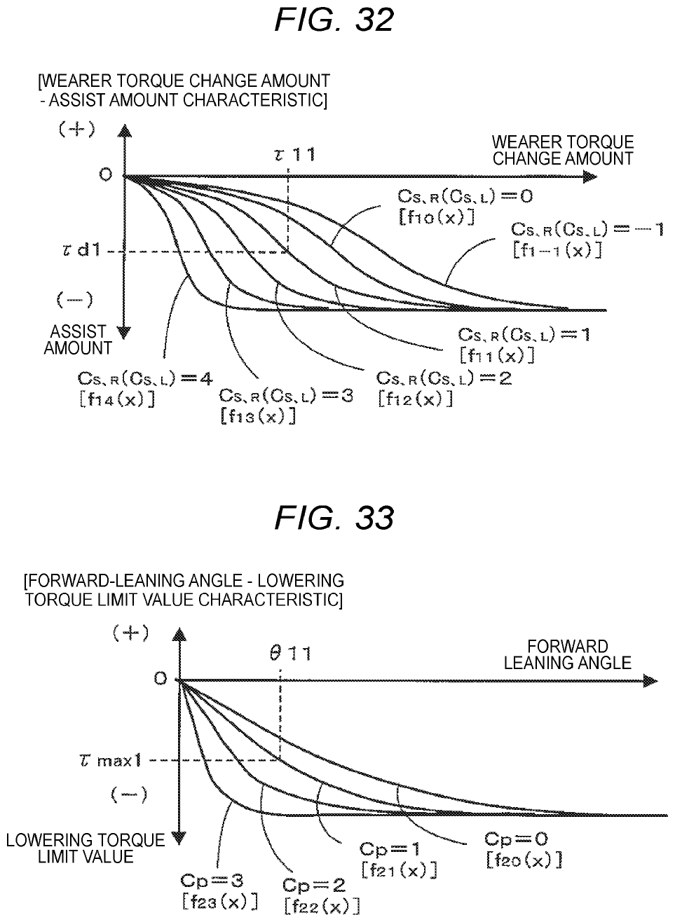

When the processing proceeds to step SD020R, the control device 61 calculates a (right) assist amount based on the (right) increase rate C_{s,R}, the (right) wearer torque change amount τ_{s,R}(t), and a wearer torque change amount−assist amount characteristic (FIG. 32), and proceeds to step SD025R. As illustrated in FIG. 32, for example, in a case of the (right) increase rate C_{s,R}=1, and the (right) wearer torque change amount τ_{S,R}(t)=τ11, using the characteristic of f11(x) of Cs=1, τd1 corresponding to τ11 is the obtained (right) assist amount.

In step SD025R, the control device 61 adds the (right) assist amount obtained in step SD020R to the (right) integrated assist amount (that is, integrates the obtained (right) assist amount), and proceeds to step SD030R.

In step SD030R, the control device 61 calculates a (right) lowering torque limit value based on the gain Cₚ, the (right) link angle (forward-leaning angle) θ_{L,R}(t), and a forward-leaning angle−lowering torque limit value characteristic (see FIG. 33), and proceeds to step SD035R. As illustrated in FIG. 33, for example, when the gain Cₚ=1 and the (right) link angle (forward-leaning angle) θ_{L,R}(t)=θ11, using the characteristic of f21(x) of Cₚ=1, τmax 1 corresponding to θ11 is the obtained (right) lowering torque limit value. For example, when the gain Cₚ is 2.6, a value of the characteristic of the gain Cₚ=2 and a value of the characteristic of the gain Cₚ=3 are obtained, and a value corresponding to Cₚ=2.6 may be obtained by interpolating from these two values. The forward-leaning angle−lowering torque limit value characteristic in FIG. 33 is one of a plurality of maps whose assist torque-related amount is set in advance.

In step SD035R, the control device 61 determines whether |the (right) integrated assist amount| is equal to or smaller than |the (right) lowering torque limit value|, proceeds to step SD040R when |the (right) integrated assist amount| is equal to or smaller than |the (right) lowering torque limit value| (Yes), and proceeds to step SD045R if not (No).

When the processing proceeds to step SD040R, the control device 61 stores the (right) integrated assist amount as the (right) lowering assist torque (that is, the (right) assist torque command value τ_{s,cmd,R}(t)), and ends the processing (proceeds to step S060R in FIG. 18).

When the processing proceeds to step SD045R, the control device 61 stores the (right) lowering torque limit value as the (right) lowering assist torque (that is, the (right) assist torque command value τ_{s,cmd,R}(t)), and ends the processing (proceeds to step S060R in FIG. 18).

In the above steps SD035R, SD040R, SD045R, the control device 61 sets a smaller one among |the (right) integrated assist amount| and |the (right) lowering torque limit value| as the (right) lowering assist torque.

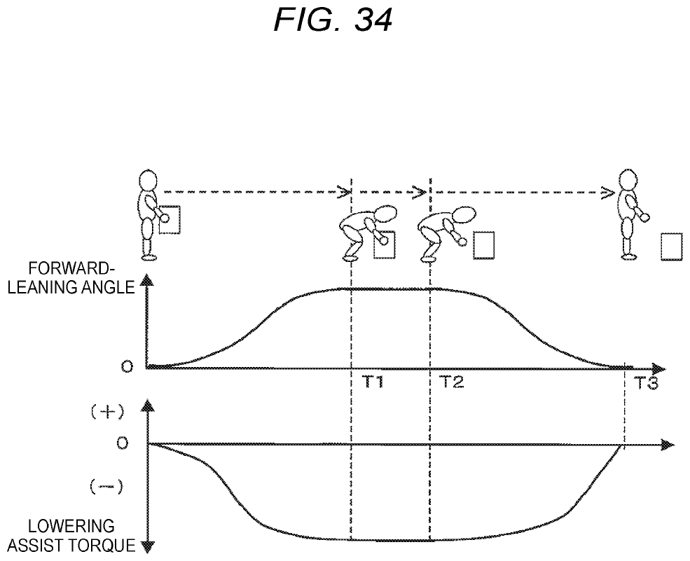

In the above processing, FIG. 34 shows a state of the lowering assist torque corresponding to the forward-leaning angle during the lowering operation. The example illustrated in FIG. 34 shows a case in which the wearer holds the load in an upright state at the time=0, gradually increasing the forward-leaning angle, completes lowering of the object at a time T1, maintains a forward-leaning state until a time T2, then gradually decreases the forward-leaning angle, and returns to the upright state. In this case, the lowering assist torque toward the lifting direction (a − (negative) side in FIG. 34) is illustrated in FIG. 34, and can reduce the load on the waist of the wearer and appropriately assist the lowering operation.

When the wearer stops the forward-leaning operation and change of the forward-leaning angle stops (Δθ_{L,R}(t)=0, Δθ_{L,L}(t)=0) (in the example of FIG. 34, between the time T1 and the time T2), or during an upright motion in which the wearer gradually reduces the forward-leaning angle from the forward-leaning state (in the example of FIG. 34, between the time T2 and the time T3), since the wearer torque change amount is zero or in the opposite direction, the assist amount obtained from the torque change amount−assist amount characteristic (see FIG. 32) is zero. That is, in this case, the control device 61 stops update of the integrated assist amount, and obtains the (right) lowering assist torque (the (right) assist torque command value) based on the maintained integrated assist amount and lowering torque limit value.

[Details of SU000: Lifting (FIGS. 35 to 43)]

Next, details of the processing in step SU000 according to step S045 illustrated in FIG. 18 will be described with reference to FIGS. 35A and 35B. In SU000, the control device 61 calculates the lifting assist torques generated by the power assist suit in order to assist the lifting operation of the wearer. In the lifting operation in which the wearer lifts the object, the (right) link angle θ_{L,R}(t) and the (left) link angle θ_{L,L}(t) (see FIG. 31) are forward-leaning angles of the waist with respect to the thighs. The lifting assist torques for assisting the operation in the lifting direction of the wearer are generated in the lifting direction (the direction of “ASSIST TORQUE” in FIG. 31) with respect to the wearer. In the following description, the sign of the torque in the lifting direction will be described as − (negative), and the sign of the torque in the lowering direction will be described as + (positive).

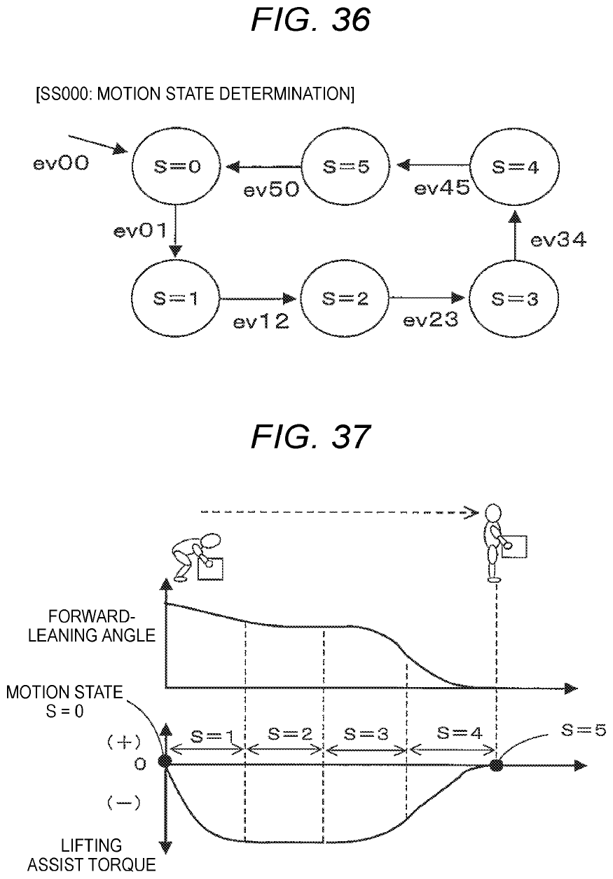

After the processing of SU000, the control device 61 proceeds to step SU010. Then, in step SU010, the control device 61 executes the processing of SS000 (see FIG. 36), and the processing proceeds to step SU015. As shown in the state transition diagram of FIG. 36, the processing of SS000 is a processing of determining a current motion state S when the entire lifting motion from lifting start to lifting end is divided into the motion states S=0 to 5, and details thereof will be described later.

In step SU015, the control device 61 determines whether the timing is a timing for the motion state S to transition from 0 to 1, proceeds to step SU020 if being the timing for the motion state S to transition from 0 to 1 (Yes), and proceeds to step SU030 if not (No).

When the processing proceeds to step SU020, the control device 61 substitutes 0 (zero) into a (right) virtual elapsed time t_{map,R}(t) and a (left) virtual elapsed time t_{map,L}(t), and substitutes 0 (zero) into a (right) lifting assist torque (the (right) assist torque command value τ_{s,cmd,R}(t)) and a (left) lifting assist torque (the (left) assist torque command value τ_{s,cmd,L}(t)). Thereafter, the control device 61 proceeds to step SU030.

[Determination of Motion State S=1 and Processing When Motion State S=1 (FIGS. 35A and 35B)]

When the processing proceeds to step SU030, the control device 61 determines whether the motion state S determined in step SU020 is 1, proceeds to step SU031 when the motion state S is 1 (Yes), and proceeds to step SU040 if not (No).

When the processing proceeds to step SU031, the control device 61 adds a task period (for example, 2 [ms], when the processing illustrated in FIG. 18 is activated per 2 [ms]) to the (right) virtual elapsed time t_{map,R}(t), adds the task period to the (left) virtual elapsed time t_{map,L}(t), and proceeds to step SU032. The (right) virtual elapsed time t_{map,R}(t) and the (left) virtual elapsed time t_{map,L}(t) indicate (virtual) elapsed times after the motion state becomes S=1.

In step SU032, the control device 61 determines whether the increase rate is “AUTOMATIC INCREASE RATE”, proceeds to step SU033R when being “AUTOMATIC INCREASE RATE” (Yes), and proceeds to step SU034 if not (No).

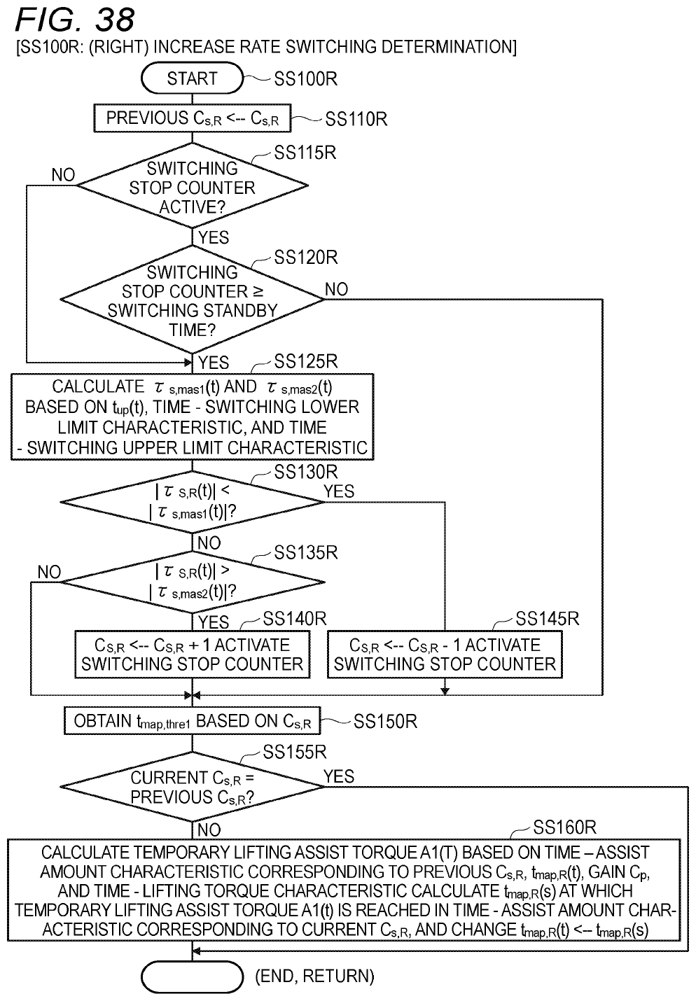

When the processing proceeds to step SU033R, the control device 61 executes the processing of SS100R (see FIG. 38), and proceeds to step SU033L. The processing of SS100R (see FIG. 38) is a processing of changing or maintaining the (right) increase rate C_{s,R} and the (right) virtual elapsed time t_{map,R}(t), and the processing of the SS100L, which is a processing of changing or maintaining the (left) increase rate C_{s,L} and the (left) virtual elapsed time t_{map,L}(t), is similar, and thus a description thereof will be omitted. In step SU033L, the control device 61 executes the processing of SS100L, and the processing proceeds to step SU034. Details of the processing in step SS100R will be described later.

In step SU034, the control device 61 determines whether the (right) increase rate C_{s,R} and the (left) increase rate C_{s,L} are equal, proceeds to step SU037R when the (right) increase rate C_{s,R} and (left) increase rate C_{s,L} are equal (Yes), and proceeds to step SU035 if not (No).

When the processing proceeds to step SU035, the control device 61 determines whether the (right) increase rate C_{s,R} is larger than the (left) increase rate C_{s,L}, proceeds to step SU036A when the (right) increase rate C_{s,R} is larger than the (left) increase rate C_{s,L} (Yes), and proceeds to step SU036B if not (No).

When the processing proceeds to step SU036A, the control device 61 substrates the (right) increase rate C_{s,R} into the (left) increase rate C_{s,L}, and proceeds to step SU037R.

When the processing proceeds to step SU036B, the control device 61 substrates the (left) increase rate C_{s,L} into the (right) increase rate C_{s,R}, and proceeds to step SU037R

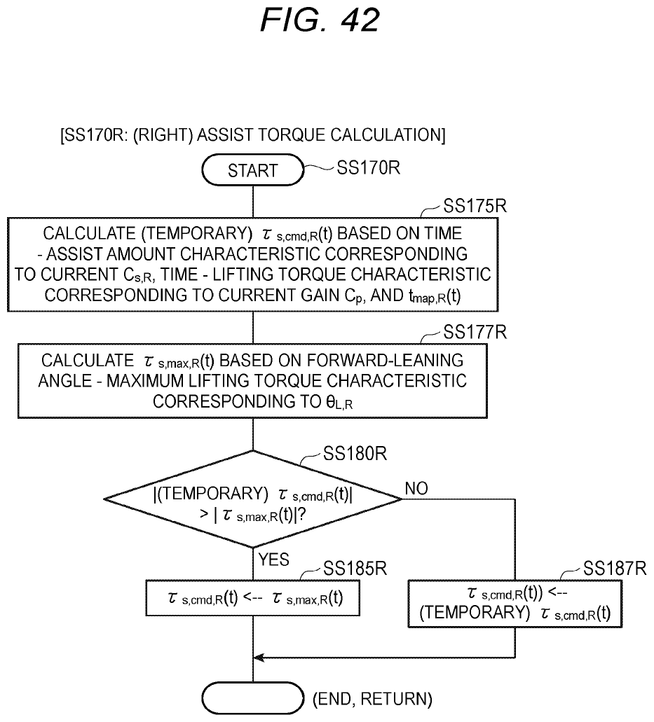

When the processing proceeds to step SU037R, the control device 61 executes the processing of SS170R (see FIG. 42), and proceeds to step SU037L. The processing of SS170R (see FIG. 42) is a processing of obtaining the (right) lifting assist torque (the (right) assist torque command value τ_{s,cmd,R}(t)) when the motion state S=1, and the processing of the SS170L, which is a processing of obtaining the (left) lifting assist torque (the (left) assist torque command value τ_{s,cmd,L}(t)) when the motion state S=1, is similar, and thus the description thereof will be omitted. In step SU037L, the control device 61 executes the processing of the SS170L, ends the processing, and returns (proceeds to step S060R in FIG. 18). Details of the processing in step SS170R will be described later.

[Determination of Motion State S=2 and Processing When Motion State S=2 (FIGS. 35A and 35B)]

When the processing proceeds to step SU040, the control device 61 determines whether the motion state S determined in step SU020 is 2, proceeds to step SU041 when the motion state S is 2 (Yes), and proceeds to step SU050 if not (No).

When the processing proceeds to step SU041, the control device 61 determines whether the (previous) motion state S is 1, proceeds to step SU042 when the (previous) motion state S is 1 (Yes), and proceeds to step SU047 if not (No).

When the processing proceeds to step SU042, the control device 61 substitutes 0 (zero) into the (right) virtual elapsed time t_{map,R}(t) and the (left) virtual elapsed time t_{map,L}(t), and proceeds to step SU047. The processing of step SU042 is executed when the motion state S transitions from 1→2.

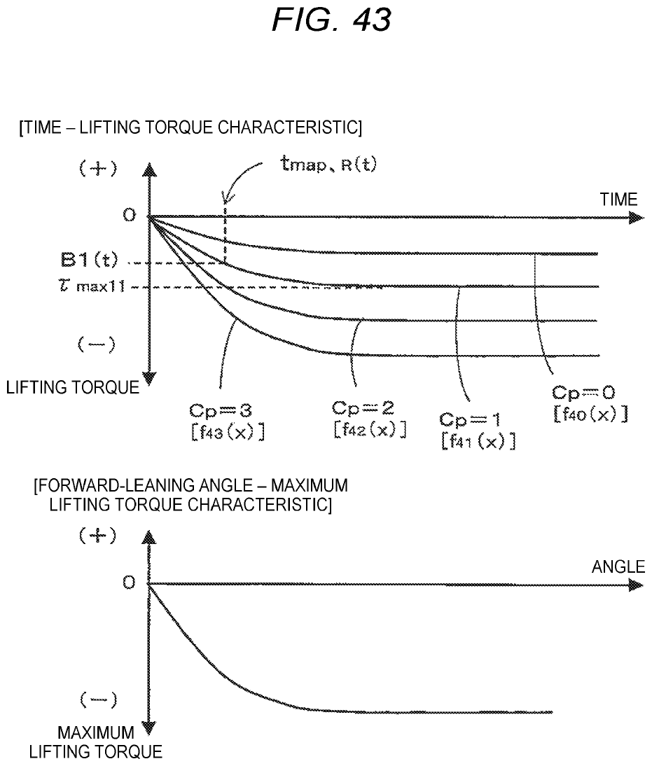

When the processing proceeds to step SU047, the control device 61 obtains a |maximum value| corresponding to the gain Cₚ based on the gain Cₚ and a time−lifting torque characteristic (see FIG. 43), and substitutes the obtained maximum value into the (right) lifting assist torque (the (right) assist torque command value τ_{s,cmd,R}(t)) and the (left) lifting assist torque (the (left) assist torque command value τ_{s,cmd,L}(t)), ends the processing, and returns (proceeds to step S060R in FIG. 18). For example, when the gain Cₚ=1, using the characteristic of f41(x) of Cₚ=1 in FIG. 43, τmax11, which is a maximum value of the |f41(x)|, is the obtained maximum value. As illustrated in FIG. 43, the time-lifting torque characteristic (one of lifting reference characteristics) is prepared in accordance with the gain Cₚ, and the control device 61 changes the lifting reference characteristic in accordance with the gain Cₚ. For example, when the gain Cₚ is 2.6, the value of the characteristic of the gain Cₚ=2 and the value of the characteristic of the gain Cₚ=3 are obtained, and the value corresponding to Cₚ=2.6 may be obtained by interpolating from these two values. The time−lifting torque characteristic illustrated in FIG. 43 is one of a plurality of maps whose assist torque-related amount is set in advance.

[Determination of Motion State S=3 and Processing When Motion State S=3 (FIGS. 35A and 35B)]

When the processing proceeds to step SU050, the control device 61 determines whether the motion state S determined in step SU020 is 3, proceeds to step SU051 when the motion state S is 3 (Yes), and proceeds to step SU060 if not (No).

When the processing proceeds to step SU051, the control device 61 obtains the maximum value corresponding to the gain Cₚ based on the gain Cₚ and the time−lifting torque characteristic (see FIG. 43), and substitutes the obtained maximum value into a (temporary) (right) lifting assist torque ((temporary) τ_{s,cmd,R}(t)) and a (temporary) (left) lifting assist torque ((temporary) τ_{S,cmd,L}(t)), and proceeds to step SU057. For example, when the gain Cₚ=1, using the characteristic of f41(x) of Cₚ=1 in FIG. 43, τmax11, which is the maximum value of the |f41(x)|, is the obtained maximum value. For example, when the gain Cₚ is 2.6, the value of the characteristic of the gain Cₚ=2 and the value of the characteristic of the gain Cₚ=3 are obtained, and the value corresponding to Cₚ=2.6 may be obtained by interpolating from these two values.

In step SU57, the control device 61 obtains a (right) torque damping rate τ_{d,R} based on the gain Cₚ, the (right) wearer torque change amount τ_{S,R}(t), and an assist ratio−torque damping rate characteristic (see FIG. 45). Similarly, the control device 61 obtains a (left) torque damping rate τ_{d,L} based on the gain Cₚ, the (left) wearer torque change amount τ_{S,L}(t), and the assist ratio−torque damping rate characteristic (see FIG. 45). Then, the control device 61 obtains and stores the (right) assist torque command value τ_{s,cmd,R}(t) according to the following Equation (7), and obtains and stores the (left) assist torque command value τ_{s,cmd,L}(t) according to the following Equation (8). Then, the control device 61 ends the processing and returns (proceeds to step S060R in FIG. 18).

(Right) assist torque command value τ_{s,cmd,R}(t)=(temporary) τ_{s,cmd,R}(t)*(right) torque damping rate τ_{d,R} (Equation 7)

(Left) assist torque command value τ_{s,cmd,L}(t)=(temporary) τ_{s,cmd,L}(t)*(left) torque damping rate τ_{d,L} (Equation 8)

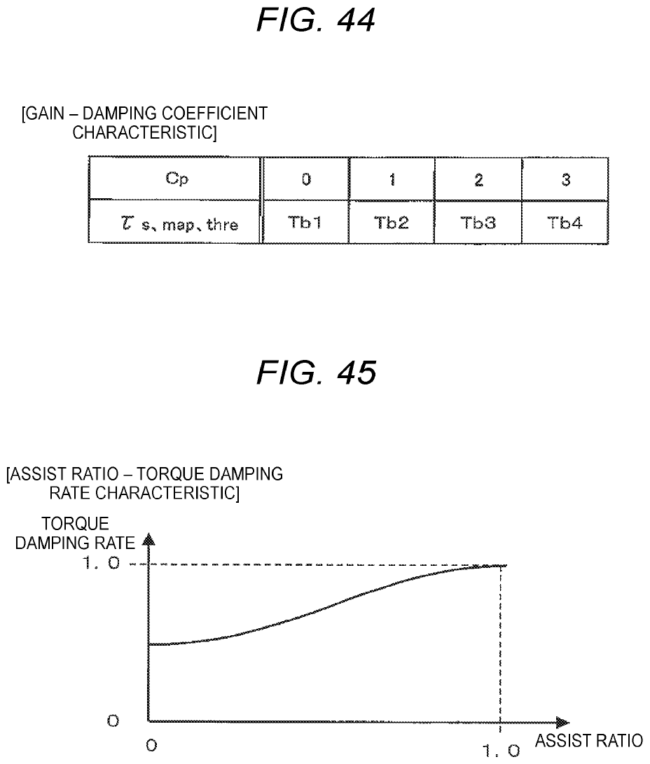

For example, when the gain Cₚ=1, the control device 61 obtains a damping coefficient τ_{s,map,thre}=Tb2 based on a gain−damping coefficient characteristic illustrated in FIG. 44. Then, the control device 61 calculates a (right) assist ratio according to the following (Equation 9), and calculates a (left) assist ratio according to (Equation 10). For example, when the gain Cₚ is 2.6, Tb3 corresponding to the gain Cₚ=2 and Tb4 corresponding to the gain Cₚ=3 are obtained, and the value corresponding to Cₚ=2.6 may be obtained by interpolating from these two values (Tb3, Tb4). The gain−damping coefficient characteristic illustrated in FIG. 44 is one of a plurality of maps (a plurality of data tables) whose assist torque-related amount is set in advance.

(Right) assist ratio=[τ_{s,map,thre}−(right) wearer torque change amount τ_{S,R}(t)]/τ_{s,map,thre} (Equation 9)

(Left) assist ratio=[τ_{s,map,thre}−(left) wearer torque change amount τ_{S,L}(t)]/τ_{s,map,thre} (Equation 10)

Then, the control device 61 obtains the (right) torque damping rate τ_{d,R}, based on the (right) assist ratio and the assist ratio−torque damping rate characteristic (see FIG. 45), and obtains the (left) torque damping rate τ_{d,L} based on the (left) assist ratio and the assist ratio−torque damping rate characteristic (see FIG. 45). Then, the control device 61 stores the (temporarily) τ_{s,cmd,R}(t)*the (right) torque damping rate τ_{d,R} as the (right) lifting assist torque (the (right) assist torque command value τ_{s,cmd,R}(t)), and stores the (temporary) τ_{s,cmd,L}(t)*the (left) torque damping rate τ_{d,L} as the (left) lifting assist torque (the (left) assist torque command value τ_{s,cmd,L}(t)).

[Determination of Motion State S=4 and Processing When Motion State S=4 (FIGS. 35A and 35B)]

When the processing proceeds to step SU060, the control device 61 determines whether the motion state S determined in step SU020 is 4, proceeds to step SU061 when the motion state S is 4 (Yes), and proceeds to step SU077 if not (No).

When the processing proceeds to step SU061, the control device 61 adds the task period (for example, 2 [ms], when the processing illustrated in FIG. 18 is activated per 2 [ms]) to the (right) virtual elapsed time τ_{map,R}(t), adds the task period to the (left) virtual elapsed time τ_{map,L}(t), and proceeds to step SU062. The (right) virtual elapsed time τ_{map,R}(t) and the (left) virtual elapsed time τ_{map,L}(t) indicate (virtual) elapsed times after the motion state becomes S=4.

In step SU62, the control device 61 substitutes a current τ_{s,cmd,R}(t) into a (previous) τ_{s,cmd,R}(t−1), substitutes a current τ_{s,cmd,L}(t) into a (previous) τ_{s,cmd,L}(t−1), the processing proceeds to step SU067.

In step SU067, the control device 61 obtains and stores the (right) assist torque command value τ_{s,cmd,R}(t) according to the following Equation (11), and obtains and stores the (left) assist torque command value τ_{s,cmd,L}(t) according to Equation (12). The damping coefficient K1 is a coefficient set in advance, and is set to 0.9, for example. Then, the control device 61 ends the processing and returns (proceeds to step S060R in FIG. 18).

(Right) assist torque command value τ_{s,cmd,R}(t)=K1*(previous) τ_{s,cmd,R}(t−1) (Equation 11)

(Left) assist torque command value τ_{s,cmd,L}(t)=K1*(previous) τ_{s,cmd,L}(t−1) (Equation 12)

[Processing When Motion State S=5 (FIGS. 35A and 35B)]

When the processing proceeds to step SU077, the control device 61 obtains and stores the (right) assist torque command value τ_{s,cmd,R}(t) according to the following Equation (13), and obtains and stores the (left) assist torque command value τ_{s,cmd,L}(t) according to Equation (14). Then, the control device 61 ends the processing and returns (proceeds to step S060R in FIG. 18).

(Right) assist torque command value τ_{s,cmd,R}(t)=0 (Equation 13)

(Left) assist torque command value τ_{s,cmd,L}(t)=0 (Equation 14)

As described above, at the time of the lifting operation, the control device 61 causes the motion state S to sequentially transition from 0 to 5 according to the lifting state, and obtains the (right) lifting assist torque (the (right) assist torque command value τ_{S,cmd,R}(t)) and the (left) lifting assist torque (the (left) assist torque command value τ_{s,cmd,L}(t)) in accordance with the calculation method set in advance corresponding to each motion state S.

[Details of SS000: Motion State Determination (FIG. 36)]

Next, details of the processing in step SS000 according to step SU010 illustrated in FIGS. 35A and 35B will be described with reference to FIG. 36. In SS000, the control device 61 determines the motion state S=0 to 5 according to the lifting state in the lifting operation of the wearer. As illustrated in FIG. 37, an outline of the motion state S is that: at the time when the wearer starts leaning forward from the upright state (a state in which the forward-leaning of a previous operation is ended) or starts the lifting motion, the motion state S=0; when transitioned after starting the lifting motion, the motion state S=1; upon lifting of the object, the motion state S the =2; when gradually decreasing the forward-leaning angle, the motion state S=3, S=4; and in an upright state after the lifting of the object is completed, the motion state S=5. The motion state S is set to correspond to the lifting state including at least one of the (right) virtual elapsed time τ_{map,R}(t), the (left) virtual elapsed time τ_{map,L}(t), the (right) link angle (forward-leaning angle) θ_{L,R}(t), the (left) link angle (forward-leaning angle) θ_{L,L}(t), the (right) wearer torque change amount τ_{S,R}(t), and the (left) wearer torque change amounts τ_{S,L}(t).

[Case Where Motion State S=0]

A procedure for determining the motion state S will be described below with reference to the state transition diagram illustrated in FIG. 36. As illustrated in FIG. 36, the control device 61 determines that the motion state S is 0 upon an event ev00 that the lifting is started. Determination of whether the lifting is started can be made based on the (right) link angle θ_{L,R}(t), the (left) link angle θ_{L,L}(t), the (right) link angle variation Δθ_{L,R}(t), the (left) link angle variation Δθ_{L,L}(t), the (right) wearer torque change amount τ_{S,R}(t), the (left) wearer torque change amount τ_{S,L}(t), and the like. When the motion state S=0, the control device 61 causes the motion state S to transition from 0 to 1 when an event ev01 is detected. The event ev01 is “normal”, and as shown in step SU015 in FIGS. 35A and 35B, the control device 61 unconditionally causes a transition to the motion state S=1 after the motion state S=0.

[Case Where Motion State S=1]

When the motion state S=1, the control device 61 causes the motion state S to transition from 1 to 2 when an event ev12 is detected. When the event ev12 is not detected, the control device 61 maintains the motion state S=1. The event ev12 is satisfied, for example, when the (right) virtual elapsed time t_{map,R}(t)≥the (right) t_{map,thre1} is satisfied, or when the (left) virtual elapsed time t_{map,L}(t)≥the (left) t_{map,thre1} is satisfied, or when either one of the (right) link angle (forward-leaning angle) θ_{L,R}(t) and the (left) link angle (forward-leaning angle)) θ_{L,L}(t) becomes the forward-leaning angle close to the end of the lifting operation is satisfied. The (right) t_{map,thre1} is determined based on the (right) increase rate C_{s,R}, and the increase rate−transition time characteristic (see FIG. 40), and the (left) t_{map,thre1} is determined based on the (left) increase rate C_{s,L} and the increase rate−transition time characteristic (see FIG. 40).

[Case Where Motion State S=2]

When the motion state S=2, the control device 61 causes the motion state S to transition from 2 to 3 when an event ev23 is detected. When the event ev23 is not detected, the control device 61 maintains the motion state S=2. The event ev23 is satisfied, for example, when the (right) wearer torque change amount τ_{S,R}(t) or the (left) wearer torque change amount τ_{S,L}(t) becomes relatively weak close to the end of the lifting operation, or when the (right) link angle (forward-leaning angle) θ_{L,R}(t) or the (left) link angle (forward-leaning angle) θ_{L,L}(t) becomes a forward-leaning angle close to the end of the lifting operation.

[Case Where Motion State S=3]

When the motion state S=3, the control device 61 causes the motion state S to transition from 3 to 4 when an event ev34 is detected. When the event ev34 is not detected, the control device 61 maintains the motion state S=3. The event ev34 is satisfied, for example, when the (right) wearer torque change amount τ_{S,R}(t)≥τ_{s,map,thre}, or the (left) wearer torque change amount τ_{S,L}(t)≥τ_{s,map,thre}, or the (right) link angle (forward-leaning angle) θ_{L,R}(t) or the (left) link angle (forward-leaning angle θ_{L,L}(t) becomes a forward-leaning angle close to the end of the lifting operation. Note that τ_{s,map,thre} is determined based on the gain Cₚ and the gain−damping coefficient characteristic (see FIG. 44).

[Case Where Motion State S=4]

When the motion state S=4, the control device 61 causes the motion state S to transition from 4 to 5 when an event ev45 is detected. When the event ev45 is not detected, the control device 61 maintains the motion state S=4. The event ev45 is satisfied, for example, when the (right) virtual elapse time t_{map,R}(t)≥a state determination time t41 (e.g., about 0.15 [sec]), or the (left) virtual elapsed time t_{map,L}(t)≥the state determination time t41 (e.g., about 0.15 [sec]).

[Case Where Motion State S=5]

When the motion state S=5, the control device 61 causes the motion state S to transition from 5 to 0 when an event ev50 is detected. When the event ev50 is not detected, the control device 61 maintains the motion state S=5. The event ev50 is the start of the lifting operation, and the motion state returns to S=0 after the lifting operation is completed.

[Details of SS100R: (Right) Increase Rate Switching Determination (FIG. 38)]

Next, details of the processing in step SS100R according to step SU033R illustrated in FIGS. 35A and 35B will be described with reference to FIG. 38. In SS100R, the control device 61 automatically switches the (right) increase rate C_{s,R} to an appropriate value among−1 to 4 in accordance with the lifting motion of the wearer. The processing of the SS100R shows the processing procedure for automatically switching the (right) increase rate C_{s,R}, while the processing procedure of SS100L (see FIGS. 35A and 35B) that automatically switches the (left) increase rate C_{s,L} is similar, and a description thereof will be omitted.

After the processing of SS100R, the control device 61 proceeds to step SS110R. Then, in step SS110R, the control device 61 stores the current (right) increase rate C_{s,R} as a previous C_{s,R}, and proceeds to step SS115R.

In step SS115R, the control device 61 determines whether a switching stop counter is active, proceeds to step SS120R when the switching stop counter is active (Yes), and proceeds to step SS125R if not (No). The switching stop counter is a counter that is activated when the (right) increase rate C_{s,R} is switched (changed) in steps SS140R, SS145R.

When the processing proceeds to step SS120R, the control device 61 determines whether the switching stop counter is equal to or greater than a switching standby time, proceeds to step SS125R when the switching stop counter is equal to or greater than the switching standby time (Yes), and proceeds to step SS150R if not (No).

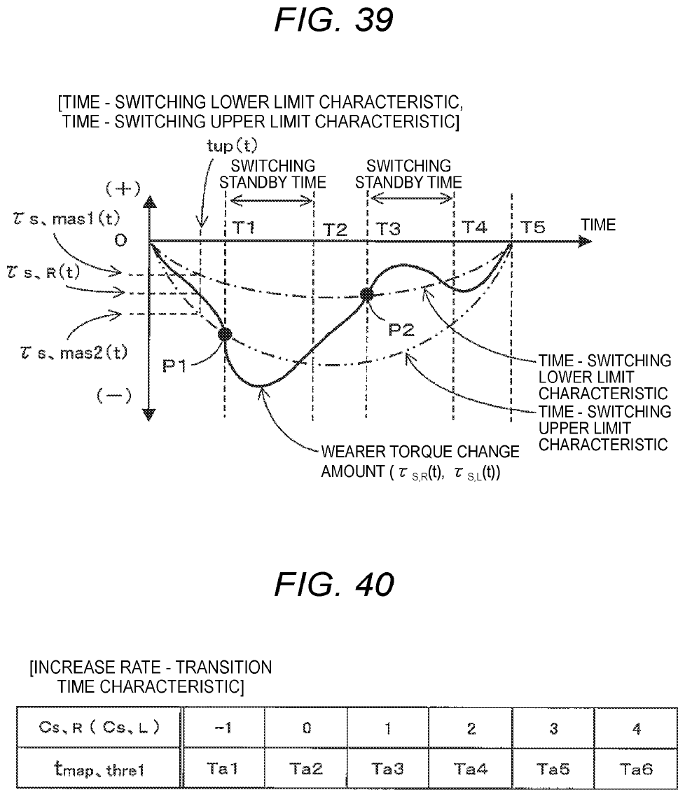

When the processing proceeds to step SS125R, the control device 61 obtains a switching lower limit τ_{s,mas1}(t) corresponding to a current lifting elapsed time tᵤₚ(t) based on the lifting elapsed time tᵤₚ(t) and a time−switching lower limit characteristic (see FIG. 39). Further, the control device 61 obtains a switching upper limit τ_{s,mas2}(t) corresponding to the current lifting elapsed time tᵤₚ(t) based on the current (right) increase rate C_{s,R}, the lifting elapsed time tᵤₚ(t), and a time−switching upper limit characteristic (see FIG. 39). The lifting elapsed time tᵤₚ(t) is an elapsed time from a timing at which the lifting is started (the motion state S transitions from 0→1). Then, the control device 61 proceeds to step SS130R. The example illustrated in FIG. 39 illustrates a state in which |the (right) wearer torque change amount τ_{S,R}(t)|>| the switching upper limit τ_{s,mas2}(t)| at a time T1 (at a position P1), and a state in which |the (right) wearer torque change amount τ_{S,R}(t)|<|the switching upper limit τ_{s,mas1}(t)| at a time T3 (at a position P2).

In step SS130R, the control device 61 determines whether |the (right) wearer torque change amount τ_{S,R}(t)| is smaller than |the switching lower limit τ_{s,mas1}(t)|, proceeds to step SS145R if |the (right) wearer torque change amount τ_{S,R}(t)| is smaller than |the switching lower limit τ_{s,mas1}(t)| (Yes), and proceeds to step SS135R if not (No).

When the processing is advanced to step SS135R, the control device 61 determines whether |the (right) wearer torque change amount τ_{S,R}(t)| is larger than |the switching upper limit τ_{s,mas2}(t)|, proceeds to step SS140R if |the (right) wearer torque change amount τ_{S,R}(t)| is larger than |the switching upper limit τ_{s,mas2}(t)| (Yes), and proceeds to step SS150R if not (No).

When the processing proceeds to step SS140R, the control device 61 increases the value of the (right) increase rate C_{s,R} by 1 (guarding the maximum value=4), activates the switching stop counter, and proceeds to step SS150R.

When the processing proceeds to step SS145R, the control device 61 reduces the value of the (right) increase rate C_{s,R} by 1 (guarding the minimum value=−1), activates the switching stop counter, and proceeds to step SS150R.

When the processing proceeds to step SS150R, the control device 61 obtains the (right) t_{map,thre1} based on the (right) increase rate C_{s,R} and the increase rate−transition time characteristic (see FIG. 40), and proceeds to step S155R. The (right) t_{map,thre1} is used for determining the motion state (determining transition of the motion state from 1→2) and the like.

In step SS155R, the control device 61 determines whether the current (right) increase rate C_{s,R} is equal to the previous C_{s,R} (see step SS110R), ends the processing and returns (returns to step SU033L in FIGS. 35A and 35B) if equal (Yes), and proceeds to step SS160R if not equal (No).

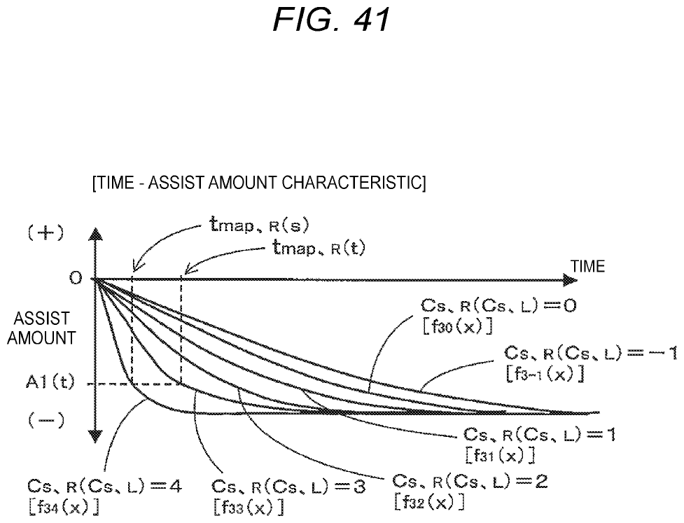

When the processing proceeds to step SS160R, the control device 61 calculates a temporary lifting assist torque A1(t) based on the previous C_{s,R}, the (right) virtual elapsed time τ_{map,R}(t), the time−assist amount characteristic (see FIG. 41), the gain Cₚ, and the time−lifting torque characteristic (see FIG. 43). For example, in a case where the previous C_{s,R}=3, the control device 61 calculates the temporary lifting assist torque A1(t) from f33(x) corresponding to C_{s,R}=3 and the (right) virtual elapsed time t_{map,R}(t), as illustrated in FIG. 41. As illustrated in FIG. 41, the time−assist amount characteristic (one of the lifting reference characteristics) is prepared according to the (right) increase rate C_{s,R} and the (left) increase rate C_{s,L}, and the control device 61 changes the lifting reference characteristics according to the (right) increase rate C_{s,R} and the (left) increase rate C_{s,L}.

The control device 61 calculates a torque deviation reduced virtual elapsed time t_{map,R}(s), at which the temporary lifting assist torque A1(t) is reached, based on the current (present) (right) increase rate C_{s,R}, the time−assist amount characteristic (see FIG. 41), the gain Cₚ, and the time−lifting torque characteristic (see FIG. 43), and substitutes (rewrites) the calculated torque deviation reduced virtual elapsed time t_{map,R}(s) into the (right) virtual elapsed time t_{map,R}(t). In a case of using the time−lifting torque characteristic, for example, when the gain Cₚ is 2.6, the value of the characteristic of the gain Cₚ=2 and the value of the characteristic of the gain Cₚ=3 are obtained, and the value corresponding to Cₚ=2.6 may be obtained by interpolating from these two values. For example, when the current (present) (right) increase rate C_{s,R}=4, as illustrated in FIG. 41, the control device 61 calculates the torque deviation reduced virtual elapsed time t_{map,R}(s) from f34(x) corresponding to C_{s,R}=4 and the temporary lifting assist torque A1(t), and substitutes the torque deviation reduced virtual elapsed time t_{map,R}(s) into the (right) virtual elapsed time t_{map,R}(t). Then, the control device 61 ends the processing and returns (returns to step SU033L in FIGS. 35A and 35B). Rewrite of the (right) virtual elapsed time t_{map,R}(t) corresponds to a switching torque deviation reducing correction of, when transitioned to a predetermined motion state S (in this case, when transitioned to the motion state S=1), reducing a deviation between the lifting assist torque obtained based on the previously selected lifting reference characteristic (the time−assist amount characteristic (see FIG. 41) corresponding to the previous (right) increase rate C_{s,R}) (the temporary lifting assist torque A1(t)) and the currently selected lifting reference characteristic (the time−assist amount characteristic (see FIG. 41) corresponding to the current (present) increase rate C_{s,R})).

In the above description, the time−assist amount characteristic (see FIG. 41), the time−lifting torque characteristic, and the forward-leaning angle−maximum lifting torque characteristic (see FIG. 43) correspond to the plurality of lifting reference characteristics in which the lifting assist torque, which is a torque in the lifting direction, is set. The control device 61 selects an appropriate lifting reference characteristic, obtains the lifting assist torque based on the selected lifting reference characteristic, and drives the actuator unit based on the assist torque using the obtained lifting assist torque as the assist torque. In a case of using the time−lifting torque characteristic, for example, when the gain Cₚ is 2.6, the value of the characteristic of the gain Cₚ=2 and the value of the characteristic of the gain Cₚ=3 are obtained, and the value corresponding to Cₚ=2.6 may be obtained by interpolating from these two values.

[Details of SS170R: (Right) Assist Torque Calculation (FIG. 42)]

Next, details of the processing in step SS170R according to step SU037R illustrated in FIGS. 35A and 35B will be described with reference to FIG. 42. In SS170R, the control device 61 obtains the (right) lifting assist torque (the (right) assist torque command value) τ_{s,cmd,R}(t). The processing of the SS170R indicates a processing procedure for obtaining the (right) lifting assist torque ((right) assist torque command value) τ_{s,cmd,R}(t), while the proceeding procedure of SS170L (see FIGS. 35A and 35B) of obtaining the (left) lifting assist torque (the (left) assist torque command value) τ_{s,cmd,L}(t) is similar, and a description thereof is omitted.

After the processing of SS170R, the control device 61 proceeds to step SS175R. Then, in step SS175R, the control device 61 calculates the (temporary) τ_{s,cmd,R}(t) based on the current (present) (right) increase rate C_{s,R}, the (right) virtual elapsed time τ_{map,R}(t), the gain Cₚ, the time−assist amount characteristic (see FIG. 41), and the time−lifting torque characteristic (see FIG. 43), and proceeds to step SS177R. For example, when the current (present) (right) increase rate C_{s,R}=3, as illustrated in FIG. 41, the control device 61 stores the assist torque A1(t) obtained from f33(x) corresponding to C_{s,R}=3 and the (right) virtual elapsed time t_{map,R}(t) as the (temporary) τ_{s,cmd,R}(t). In a case of using the time−lifting torque characteristic, for example, when the gain Cₚ is 2.6, the value of the characteristic of the gain Cₚ=2 and the value of the characteristic of the gain Cₚ=3 are obtained, and the value corresponding to Cₚ=2.6 may be obtained by interpolating from these two values.

In step SS177R, the control device 61 calculates a (right) torque upper limit value τ_{s,max,R}(t) based on the forward-leaning angle and the forward-leaning angle−maximum lifting torque characteristic (see FIG. 43), and proceeds to step SS180R. For example, the control device 61 stores a maximum lifting torque B1(t) obtained from the forward-leaning angle−maximum lifting torque characteristic illustrated in FIG. 43 and the (right) link angle (forward-leaning angle) θ_{L,R}(t) as the (right) torque upper limit value τ_{s,max,R}(t). The lifting torque has a torque value limited by the “forward-leaning angle−maximum lifting torque characteristic” so as not to become excessively large when the forward-leaning angle is small.

In step SS180R, the control device 61 determines whether |the (temporary) τ_{s,cmd,R}(t)| is larger than |the (right) torque upper limit value τ_{s,max,R}(t)|, proceeds to step SS185R when larger (Yes), and proceeds to step SS187R if not (No).

When the processing proceeds to step SS185R, the control device 61 stores the (right) torque upper limit value τ_{s,max,R}(t) as the (right) lifting assist torque (the (right) assist torque command value τ_{s,cmd,R}(t)), ends the processing, and returns (returns to step SU037L in FIGS. 35A and 35B).

When the processing proceeds to step SS187R, the control device 61 stores the (temporary) τ_{s,cmd,R}(t) as the (right) lifting assist torque (the (right) assist torque command value τ_{s,cmd,R}(t)), ends the processing, and returns (returns to step SU037L in FIGS. 35A and 35B).

As described above, the power assist suit 1 described in the present embodiment has a simple configuration and can be easily worn by the wearer. In addition, assist control for the lowering motion and assist control for the lifting motion are simple, and the object lifting operation and the object lowering operation can be appropriately assisted. Further, when assisting the object lifting motion or lowering motion, the magnitude of the assist torque can be automatically adjusted in accordance with the mass or weight of the object held by the wearer, so as to further prevent a sense of discomfort or dissatisfaction of the wearer (improve harmonization of the assist). Further, in a case where the wearer does not hold a object, it is possible to not generate unnecessary assist torque (it is possible to perform setting so as to substantially not generate the assist torque when the gain Cₚ=0), so as not to hinder the motion of the wearer who is not holding the load.

Various changes, additions, and deletions may be made to the structure, configuration, shape, appearance, processing procedure, and the like of the power assist suit of the present disclosure without departing from the scope of the present disclosure. For example, the processing procedure of the control device is not limited to the flowchart and the like described in the present embodiment. The spiral spring 45R (see FIG. 10) is used in the description of the present embodiment, whereas a torsion spring (e.g., a torsion bar or a torsion bar spring) may be used instead of the spiral spring.

The power assist suit 1 described in the present embodiment describes an example in which a triglide or a buckle is used as the belt holding member for holding the belt in a tightened state. Although an example in which connection and release of the belt or the like are performed by a buckle has been described, connection and release of the belt or the like may be performed with a belt holding member different from the buckle. In addition, although the belt is passed through the triglide so that the stretched belt is not loosened, a belt holding member other than the triglide may be used. Further, a belt holding member having both functions of the triglide and the buckle may be used.

The description of the present embodiment describes an example in which the operation unit R1 includes both the gain up operation unit R1BU, the gain down operation unit R1BD and the increase rate up operation unit R1CU, the increase rate down operation unit R1CD, but may also include at least one of the gain up operation unit R1BU, the gain down operation unit R1BD and the increase rate up operation unit R1CU, the increase rate down operation unit R1CD.

The power assist suit 1 described in the present embodiment is described as an example in which the gain, the increase rate, and the like can be changed from the operation unit R1, but may also be provided with a communication unit 64 (see FIG. 15) (for wireless or wired communication) to the control device 61, and the gain, the increase rate, and the like can be changed by communication from a smartphone or the like. Further, the control device 61 may be provided with the communication unit 64 (see FIG. 15) (for wireless or wired communication), various data may be collected by the control device 61, and the collected data may be transmitted to an analysis system at a predetermined timing (constantly, at a constant time interval, after completion of the assist operation, or the like). For example, the collected data includes wearer information and assist information. The wearer information is information on the wearer including, for example, the wearer torque and the posture of the wearer. The assist information is information on input and output of the left and right actuator units including, for example, the assist torque, the rotation angle of the electric motor (actuator) (the actual motor shaft angle θ_{rM,R} in FIG. 15), the output link rotation angle (the actual link angle θ_{L} in FIG. 15), the motion mode, the gain, the increase rate, and the like. The analysis system is a system prepared separately from the power assist suit, for example, an embedded system such as an external personal computer, a server, a programmable logic controller (PLC), and a computerized numerical control (CNC) device connected via a network (LAN). The analysis system may analyze (calculate) an optimal setting value (an optimal value of the gain, the increase rate, or the like) unique to the power assist suit 1 (that is, unique to the wearer), and transmit analysis information including the optimal setting value as the analysis result (calculation result) to the control device 61 (the communication unit 64) of the power assist suit 1. By analyzing the motion of the wearer, the assist force, and the like with the analysis system, it is possible to output an optimal assist torque in consideration of the type of operation (repetition, lifting height, and the like) and the ability of the wearer. The left and right actuator units adjust its own operation based on the analysis information (e.g., the gain and the increase rate) received from the analysis system (e.g., changes the gain and the increase rate to the received gain and increase rate).

The present embodiment describes an example in which the gain Cₚ is obtained by using the wearer mass M and the object mass m, whereas the gain Cₚ may be obtained using the wearer weight (M*g) and the object weight (m*g) by using the gravitational acceleration g.

The present embodiment describes an example in which the load detection units are provided under the left and right feet of the wearer, whereas gloves may be worn on right and left hands of the wearer, and the left and right gloves may be provided with load detection units. In this case, the object mass (or object weight) can be detected from the load detected by the load detection units, and the detected object mass (or object weight) can be converted into the gain Cₚ. Further, a plurality of switches for detecting presence or absence of a load may be provided instead of providing the load detection units under the left and right feet or on the left and right gloves. For example, if each switch is turned on at 2 [kg] or more, an approximate object weight can be detected according to a number of switches that are turned on.

What is claimed is:

1. A power assist suit comprising:
a body wearing tool configured to be worn around at least a waist of a wearer;
a left actuator portion configured to be attached to the body wearing tool and worn on a left thigh of the wearer, such that the left actuator portion generates an assist torque of assisting a motion of the left thigh with respect to the waist of the wearer;
a right actuator portion configured to be attached to the body wearing tool and worn on a right thigh of the wearer, such that the right actuator portion generates an assist torque of assisting a motion of the right thigh with respect to the waist of the wearer;
a left-torque-related amount detector configured to detect a left-torque-related amount, which is a torque related to a left wearer torque and a left assist torque, the left wearer torque being a torque input from the left thigh of the wearer to the left actuator portion, the left assist torque being the assist torque generated by the left actuator portion;
a right-torque-related amount detector configured to detect a right-torque-related amount, which is a torque related to a right wearer torque and a right assist torque, the right wearer torque being a torque input from the right thigh of the wearer to the right actuator portion, the right assist torque being the assist torque generated by the right actuator portion; and
a controller configured to automatically switch a motion mode based on the left-torque-related amount and the right-torque-related amount.

2. The power assist suit according to claim 1,
wherein the motion mode includes three modes whose assist motions are different from one another, the motion mode including:
a lifting mode of assisting a lifting operation in which the wearer lifts up an object;
a lowering mode of assisting a lowering operation in which the wearer puts down the object; and
a walking mode of assisting a walking motion in which the wearer walks, and
wherein the controller is configured to switch or maintain the motion mode to one of the lifting mode, the lowering mode, and the walking mode, based on the left-torque-related amount and the right-torque-related amount.

3. The power assist suit according to claim 2,
wherein the controller is configured to:
switch the motion mode to the lowering mode when the left-torque-related amount and the right-torque-related amount relates to the torques in a direction in which the wearer leans forward and are larger than a first predetermined threshold, and
switch the motion mode to the lifting mode when the left-torque-related amount and the right-torque-related amount relates to the torques in a direction opposite to the direction in which the wearer leans forward and are larger than a second predetermined threshold.

4. The power assist suit according to claim 1,
wherein the left-torque-related amount detector includes a left thigh angle detector configured to detect a swing angle of the left thigh with respect to the waist of the wearer, and
wherein the right-torque-related amount detector includes a right thigh angle detector configured to detect a swing angle of the right thigh with respect to the waist of the wearer.

5. The power assist suit according to claim 3, further comprising:
a storage portion in which a learning model is stored,
wherein the controller is configured to perform a machine learning with the learning model, such that the controller adjusts values of the first predetermined threshold and the second predetermined threshold, respectively.

6. The power assist suit according to claim 1,
wherein each of the left actuator portion and the right actuator portion includes:
an output link configured to be worn on one of the left thigh and the right thigh of the wearer and to move rotationally around a joint of the one of the left thigh and the right thigh;
an actuator including an output shaft configured to generate the assist torque of assisting a rotational movement around the joint of the one of the left thigh and the right thigh via the output link;
an elastic member configured to accumulate a synthetic torque obtained by synthesizing the wearer torque input from the output link moved rotationally by a force of the wearer and the assist torque input from the output shaft in the one of the left thigh and the right thigh, one end of the elastic member being connected to the output link, the other end of the elastic member being connected to the output shaft of the actuator; and
a deformation state detector configured to detect a deformation state in which the elastic member is deformed,
wherein the controller is configured to control the left actuator portion and the right actuator portion, and
wherein the controller includes:
a synthetic torque acquisition portion configured to acquire the synthetic torque accumulated in the elastic member based on the deformation state of the elastic member, the deformation state being detected with the deformation state detector of each of the left actuator portion and the right actuator portion; and
a spring failure determination portion configured to determine whether the elastic member of each of the left actuator portion and the right actuator portion is to fail, based on the synthetic torque accumulated in the elastic member acquired via the synthetic torque acquisition portion.

7. The power assist suit according to claim 6,
wherein the spring failure determination portion is configured to determine that the elastic member is to fail when the synthetic torque acquired via the synthetic torque acquisition portion is equal to or greater than a predetermined torque threshold.

8. The power assist suit according to claim 6, further comprising:
a power supply portion configured to supply an electric power to the left actuator portion and the right actuator portion,
wherein the controller includes a power supply control portion which controls to stop supplying the electric power to the left actuator portion and the right actuator portion when the spring failure determination portion determines that the elastic member is to fail.

9. The power assist suit according to claim 6,
wherein the deformation state detector includes:
an output shaft rotation angle detection device configured to detect a rotation angle of the output shaft; and
an output link rotational movement angle detection device configured to detect a rotational movement angle of the output link, and
wherein the synthetic torque acquisition portion is configured to acquire each of the synthetic torques based on the rotation angle of the output shaft detected by the output shaft rotation angle detection device and the rotational movement angle of the output link detected by the output link rotational movement angle detection device.

10. The power assist suit according to claim 9,
wherein each of the left actuator portion and the right actuator portion includes a speed reducer including a speed-reducing shaft connected to the output link, and including a speed-increasing shaft connected to the output link rotational movement angle detection device.

11. A power assist suit comprising:
a body wearing tool configured to be worn around at least a waist of a wearer;
a left actuator portion configured to be attached to the body wearing tool and worn on a left thigh of the wearer, such that the left actuator portion generates an assist torque of assisting a motion of the left thigh with respect to the waist of the wearer;
a right actuator portion configured to be attached to the body wearing tool and worn on a right thigh of the wearer, such that the right actuator portion generates an assist torque of assisting a motion of the right thigh with respect to the waist of the wearer; and
a controller configured to control the left actuator portion and the right actuator portion,
wherein each of the left actuator portion and the right actuator portion includes:
an output link configured to be worn on one of the left thigh and the right thigh of the wearer and to move rotationally around a joint of the one of the left thigh and the right thigh;
an actuator including an output shaft configured to generate the assist torque of assisting a rotational movement around the joint of the one of the left thigh and the right thigh via the output link;
an elastic member configured to accumulate a synthetic torque obtained by synthesizing the wearer torque input from the output link moved rotationally by a force of the wearer and the assist torque input from the output shaft in the one of the left thigh and the right thigh, one end of the elastic member being connected to the output link, the other end of the elastic member being connected to the output shaft of the actuator; and
a deformation state detector configured to detect a deformation state in which the elastic member is deformed, and
wherein the controller includes:
a synthetic torque acquisition portion configured to acquire the synthetic torque accumulated in the elastic member based on the deformation state of the elastic member, the deformation state being detected with the deformation state detector of each of the left actuator portion and the right actuator portion; and
a spring failure determination portion configured to determine whether the elastic member of each of the left actuator portion and the right actuator portion is to fail, based on the synthetic torque accumulated in the elastic member acquired via the synthetic torque acquisition portion.

12. The power assist suit according to claim 6,
wherein the elastic members includes a spiral spring.

13. The power assist suit according to claim 1, further comprising:
a power supply portion configured to supply an electric power to the left actuator portion and the right actuator portion,
wherein each of the left actuator portion and the right actuator portion includes:
an output link configured to be worn on one of the left thigh and the right thigh of the wearer and to move rotationally around a joint of the one of the left thigh and the right thigh;
an actuator including an output shaft configured to generate the assist torque of assisting a rotational movement around the joint of the one of the left thigh and the right thigh via the output link;
an elastic member configured to accumulate a synthetic torque obtained by synthesizing the wearer torque input from the output link moved rotationally by a force of the wearer and the assist torque input from the output shaft in the one of the left thigh and the right thigh, one end of the elastic member being connected to the output link, the other end of the elastic member being connected to the output shaft of the actuator; and
a deformation state detector configured to detect a deformation state in which the elastic member is deformed,
wherein the controller is configured to control the left actuator portion and the right actuator portion, and
wherein the controller includes:
a synthetic torque acquisition portion configured to acquire the synthetic torque accumulated in the elastic member based on the deformation state of the elastic member, the deformation state being detected with the deformation state detector of each of the left actuator portion and the right actuator portion;
a first rotational movement torque acquisition portion configured to acquire a first rotational movement torque of moving rotationally the output link of each of the left actuator portion and the right actuator portion, based on the synthetic torque accumulated in the elastic member acquired via the synthetic torque acquisition portion;
a current detector configured to detect a current value supplied to each of the left actuator portion and the right actuator portion;
a second rotational movement torque acquisition portion configured to acquire a second rotational movement torque of moving rotationally the output link of each of the left actuator portion and the right actuator portion, based on the current value supplied to each of the left actuator portion and the right actuator portion detected with the current detector; and
a device failure determination portion configured to determine whether the deformation state detector of each of the left actuator portion and the right actuator portion fails, based on a difference between the first rotation torque and the second rotation torque.

14. The power assist suit according to claim 13,
wherein the device failure determination portion is configured to determine that the deformation state detector fails when the difference between the first rotational movement torque and the second rotational movement torque is equal to or greater than a predetermined error threshold.

15. The power assist suit according to claim 13,
wherein the controller includes a power supply control portion which controls to stop supplying the electric power to the left actuator portion and the right actuator portion when the device failure determination portion determines that the deformation state detector of the left actuator portion or the right actuator portion fails.

16. The power assist suit according to claim 13,
wherein the deformation state detector includes:
an output shaft rotation angle detection device configured to detect a rotation angle of the output shaft; and
an output link rotational movement angle detection device configured to detect a rotational movement angle of the output link, and
wherein the synthetic torque acquisition portion is configured to acquire each of the synthetic torques based on the rotation angle of the output shaft detected by the output shaft rotation angle detection device and the rotational movement angle of the output link detected by the output link rotational movement angle detection device.

17. The power assist suit according to claim 16,
wherein the device failure determination portion is configured to determine whether the output link rotational movement angle detection device of each of the left actuator portion and the right actuator portion fails, based on the difference between the first rotation torque and the second rotation torque of each of the left actuator portion and the right actuator portion.

18. The power assist suit according to claim 16,
wherein each of the left actuator portion and the right actuator portion includes a speed reducer including a speed-reducing shaft connected to the output link, and including a speed-increasing shaft connected to the output link rotational movement angle detection device.

19. The power assist suit according to claim 1, wherein the controller includes a communication portion,
wherein the communication portion transmits data to an analysis system, and
wherein the communication portion receives an analysis information from the analysis system.

20. The power assist suit according to claim 13,
wherein the elastic members includes a spiral spring.
